(19) United States
(12) Patent Application Publication
(10) Pub. No.: US 2010/0300310 A1
(43) Pub. Date: Dec. 2, 2010

(54) Print apparatus, print method, and print program

(75) Inventors: Yukiko Kanekiyo, Tokyo (JP); Taro Suito, Kanagawa (JP); Kuriko Takeshima, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/800,024

(22) Filed: May 6, 2010

(30) Foreign Application Priority Data
May 28, 2009 (JP) P2009-129314

(51) Int. Cl. B41F 17/00; B41F 33/00

(52) U.S. Cl. 101/35; 101/483

(57) ABSTRACT

A print apparatus includes: a print image generation unit that generates a circular print image by bonding one end and the other end of a single direction of a representative image where an image characteristic portion extending in a single direction is depicted to represent contents recorded on the recording disc; and a print unit that prints the print image on one surface of the recording disc by matching a center of the recording disc with a center of the print image.

### BACKGROUND OF THE INVENTION

1. Field of the Invention

The present invention relates to a print apparatus, a print method, and a print program. For example, the present invention is very suitable for a program recording device capable of recording a television broadcasting program.

2. Description of the Related Art

A print apparatus of the related art determines a characteristic portion (hereinafter, also referred to as an image characteristic portion) within a rectangular image (hereinafter, also referred to as a recording image) recorded on a disc such as a CD (Compact Disc) or a DVD (Digital Versatile Disc). In addition, the print apparatus also determines a center position of the image characteristic portion for that recording image.

The print apparatus determines, as a printable area, an area between the first concentric circle having the smallest radius and the third concentric circle having the largest radius among first to third concentric circles having difference radiuses from the disc center on one surface of the disc.

Furthermore, in the printable area on one surface of the disc, the print apparatus places a center of the image characteristic portion at the second concentric circle and forms a fan-shaped print area for printing a predetermined area including the corresponding image characteristic portion within the recording image as the print image.

The print apparatus prints out the print image in the print area on one surface of the disc. In this manner, the print apparatus allows users to identify what kind of recording image is recorded on the disc on which the recording image is recorded using the print image printed on one surface thereof (e.g., Japanese Unexamined Patent Application Publication No. 2007-279880, pages 8 and 9, FIGS. 6 and 10)

However, the print apparatus having such a configuration prints out the print image in the print area on one surface of the disc such that the graphic of the corresponding print image is nearly similar to the graphic of the print result by positioning the center of the image characteristic portion in the second concentric circle and appropriately magnifying it without any blank.

For this reason, if the image characteristic portion within the recording image is depicted to extend along a horizontal direction of the image, both ends of the image characteristic portion as the print image may protrude out of one surface of the disc. Therefore, it is difficult for the print apparatus to print out both the corresponding ends of the image characteristic portion on one surface.

The print apparatus also has a problem in that, if both ends of the image characteristic portion are missing from the recording image printed on one surface of the disc, users may be difficult to identify what kind of recording image has been recorded just by using such a printed content.

### SUMMARY OF THE INVENTION

The present has been made to propose a print apparatus, a print method, and a print program by which the print image printed on the recording disc can be used to identify the contents recorded on the corresponding recording disc.

According to an embodiment of the present invention, there is provided a print apparatus in which a circular print image is generated by bonding one end and the other end of a single direction of a representative image where an image characteristic portion extending in a single direction is depicted to represent contents recorded on the recording disc, and the print image is printed on one surface of the recording disc by matching the center of the recording disc with the center of the print image.

According to the present invention, in the print apparatus, it is possible to print the image characteristic portion extending in a single direction depicted in the representative image representing the contents recording on the recording disc on one surface of the disc without omission.

According to the present invention, in the print apparatus, a circular print image is generated by bonding one end and the other end of a single direction of a representative image where an image characteristic portion extending in a single direction is depicted to represent contents recorded on the recording disc, and the print image is printed on one surface of the recording disc by matching the center of the recording disc with the center of the print image. Thereby, it is possible to print the image characteristic portion extending in one direction, where the representative image representing the recorded contents recorded on the recording disc is depicted, on one surface of the disc without any omission. It is possible to implement the print apparatus, the print method, and the print program capable of identifying the contents recorded in the corresponding recording disc by the print image printed on the recording disc.

### BRIEF DESCRIPTION OF THE DRAWINGS

FIG. 1 is a schematic front diagram illustrating an exterior configuration of a program recording device according to an embodiment of the present invention.

FIG. 2 is a block diagram illustrating a circuit configuration including hardware circuit blocks of the program recording device.

FIG. 3 is a block diagram illustrating a circuit configuration including functional circuit blocks provided in the description of the process executed by a main control unit.

FIG. 4 is a schematic diagram illustrating delimitation for analysis of a representative image (1).

FIG. 5 is a schematic diagram illustrating an RGB histogram obtained for every analysis region of the representative image.

FIG. 6 is a schematic diagram illustrating extraction of the characteristic depiction area from the representative image (1).

FIG. 7 is a schematic diagram illustrating comparison of left and right sides of the characteristic depiction area.

FIG. 8 is a schematic diagram illustrating extraction of the lengthwise characteristic image from the characteristic depiction area.

FIG. 9 is a schematic diagram illustrating delimitation for analysis of a representative image (2).

FIG. 10 is a schematic diagram illustrating extraction of the characteristic depiction area from the representative image (2).

FIG. 11 is a schematic diagram illustrating comparison of the upper and lower sides of the characteristic depiction area.

FIG. 12 is a schematic diagram illustrating extraction of the breadthwise characteristic image from the characteristic depiction area.

FIG. 13 is a schematic diagram illustrating delimitation for analysis of a representative image (3).

FIG. 14 is a schematic diagram illustrating extraction of a matrix-type characteristic image from the representative image.

FIG. 15 is a schematic diagram illustrating generation of the print image based on the lengthwise characteristic image (1).

FIG. 16 is a schematic diagram illustrating a configuration of the print image.

FIG. 17 is a schematic diagram illustrating generation of the print image based on the breadthwise characteristic image.

FIG. 18 is a schematic diagram illustrating generation of the print image based on two lengthwise characteristic images.

FIG. 19 is a schematic diagram illustrating generation of the print image based on two breadthwise characteristic images.

FIG. 20 is a schematic diagram illustrating print area information representing a print area on one surface of the recording disc.

FIG. 21 is a schematic diagram illustrating a configuration of the print data (1).

FIG. 22 is a schematic diagram illustrating a configuration of a print preview window (1).

FIG. 23 is a schematic diagram illustrating printing of the print image on one surface of the recording disc (1).

FIG. 24 is a schematic diagram illustrating generation of the print image based on the lengthwise characteristic image (2).

FIG. 25 is a schematic diagram illustrating a configuration of the print image by changing a depicted direction.

FIG. 26 is a schematic diagram illustrating a configuration of the print data (2).

FIG. 27 is a schematic diagram illustrating a configuration of the print preview window (2).

FIG. 28 is a schematic diagram illustrating printing of the print image on one surface of the recording disc (2).

FIG. 29 is a schematic diagram illustrating a configuration of the print image by adding a title.

FIG. 30 is a schematic diagram illustrating a configuration of the print data (3).

FIG. 31 is a schematic diagram illustrating a configuration of the print preview window (3).

FIG. 32 is a schematic diagram illustrating printing of the print image on one surface of the recording disc (3).

FIG. 33 is a schematic diagram illustrating a configuration of the print data (4).

FIG. 34 is a schematic diagram illustrating a configuration of the print preview window (4).

FIG. 35 is a schematic diagram illustrating printing of the print image on one surface of the recording disc (4).

FIG. 36 is a flowchart illustrating a print process sequence (1).

FIG. 37 is a flowchart illustrating a print process sequence (2).

FIG. 38 is a schematic diagram illustrating a process of the characteristic depiction image.

### DESCRIPTION OF THE PREFERRED EMBODIMENTS

Hereinafter, best modes (hereinafter, also referred to as embodiments) for embodying the present invention will be described with reference to the accompanying drawings. Descriptions will be made in the following sequence.
1. Embodiments
2. Modifications

### 1. Embodiments

### 1-1. Exterior Configuration of Program Recording Device

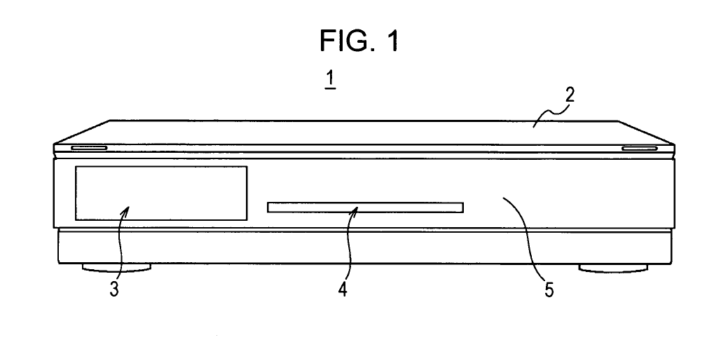

Referring to FIG. 1, the reference numeral 1 denotes a program recording device as a whole according to an embodiment of the present invention. Such a program recording device 1 has an electronic program guide (EPG) obtainment function for obtaining EPG information regarding digital and analog system broadcasting.

The program recording device 1 also has a program recording function for recording digital and analog system broadcasting programs and a data storing function for importing and storing moving picture data or photograph image data from an external device.

The program recording device 1 further has a data reproducing function for reproducing program data regarding the recorded program or moving picture data and photograph image data that have been imported from an external device and stored.

Furthermore, the program recording device 1 has a disc recording function for recording, on a disc, the program data on the recorded program or the moving picture data and photograph image data that have been externally imported and stored and a disc reproducing function for reproducing the program data, moving picture data, or photograph image data recorded on the disc.

Hereinafter, the recorded program will be also referred to as a recording program. In addition, a disc used to record the program data, photograph image data, or moving picture data will be also referred to as a recording disc.

The program recording device 1 also has a print function for printing a print image representing the recorded program data, moving picture data, or photograph image data on one surface of the recording disc on which the program data, moving picture data, or photograph image data are recorded. Hereinafter, one surface of the recording disc will be also referred to as one disc surface.

In practice, the program recording device 1 has a box-shaped device casing 2. The device casing 2 is provided with a display unit 3 such as a liquid crystal display or an organic electro-luminescence (EL) display on the right side of the front face. Consequently, the program recording device 1 is allowed to display, on the display unit 3, condition notification information for notifying operation conditions of the corresponding program recording device 1, such as a recording time or reproduction time of the program.

The device casing 2 is also provided with a disc tray 4 on the center of the front face so that it can slide forward from the device and slide backward to the internal space of the device. Consequently, the program recording device 1 is allowed to install a recording disc such as a DVD (Digital Versatile Disc) or a BD (Blu-ray Disc) inside the device and discharge the disc to an external space using the disc tray 4.

Furthermore, the device casing 2 is provided with a transparent protection cover 5 on the front face to be openable and closable to outwardly open the front face and cover it. Consequently, the program recording device 1 is allowed to eject the disc tray 4 from the internal space to the external space when the protection cover 5 is opened at the front face of the device casing 2.

For this purpose, the program recording device 1 is configured to protect the display unit 3 or the disc tray 4 from external attacks when the protection cover 5 is closed at the front side of the device casing 2 with the disc tray 4 being stored in the internal space of the device.

### 1-2. Circuit Configuration of Program Recording Device

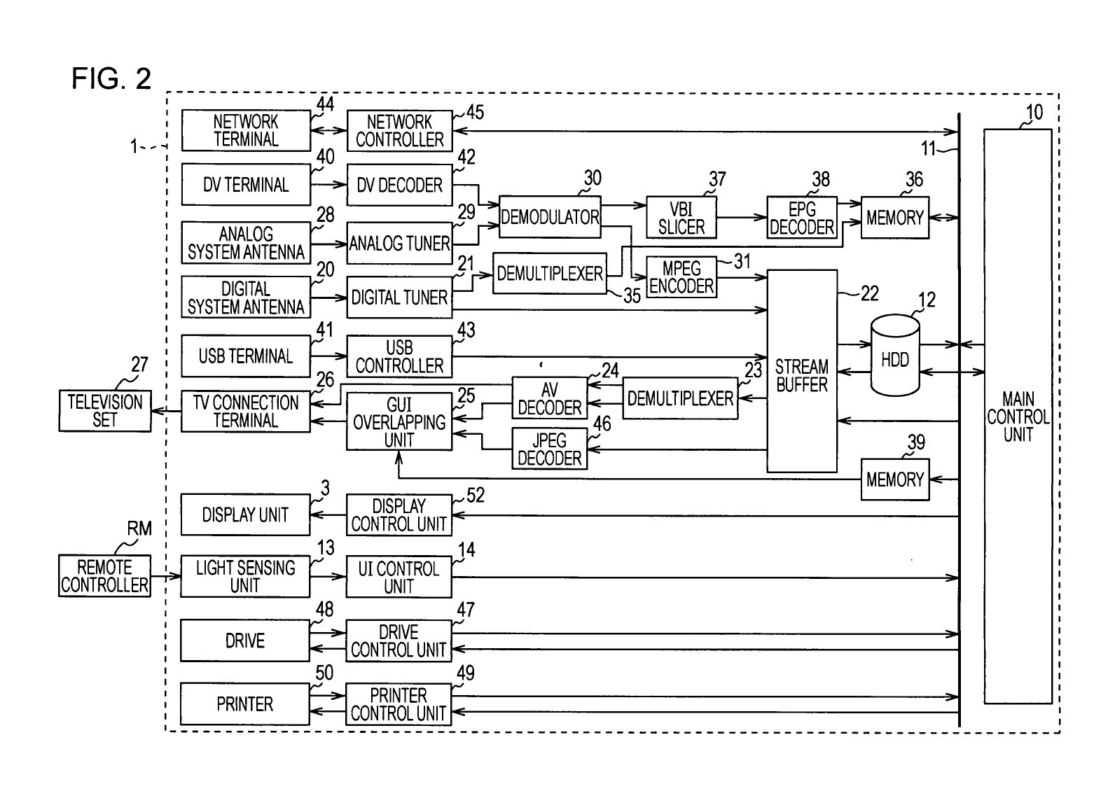

Next, a circuit configuration of hardware circuit blocks of the program recording device 1 will be described with reference to FIG. 2. The program recording device 1 has a main control unit 10, for example, constructed of a micro-computer.

The main control unit 10 controls the entire program recording device 1 and executes a predetermined operation process according to various programs stored in internal memory (not shown) or a hard disc drive 12 connected via a bus 11.

The main control unit 10 performs control such that the light sensing unit 13 receives an optical signal transmitted from the remote controller RM in response to user's manipulation, and the UI (User Interface) control unit imports it as a manipulation command to execute various processes according to the manipulation command. Hereinafter, the remote controller RM will be referred to as a remocon RM.

Consequently, the main control unit 10 imports the digital broadcasting signal received using a digital system antenna 20 to a digital tuner 21 in response to user's manipulation of the remocon RM during a program watching mode of the digital system broadcasting.

The digital tuner 21 extracts broadcasting data of any channel (e.g., a channel selected by manipulation of the remocon RM) from the corresponding digital broadcasting signal while receiving the digital broadcasting signal from the digital system antenna 20. In addition, the digital tuner 21 outputs the broadcasting data extracted from the digital broadcasting signal to the demultiplexer 23 via the stream buffer 22.

Here, the broadcasting data of the digital system broadcasting are generated as transport streams by time-division multiplexing the program data on programs and broadcasting-related data. In addition, the program data on programs are generated by time-division multiplexing the video data on the program video and the sound data on the program sound.

The broadcasting-related data contains information on data broadcasting and other kinds of information on the broadcasting. In addition, the video data of a program video is constructed of frame image data containing a plurality of temporally consecutive frame images.

The demultiplexer 23 splits the broadcasting data into program data and broadcasting-related data. In addition, the demultiplexer 23 splits the program data into video data and sound data. The demultiplexer 23 transmits the video data and the sound data to an AV (Audio Visual) decoder 24.

The AV decoder 24 decodes the video data and the sound data, and then, performs digital-analog conversion to generate a video signal and a sound signal. In addition, the AV decoder 24 transmits the video signal to the GUI (Graphic User Interface) overlapping unit 25.

The GUI overlapping unit 25 overlaps a graphics signal such as OSD (On Screen Display) on the video signal. The GUI overlapping unit 25 transmits the video signal with the overlapped graphics signal to an external television set 27 through a TV (television) connection terminal 26. Further, at this moment, the AV decoder 24 transmits the sound signal to the television set 27 through the TV connection terminal 26.

Accordingly, the main control unit 10 performs control such that the program video based on the video signal is displayed on a display of the television set 27 and simultaneously output the program sound based on the sound signal from the loudspeaker in synchronization with display of the program video. In this manner, the main control unit 10 can allow a user to watch the program broadcasted by the digital system broadcasting.

The main control unit 10 imports the analog broadcasting signal received by the analog system antenna 28 to the analog tuner 29 in response to the user's manipulation of the remocon RM during the analog system broadcasting program watching mode.

The analog tuner 29 extracts a broadcasting signal on an arbitrary channel from the corresponding analog broadcasting signal while receiving the analog broadcasting signal from the analog system antenna 28. In addition, the analog tuner 29 transmits the broadcasting signal extracted from the analog broadcasting signal to the demodulator 30.

The demodulator 30 demodulates the broadcasting signal according to the NTSC (National Television Standards Committee) standard to generate an NTSC signal. The demodulator 30 transmits the NTSC signal to the MPEG (Moving Picture Experts Group) encoder 31.

The MPEG encoder 31 encodes the NTSC signal according to the MPEG standard to generate program data. The MPEG encoder 31 transmits the program data to the demultiplexer 23 via the stream buffer 22.

At this moment, the demultiplexer 23 splits the program data into the video data and the sound data and transmits them to the AV decoder 24 as described above. The AV decoder 24 generates the video signal and the sound signal based on the video data and the sound data as described above. In addition, the AV decoder 24 transmits the video signal to the GUI overlapping unit 25.

The GUI overlapping unit 25 overlaps the graphics signal with the video signal as described above and transmits it to the external television set 27 through the TV connection terminal 26. Further, at this moment, the AV decoder 24 transmits the sound signal to the television set 27 through the TV connection terminal 26.

Consequently, the main control unit 10 performs control such that the program video based on the video signal is displayed on the display of the television set 27, and simultaneously, the program sound based on the sound signal is output from the loudspeaker in synchronization with the display of that program video. In this manner, the main control unit 10 can make users watch the program broadcasted by the analog system broadcasting.

However, in the digital system broadcasting or the analog system broadcasting, electronic program guide information of each channel is delivered as program information on each program functioning as a basis of the corresponding electronic program guide information. In addition, the program information on each program contains a company name of the broadcasting center which broadcasts that program (hereinafter, also referred to as a broadcasting center name), a date/time of broadcasting the corresponding program, a program title, a genre of the program, a program summary, program details, performer names, or the like.

In the digital system broadcasting, the broadcasting-related data containing the program information on the program are generated for each channel. In addition, in the digital system broadcasting, the electronic program guide information of each channel (i.e., the program information) is collectively delivered through a particular channel or individually delivered through each channel.

That is, in the digital system broadcasting, when the electronic program guide information is delivered through a particular channel, the broadcasting data of the particular channel are generated by time-division multiplexing the program data of the particular channel with the broadcasting-related data of each channel.

In the digital system broadcasting, when electronic program guide information is delivered through each channel, the broadcasting data of each channel are generated by time-division multiplexing the program data of the corresponding channel with the broadcasting-related data of that channel.

Therefore, when the electronic program guide information is delivered through a particular channel, the digital tuner 21 extracts the broadcasting data of the particular channel from the digital broadcasting signal at a predetermined timing. The digital tuner 21 transmits the broadcasting data extracted from the digital broadcasting signal to the demultiplexer 35.

When electronic program guide information is delivered through each channel, the digital tuner 21 sequentially extracts the broadcasting data of each channel from the digital broadcasting signal at a predetermined timing. The digital tuner 21 transmits the broadcasting data extracted from the digital broadcasting signal to the demultiplexer 35.

The demultiplexer 35 separates the broadcasting-related data from the broadcasting data. In addition, the demultiplexer 35 transmits the broadcasting-related data to the memory 36 to temporarily store it.

The main control unit 10 reads the broadcasting-related data from the memory 36 via the bus 11. The main control unit 10 extracts the program information on each program based on the PSI/SI (Program Specific Information/Service Information) from the broadcasting-related data.

The main control unit 10 generates the electronic program guide information using the program information on each program extracted from the broadcasting-related data, transmits it as the electronic program guide information of the digital system broadcasting to the hard disc drive 12 via the bus 11, and stores it.

In the analog system broadcasting, the program information on each program functioning as a basis of the electronic program guide information of each channel is stored in a vertical fly-back time portion of the video signal included in the broadcasting signal of a particular channel. In the analog system broadcasting, the electronic program guide information (i.e., the program information) of each channel is collectively delivered through the particular channel.

The analog tuner 29 extracts the broadcasting signal of a particular channel from the analog broadcasting signal at a predetermined timing. The analog tuner 29 transmits the broadcasting signal extracted from the analog broadcasting signal to the demodulator 30.

At this moment, the demodulator 30 generates the NTSC signal based on the broadcasting signal of a particular channel as described above. The demodulator 30 transmits the NTSC signal to the VBI (Vertical Blanking Interval) slicer 37.

The VBI slicer 37 separates the video signal from the NTSC signal, simultaneously extracts the vertical fly-back time portion from the corresponding video signal, and transmits it to the EPG (Electronic Program Guide) decoder 38.

The EPG decoder 38 obtains the program information on each program by decoding the vertical fly-back time portion extracted from the video signal and transmits it as the program information data to the memory 36 to temporarily store it.

The main control unit 10 reads the program information data on each program from the memory 36 via the bus 11. The main control unit 10 generates the electronic program guide information using the program information based on the program information data on each program and transmits it as the electronic program guide information of the analog system broadcasting to the hard disc drive 12 via the bus 11 to store it. In this manner, the main control unit 10 obtains the electronic program guide information on the digital and analog system broadcasting.

Such electronic program guide information contains, as program information on each program scheduled to broadcast for the next single week from the current time point, broadcasting center names, broadcasting date/time, program titles, genres, summaries of the program, program details, names of performers, or the like.

The main control unit 10 reads the electronic program guide information of the digital or analog system broadcasting from the hard disc drive 12 via the bus 11 in response to user's manipulation of the remocon RM.

At this moment, the main control unit 10 generates window data on a program table (hereinafter, also referred to as a program table window data) obtained by creating a table containing broadcasting schedules of a plurality of programs scheduled to broadcast based on the electronic program guide information. The main control unit 10 transmits the program table window data to the memory 39 via the bus 11 to temporarily store them.

At this moment, the GUI overlapping unit 25 reads the program table window data from the memory 39 under the control of the main control unit 10 and generates a program table window signal. In addition, the GUI overlapping unit 25 transmits the program table window signal to an external television set 27 through the TV connection terminal 26.

Consequently, the GUI overlapping unit 25 displays the program table window (not shown) of the digital or analog system broadcasting on the display of the television set 27 based on the program table window signal. In this manner, the main control unit 10 allows users to identify programs scheduled to broadcast for the next single week from the current time point using the program table window.

In this state, if an arbitrary program is selected on the program table window by user's manipulation of the remocon RM, and a recording reservation is instructed, the main control unit 10 generates recording reservation information representing a program recording date/time or the like using the program information (such as a broadcasting center name or a broadcasting date/time) of the selected program. The main control unit 10 makes a recording reservation on the program instructed to record by storing that recording reservation information, for example, in the memory 36.

For example, if the recording of the digital system broadcasting program is reserved, the main control unit 10 compares the recording date/time of the program indicated by the recording reservation information with the current date/time. When the current date/time reaches the recording date/time, the process advances to a reservation recording mode of the digital system broadcasting. Consequently, the main control unit 10 imports the digital broadcasting signal received by the digital system antenna 20 to the digital tuner 21.

The digital tuner 21 extracts the broadcasting data of the channel indicated by the recording reservation information from the corresponding digital broadcasting signal while receiving the digital broadcasting signal from the digital system antenna 20.

The digital tuner 21 sets the broadcasting data extracted from the digital broadcasting signal to program data on a program basis via the stream buffer 22 and transmits it to the hard disc drive 12 to store it. In this manner, the main control unit 10 can record the digital system broadcasting program.

Meanwhile, for example, even when the recording of the analog system broadcasting program is reserved, if the current date/time reaches the recording date/time, the main control unit 10 compares the program recording date/time indicated by the recording reservation information with the current date/time. When the current date/time reaches the recording date/time, the mode advances to the reservation recording mode of the analog system broadcasting. Consequently, the main control unit 10 imports the analog broadcasting signal received by the analog system antenna 28 to the analog tuner 29.

The analog tuner 29 extracts the broadcasting signal indicated by the recording reservation information from the corresponding analog broadcasting signal while importing the analog broadcasting signal from the analog system antenna 28. The analog tuner 29 transmits the broadcasting signal extracted from the analog broadcasting signal to the demodulator 30.

The demodulator 30 demodulates the broadcasting signal as described above to generate the NTSC signal. The demodulator 30 transmits the NTSC signal to the MPEG encoder 31. The MPEG encoder 31 encodes the NTSC signal as described above to generate the program data.

The MPEG encoder 31 transmits the program data to the hard disc drive 12 via the stream buffer 22 to store it. In this manner, the main control unit 10 can record the program of the analog system broadcasting.

If a user inputs the recording command using the remocon RM while watching the digital or analog system broadcasting program, the main control unit 10 stores the program data on the program that is being watched in the hard disc drive 12 using nearly the same method as described above. Consequently, the main control unit 10 can record the program while a user watches the digital or analog system broadcasting.

However, if the program is recorded in response to the recording reservation or the recording command input, the main control unit 10 reads the program data on the recording program from the hard disc drive 12 via the bus 11.

The main control unit 10 separates video data from the program data on that recording program. The main control unit 10 determines, for example, the frame image data located in a leading end among a plurality of pieces of frame image data constituting that image data as data (hereinafter, also referred to as representative image data) on a representative image representing the recording program (hereinafter, also referred to as a representative image).

Furthermore, the main control unit 10 detects frame identification information that can be used to identify the frame image data of the leading end as the representative image data within that image data as representative image identification information. In addition, the frame identification information includes frame numbers sequentially attached to, for example, a plurality of frame image data constituting the image data.

Moreover, the main control unit 10 generates thumbnail image data on a thumbnail image reduced by decimating pixels from the representative image based on the corresponding representative image data (i.e., the frame image) by executing a contraction process for the representative image data (i.e., the frame image data located in the leading end).

In addition, the main control unit 10 extracts a part of information such as titles, genres, or broadcasting date/times of the programs from the program information on the recording programs. The main control unit 10 generates attribute information representing attributes of the program data on the corresponding recording program by combining the information extracted from the program information, the representative image identification information (i.e., the frame identification information), and the thumbnail image data. That is, the main control unit 10 collectively sets the information extracted from the program information, the detected frame identification information, and the thumbnail image data as the attribute information on the program data.

In this manner, if the attribute information is generated, the main control unit 10 transmits the attribute information to the hard disc drive 12 via the bus 11 and stores the attribute information in the corresponding hard disc drive 12 in relation to the program data on the recording program.

However, the program recording device 1 is configured such that a digital video camera or a digital camera (not shown) can be connected thereto through the DV (Digital Video) terminal 40 or the USB (Universal Serial Bus) terminal 41. Hereinafter, these digital video camera and digital camera will be collectively referred to as a digital recording device.

The digital recording device is configured such that moving picture data can be generated by taking a film of a target object, and the photograph image data can be generated by taking a photograph of the target object. In addition, the moving picture data generated by the digital recording device includes video data obtained by taking a film of the target object and sound data obtained by recording atmospheric sounds during taking a film of the target object. Such video data contain the frame image data on a plurality of temporally consecutive frame images.

The digital recording device determines as the representative image data which represents the moving picture, for example, the frame image data located in a leading end among a plurality of pieces of frame image data in the video data of the moving picture data when the moving picture data are generated by taking a film of the target object. In addition, the digital recording device detects, as the representative image identification information, the frame identification information that can identify the frame image data located in the leading end.

Furthermore, the digital recording device generates thumbnail image data regarding thumbnail images contracted by decimating pixels as the representative image (i.e., the frame image) based on the corresponding representative image data by executing a contraction process for the representative image data (i.e., the frame image data located in the leading end).

The digital recording device generates attribute information regarding attributes of the corresponding moving picture data by combining information used to identify the moving picture data such as a title or a creating date/time (a moving picture recording date/time), the representative image identification information (i.e., the frame identification information), and the thumbnail image data.

In addition, the title that can be used to identify the moving picture data may be a file name automatically attached to the corresponding moving picture data by the digital recording device or a name arbitrarily attached by a user. Hereinafter, that title will be also referred to as a moving picture title.

When photograph image data are generated by taking a photograph of a target object, the digital recording device determines the photograph image data itself as the representative image data regarding the representative image representing the photograph images. The digital recording device generates thumbnail image data regarding the thumbnail image contracted by decimating pixels as the representative image (i.e., the photograph image) based on the corresponding representative image data by executing a contraction process for the representative image data (i.e., the photograph image data).

The digital recording device generates attribute information representing the attributes of the corresponding photograph image data by combining information regarding a title that can be used to identify the photograph image data or a creation date/time (i.e., photographing date/time) and the thumbnail image data.

In addition, the title that can be used to identify the photograph image data may be, for example, a file name automatically attached to the corresponding pthotograph image data by the digital recording device or a name arbitrarily attached by a user. Hereinafter, that title will be also referred to as a photograph title.

If the moving picture data having a predetermined format are output from the connected digital recording device through the DV terminal 40 as the moving picture signal for transmission together with the attribute information, the main control unit 10 imports them into the DV (Digital Video) decoder 42.

The DV decoder 42 decodes that moving picture signal and transmits it to the demodulator 30 together with the attribute information. If the moving picture signal and the attribute information are provided from the DV decoder 42, the demodulator 30 demodulates the moving picture signal according to the NTSC standard to generate the NTSC signal. The demodulator 30 transmits the NTSC signal to the MPEG encoder 31 together with the attribute information.

The MPEG encoder 31 generates moving picture data having a format allowed to handle within the program recording device 1 by encoding the NTSC signal according to the MPEG standard. That is, the MPEG encoder 31 converts the moving picture data having a predetermined format generated by the digital recording device into a format allowed to handle in the program recording device 1.

In addition, the moving picture data having a converted format are generated by time-division multiplexing the video data and the sound data. The video data contained in the moving picture data includes the frame image data on a plurality of temporally consecutive frame images.

The MPEG encoder 31 transmits that moving picture data to the hard disc drive 12 via a stream buffer 22 and store it therein. At this moment, the MPEG encoder transmits the attribute information to the hard disc drive 12 via the stream buffer 22 to store the attribute information in relation to the moving picture data in the corresponding hard disc drive 12. In this manner, the main control unit 10 obtains the moving picture generated by taking a film of the target object using the digital recording device.

If the photograph image data are output from the connected digital recording device together with the attribute information through the USB terminal 41, the main control unit 10 imports them into the USB controller 43.

The USB controller 43 transmits that photograph image data to the hard disc drive 12 via the stream buffer 22 to store them therein. At this moment, the USB controller 43 also transmits the attribute information to the hard disc drive 12 via the bus 11 to store the attribute information in relation to the photograph image data in the corresponding hard disc drive 12. In this manner, the main control unit 10 obtains the photograph image generated by taking a photograph of the target object using the digital recording device.

Furthermore, the main control unit 10 may import moving picture data or photograph image data transmitted from the network device (not shown) together with such attribute information by sequentially using the network terminal 44 and the network controller 45 in response to user's manipulation on the remocon RM.

The main control unit 10 transmits that moving picture data or photograph image data to the hard disc drive 12 via the bus 11 to store them therein. At this moment, the main control unit 10 also transmits the attribute information to the hard disc drive 12 via the bus 11 to store the attribute information in relation to the moving picture data or the photograph image data in the corresponding hard disc drive 12. In this manner, the main control unit 10 obtains the moving picture or photograph image provided by the network device.

In addition, the moving picture data provided by the network device is generated by time-division multiplexing the video data and the sound data. For the moving picture data, for example, the frame image data located in the leading end among a plurality of pieces of the frame image data contained in the video data are determined as the representative image data on the representative image representing the moving picture.

The attribute information representing the attribute of the moving picture data contains a moving picture title such as a file name of the corresponding moving picture data or information representing a creation date/time. The attribute information on the moving picture data contains, as the representative image identification information, the frame identification information of the frame image data located in the leading end, determined as the representative image data on the representative image.

Furthermore, the attribute information on the moving picture data also contains thumbnail image data on the thumbnail image contracted by decimating pixels as the representative image (i.e., the frame image) based on the corresponding representative image data by executing a contraction process for the representative image data (i.e., the frame image data located in the leading end).

Meanwhile, for the photograph image data provided by the network device, the photograph image data itself is determined as the representative image data on the representative image representing the photograph image. The attribute information representing the attribute of the photograph image data contains a photograph title such as a filename of the corresponding photograph image data or information such as a creation date/time.

The attribute information on the photograph image data also contains thumbnail image data on the thumbnail image contracted by decimating pixels as the representative image (i.e., the photograph image) based on the corresponding representative image data by executing a contraction process for the representative image data (i.e., the photograph image data).

If the data reproduction mode is selected by a user using the remocon RM, the main control unit 10 reads the program data or the attribute information on the moving picture data or the photograph image data from the hard disc drive 12 via the bus 11.

The main control unit 10 generates notification window data for notifying the recording program recorded until this time point or the moving pictures and photograph images obtained until this time point based on the attribute information. Furthermore, the main control unit 10 transmits the notification window data for display to the memory 39 via the bus 11 to temporarily store them.

At this moment, the GUI overlapping unit 25 reads the notification window data from the memory 39 under the control of the main control unit 10 and generates the notification window signal. The GUI overlapping unit 25 transmits the notification window signal to an external television set 27 through the TV connection terminal 26.

Consequently, the GUI overlapping unit 25 displays the notification window (not shown) on the display of the television set 27 based on the notification window signal. In this case, thumbnail images representing the corresponding recording programs, moving pictures, or photograph images are arranged within the notification window together with the program title, the moving picture title, or the photograph title.

Therefore, the main control unit 10 can notify a user of the recording programs that have been recorded until this time point or the moving pictures and photograph images that have been obtained until this time point using the program title, the moving picture title, the photograph title, and the thumbnail image within the notification window.

In this state, the main control unit 10 allows a user to select the recording program to be reproduced, the moving picture to be reproduced, or the photograph image to be produced on the notification window using the remocon RM. In practice, if the recording program is selected, the main control unit 10 reads the program data on the corresponding selected recording program from the hard disc drive 12 and transmits them to the demultiplexer 23 via the stream buffer 22.

The demultiplexer 23 splits the program data into the video data and the sound data and transmits them to the AV decoder 24 as described above. The AV decoder 24 generates the video signal and the sound signal based on the video data and the sound data as described above. In addition, the AV decoder 24 transmits the video signal to the GUI overlapping unit 25.

The GUI overlapping unit 25 overlaps the graphics signal on the video signal as described above and transmits them to the television set 27 through the TV connection terminal 26. In addition, the AV decoder 24 transmits the sound signal at this moment to the television set 27 through the TV connection terminal 26.

Consequently, the main control unit 10 performs control such that the program image based on the image signal is displayed on the display of the television set 27, and simultaneously, the program sound based on the sound signal is output from the loudspeaker in synchronization with the display of the program video. In this manner, the main control unit 10 allows a user to watch the recorded program.

If the moving picture is selected on the notification window, the main control unit 10 reads the moving picture data on the corresponding selected moving picture from the hard disc drive 12 and transmits them to the demultiplexer 23 via the stream buffer 22. The demultiplexer 23 splits the moving picture data into the video data and the sound data and transmits them to the AV decoder 24.

If the video data and the sound data are provided from the demultiplexer 23, the AV decoder 24 generates the video signal and the sound signal based on the video data and the sound data as described above. In addition, the AV decoder 24 transmits the video signal to the GUI overlapping unit 25.

If the video signal is provided from the AV decoder 24, the GUI overlapping unit 25 overlaps the graphics signal on the video signal as described above and transmits them to the television set 27 through the TV connection terminal 26. The AV decoder 24 transmits the sound signal to the television set 27 through the TV connection terminal 26 at this moment.

Consequently, the main control unit 10 performs control such that the video based on the video signal is displayed on the display of the television set 27, and simultaneously, the sound based on the sound signal is output from the loudspeaker in synchronization with the display of the video. In this manner, the main controller 10 allows a user to watch the moving picture obtained from an external device.

Furthermore, if the photograph image is selected on the notification window, the main control unit 10 reads the photograph image data on the corresponding selected photograph image from the hard disc drive 12 and transmits them to the JPEG (Joint Photographic Experts Group) decoder 46 via the stream buffer 22.

The JPEG decoder 46 decodes the photograph image data according to the JPEG standard and generates the photograph image signal by performing digital-analog conversion. The JPEG decoder 46 transmits the photograph image signal to the GUI overlapping unit 25. The GUI overlapping unit 25 overlaps the graphics signal such as OSD on the photograph image signal and transmits them to the television set 27 through the TV connection terminal 26.

Consequently, the main control unit 10 displays the photograph image based on the photograph image signal on the display of the television set 27. In this manner, the main control unit 10 allows a user to see the photograph obtained from an external device.

However, as described above, for the recording program or the moving picture, the frame image located in the leading end at that creating time point is determined as the representative image. However, it is not the typical case for a user that the frame image located in the leading end is the representative image having a characteristic portion (hereinafter, also referred to as an image characteristic portion) which accurately represents the recording program of the moving picture.

Therefore, if the image selection mode for selecting the representative image is selected by a user using the remocon RM, the main control unit 10 reads the attribute information on the program data or the moving picture data from the hard disc drive 12 via the bus 11.

The main control unit 10 generates the notification window data based on the attribute information in a similar way to the data reproduction mode described above and displays the notification window (not shown) on the display of the television set 27.

In this state, if the recording program is selected by a user on the notification window using the remocon RM, the main control unit 10 reads the program data on the corresponding selected recording program from the hard disc drive 12 via the bus 11.

The main control unit 10 separates the video data from the program data and decodes the video data. Simultaneously, the main control unit 10 sequentially extracts, for example, a single piece of the frame image data per a single second in time series from the decoded video data.

Furthermore, the main control unit 10 generates frame image list window data for displaying a list of a plurality of frame images based on the frame image data sequentially extracted from the image data. The main control unit 10 transmits the frame image list window data for display to the memory 39 via the bus 11 to temporarily store them.

At this moment, the GUI overlapping unit 25 reads the frame image list window data from the memory 39 under the control of the main control unit 10 and generates a frame image list window signal. The GUI overlapping unit 25 transmits the frame image list window signal to the external television set 27 through the TV connection terminal 26.

Consequently, the GUI overlapping unit 25 displays a frame image list window (not shown) on the display of the television set 27 based on the frame image list window signal. In this manner, the main control unit 10 allows a user to see a plurality of frame images included in the program video of a single recording program using the frame image list window.

In this state, if a single frame image is selected by a user on the frame image list window using the remocon RM, the main control unit 10 determines the frame image data on the corresponding selected single frame image as representative image data on a new representative image.

The main control unit 10 detects, as new representative image identification information, the frame identification information on the frame image data determined as the new representative image data. The main control unit generates new thumbnail image data by executing a contraction process for the representative image data (i.e., the new frame image data).

Furthermore, the main control unit 10 updates contents by exchanging the representative image identification information and the thumbnail image data that have been already contained with new representative image identification information and new thumbnail image data for the attribute information on the recording program selected by a user at this moment.

The main control unit 10 transmits the attribute information having the updated contents to the hard disc drive 12 via the bus 11 and stores the attribute information in the corresponding hard disc drive 12 so as to overwrite the updated attribute information on the attribute information before updating the contents.

In this manner, the main control unit 10 can change the frame image as the representative image representing the recording program into a frame image having an image characteristic portion considered to more accurately represent the recording program to a user. In addition, the main control unit 10 can also change the representative image (and the thumbnail image) representing the moving picture in a similar way to the case of the recording program.

However, if the disc recording mode is selected by a user using the remocon RM with the recording disc being installed inside the device, the main control unit 10 reads the attribute information from the hard disc drive 12 via the bus 11.

The main control unit 10 generates selection window data for selecting the recording program, the moving picture, and the photograph image to be recorded among the recording program recorded until this time point or the moving picture and the photograph images obtained until this time point based on the attribute information. The main control unit 10 transmits the selection window data for display to the memory 39 via the bus 11 and temporarily stores them.

At this moment, the GUI overlapping unit 25 reads the selection window data from the memory 39 under the control of the main control unit 10 to generate the selection window signal. The GUI overlapping unit 25 transmits the selection window signal to the external television set 27 via the TV connection terminal 26.

Consequently, the GUI overlapping unit 25 displays a selection window (not shown) on the display of the television set 27 based on the selection window signal. In this case, the thumbnail image representing the corresponding recording program, the moving picture, or the photograph image is arranged together with the program title, the moving picture title, or the photograph title within the selection window.

Therefore, the main control unit 10 can propose, to a user, the recording program recorded until this time point or the moving picture and the photograph image obtained until this time point using the program title, the moving picture title, the photograph title, and the thumbnail image within the selection window. The main control unit 10 allows a user to select the recording program, the moving picture, or the photograph image to be recorded on the selection window using the remocon RM.

In practice, if the recording program to be recorded is selected on the selection window, the main control unit 10 reads the program data on the corresponding selected recording program from the hard disc drive 12 together with the attribute information on that program data via the bus 11. The main control unit 10 transmits the program data on the recording program together with the attribute information to the internal drive control unit 47 via the bus 11.

At this moment, the drive control unit 47 records that program data in relation to the attribute information on the recording disc by driving and controlling the internal drive 48. Consequently, the main control unit 10 is configured to record the recording program (i.e., the program data) on the recording disc installed inside the device.

If the moving picture to be recorded is selected on the selection window, the main control unit 10 reads the moving picture data on the corresponding selected moving picture together with the attribute information on that moving picture data from the hard disc drive 12 via the bus 11. The main control unit 10 transmits the moving picture data together with the attribute information to the internal drive control unit 47 via the bus 11.

At this moment, the drive control unit 47 records that moving picture data on the recording disc in relation to the attribute information by driving and controlling the internal drive 48. Consequently, the main control unit 10 can record the moving picture (i.e., the moving picture data) obtained from an external device on the recording disc installed inside the device.

Furthermore, if the photograph image to be recorded is selected on the selection window, the main control unit 10 reads the photograph image data on the corresponding selected photograph image together with the attribute information on that photograph image data from the hard disc drive 12 via the bus 11. The main control unit 10 transmits the photograph image data together with the attribute information to the internal drive control unit 47 via the bus 11.

At this moment, the drive control unit 47 records that photograph image data in relation to the attribute information on the recording disc by driving and controlling the internal drive 48. Consequently, the main control unit 10 can record the photograph image (i.e., the photograph image data) obtained from an external device on the recording disc installed inside the device.

In this manner, the main control unit 10 can record any one kind of one or more recording programs (program data), one or more moving pictures (moving picture data), or one or more photograph images (photograph image data) on the recording disc in response to the user's instruction.

The main control unit 10 may mixedly record two or more kinds of one or more recording programs (program data), one or more moving pictures (moving picture data), or one or more photograph images (photograph image data) on the recording disc in response to the user's instruction.

Furthermore, even in the recording disc where the recording program or the moving picture has been previously recorded and output to an external device, for example, if any data unrecorded region remains, the main control unit 10 may additionally record the recording program, the moving picture, or the photograph image by installing it inside the device later.

If the disc reproduction mode is selected by a user using the remocon RM while the recording disc where the recording program, the moving picture, or the photograph image is recorded is installed inside the device, the main control unit 10 drives and controls the drive 48 using the drive control unit 47. Consequently, the main control unit 10 reads the entire attribute information recorded in the recording disc by sequentially using the drive control unit 47 and the drive 48.

The main control unit 10 generates proposal window data for proposing all of the recording programs, moving pictures, and photograph images recorded in the recording disc, for example, based on the attribute information. The main control unit 10 transmits the proposal window data to the memory 39 for display via the bus 11 and temporarily stores them.

At this moment, the GUI overlapping unit 25 reads the proposal window data from the memory 39 under the control of the main control unit 10 to generate the proposal window signal. The GUI overlapping unit 25 transmits the proposal window signal to the external television set 27 through the TV connection terminal 26.

Consequently, the GUI overlapping unit 25 displays a proposal window (not shown) on the display of the television set 27 based on the proposal window signal. In this case, the thumbnail images representing the recording programs, the moving pictures, or the photograph images are arranged within the proposal window in relation to the program titles, the moving picture titles, and the photograph titles.

Therefore, the main control unit 10 can propose, to a user, all of the recording programs, moving pictures, and photograph images recorded in the recording disc using the program titles, moving picture titles, photograph titles, and thumbnail images within the proposal window. The main control unit 10 allows a user to select the recording programs, moving pictures, or photograph images to be reproduced on the proposal window using the remocon RM.

If the recording program to be reproduced is selected by a user on the proposal window using the remocon RM, and the reproduction command is input, the main control unit 10 controls the drive control unit 47 in response to this command. Consequently, the drive control unit 47 drives and controls the drive 48 and reads the program data on the recording program selected by a user from the recording disc. The drive control unit 47 transmits the program data to the demultiplexer 23 by sequentially using the bus 11 and the stream buffer 22.

At this moment, the multiplexer 23 splits the program data into the video data and the sound data as described above and transmits them to the AV decoder 24. The AV decoder 24 generates the video signal and the sound signal based on the video data and the sound data as described above. In addition, the AV decoder 24 transmits the video signal to the GUI overlapping unit 25.

The GUI overlapping unit 25 appropriately overlaps the graphics signal on the video signal and transmits them to the external television set 27 through the TV connection terminal 26. At this moment, the AV decoder 24 transmits the sound signal to the television set 27 through the TV connection terminal 26.

Consequently, the main control unit 10 performs control such that the program video based on the video signal is displayed on the display of the television set 27, and simultaneously, the program sound based on the sound signal is output from the loudspeaker in synchronization with the display of the program video. In this manner, the main control unit 10 allows a user to watch the recording program recorded in the recording disc.

If the moving picture to be reproduced is selected by a user on the proposal window using the remocon RM, and the reproduction command is input, the main control unit 10 controls the drive control unit 47 in response to this command.

Consequently, the drive control unit 47 drives and controls the drive 48 and reads the moving picture data on the moving picture selected by a user from the recording disc. The drive control unit 47 transmits the moving picture data to the demultiplexer 23 by sequentially using the bus 11 and the stream buffer 22.

At this moment, the demultiplexer 23 splits the moving picture data into the video data and the sound data and transmits them to the AV decoder 24 as described above. The AV decoder 24 generates the video signal and the sound signal based on the video data and the sound data as described above. In addition, the AV decoder 24 transmits the video signal to the GUI overlapping unit 25.

The GUI overlapping unit 25 overlaps the graphics signal on the video signal and transmits them to the external television set 27 through the TV connection terminal 26. At this moment, the AV decoder 24 transmits the sound signal to the television set 27 through the TV connection terminal 26.

Consequently, the main control unit 10 performs control such that the video based on the video signal is displayed on the display of the television set 27, and simultaneously, the sound based on the sound signal is output from the loudspeaker in synchronization with the display of the video. In this manner, the main control unit 10 can allow a user to watch the moving picture recorded in the recording disc.

Furthermore, if the photograph image to be reproduced is selected by a user on the proposal window using the remocon RM, and the reproduction command is input, the control unit 10 controls the drive control unit 47 in response to this command.

Consequently, the drive control unit 47 drives and controls the drive 48 and reads the photograph image data on the photograph image selected by a user from the recording disc. The drive control unit 47 transmits the photograph image data to the JPEG decoder 46 by sequentially using the bus 11 and the stream buffer 22.

At this moment, the JPEG decoder 46 generates the photograph image signal based on the photograph image data and transmits it to the GUI overlapping unit 25 as described above. At this moment, the GUI overlapping unit 25 overlaps the graphics signal on the photograph image signal as described above and transmits them to the television set 27 through the TV connection terminal 26.

Consequently, the main control unit 10 displays the photograph image based on the photograph image signal on the display of the television set 27. In this manner, the main control unit 10 may show the photograph image recorded on the recording disc.

However, if the print mode is selected by a user using the remocon RM with the recording disc where the recording program, the moving picture, or the photograph image is recorded being installed inside the device, the main control unit 10 drives and controls the drive 48 using the drive control unit 47.

Consequently, the main control unit 10 reads the entire attribute information recorded thereon from the recording disc by sequentially passing through the drive control unit 47 and the drive 48. At this moment, the main control unit 10 selects a predetermined maximum number (set to one or higher number, for example, 3) of pieces of the attribute information.

In this manner, the main control unit 10 selects, as the attribute information, the recording program, the moving picture, or the photograph image to be used in the print process among all of recording programs, moving pictures, and photograph images recorded on the recording disc.

The main control unit 10 reads the program data, the moving picture data, and the photograph image data corresponding to the selected attribute information from the recording disc. At this moment, if the photograph image data on the photograph image is read from the recording disc, the main control unit 10 decodes the photograph image data that has been read and determines it as the representative image data (i.e., the representative image data on the representative image representing the photograph image) used in the print process.

At this moment, if the program data on the recording program is read from the recording disc, the main control unit 10 separates the video data from the corresponding program data. The main control unit 10 decodes the video data and simultaneously extracts the representative image data (i.e., the frame image data) identified by the representative image identification information within the attribute information from the decoded image data.

At this moment, if the moving picture data on the moving picture are read from the recording disc, the main control unit 10 separates the video data from the corresponding moving picture data. In addition, the main control unit 10 decodes the video data and simultaneously extracts the representative image data (i.e., the frame image data) identified by the representative image identification information within the attribute information from the decoded video data.

In this manner, if the representative image data on one or more representative images representing the recording program, the moving picture, or the photograph image recorded on the recording disc are obtained, the main control unit 10 generates the print image based on the representative image data. In addition, the main control unit 10 generates the print data for printing the print image on one disc surface. Further, the main control unit 10 transmits the print data to the print control unit 49 inside the device via the bus 11.

At this moment, the print control unit 49 drives and controls the printer 50 inside the device based on the print data to print the print image on one surface of the recording disc. Consequently, even when the recording disc is extracted from the device, the main control unit 10 can identify at least one of recording programs, moving pictures, and photograph images recorded on the recording disc based on the print image printed on one disc surface.

In addition, when the program is recorded, or the program and the moving picture are reproduced, the main control unit 10 generates condition notification data for notifying of the operational condition of the program recording device 1, such as a recording time or a reproduction time. In addition, the main control unit 10 transmits the condition notification data to the display control unit 52 via the bus 11.

Consequently, the display control unit 52 displays the condition notification information on the display unit 3 based on the condition notification data. In this manner, the main control unit 10 can notify a user of an operation condition of the program recording device 1 using the display unit 3.

### 1-3. Print Process of Print Image on One Surface of Recording Disc

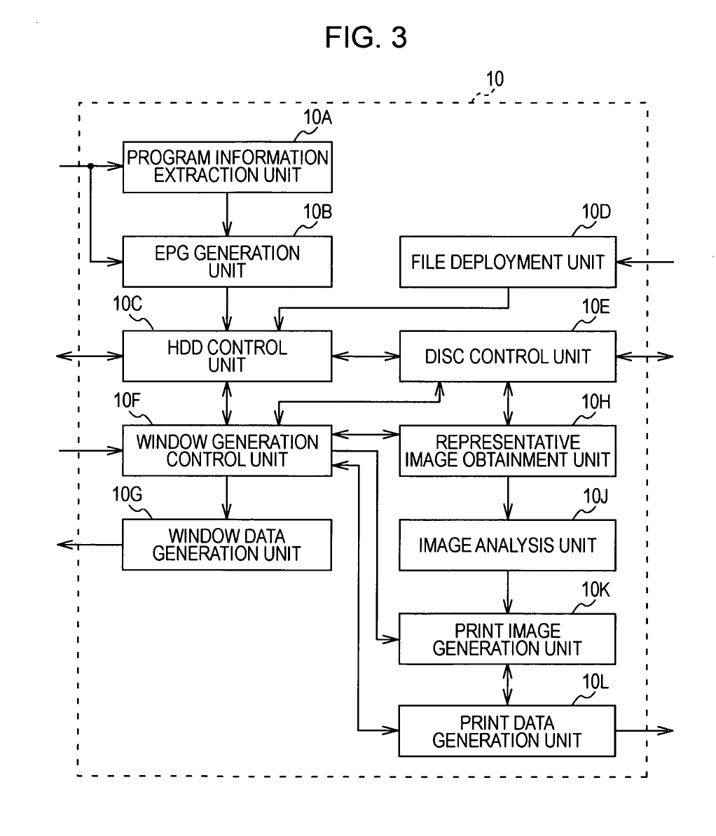

Next, a print process for printing a print image on one surface of the recording disc where the program data, the moving picture data, or the photograph image data are recorded by the main control unit 10 will be described with reference to FIG. 3. However, it is noted that the main control unit 10 implements various functions by executing various functions according to the print program.

Hereinafter, various functions implemented by the main control unit 10 according to the print program will be described as functional circuit blocks, and various processes executed by the main control unit 10 will be described as processes executed by those functional circuit blocks.

Hereinafter, when it is not necessary to particularly distinguish the program data, the moving picture data, and the photograph image data recorded on the recording disc, these program data, moving picture data, photograph image data will be collectively referred to as contents data.

Hereinafter, when it is not necessary to particularly distinguish the recording programs based on the program data, the moving pictures based on the moving picture data, and the photograph images based on the photograph image data, these recording programs, moving pictures, and photograph images will be collectively referred to as contents.

The program information extraction unit 10A reads the broadcasting-related data from the memory 36 via the bus 11. In addition, the program information extraction unit 10A extracts program information on each program from the broadcasting-related data based on the PSI/SI included therein as described above and transmits it to the EPG generation unit 10B.

The EPG generation unit 10B generates the electronic program guide information of the digital system broadcasting based on the program information on each program transmitted from the program information extraction unit 10A. In addition, the EPG generation unit 10B reads the program information data on each program from the memory 36 via the bus 11 and simultaneously generates the electronic program guide information of the analog system broadcasting based on the program information data. Furthermore, the EPG generation unit 10B transmits the electronic program guide information to the HDD (Hard Disc Drive) control unit 10C.

The HDD control unit 10C transmits various kinds of data or various kinds of information to the hard disc drive 12 via the bus 11 to store it. In addition, the HDD control unit 10C reads various kinds of data or various kinds of information from the hard disc drive 12 via the bus 11.

Therefore, if the electronic program guide information of the digital system broadcasting or the analog system broadcasting is provided from the EPG generation unit 10B, the HDD control unit 10C transmits the electronic program guide information the hard disc drive 12 via the bus 11 to store it.

The file deployment unit 10D imports the moving picture data or the photograph image data having a predetermined format transmitted from the network device by sequentially using the network terminal 44, the network controller 45, and the bus 11. In addition, the file deployment unit 10D decodes the moving picture data or the photograph image data to convert them into a format that can be handled by the program recording device 1.

The file deployment unit 10D transmits the moving picture data or the photograph image data having a converted format to the HDD control unit 10C. Consequently, the HDD control unit 10C transmits the moving picture data or the photograph image data transmitted from the network device to the hard disc drive 12 via the bus 11 to store them.

The disc control unit 10E is configured to drive and control the drive 48 using the drive control unit 47, records various kinds of data or various kinds of information in the recording disc, and reads various kinds of data or various kinds of information from the corresponding recording disc.

Therefore, the disc control unit 10E records the contents data and the attribute information read by the HDD control unit 10C from the hard disc drive 12 on the recording disc by sequentially using the drive control unit 47 and the drive 48.

In addition, the disc control unit 10E reads the attribute information from the recording disc by sequentially using the drive control unit 47 and the drive 48 and transmits it to the window generation control unit 10F. Furthermore, the disc control unit 10E reads the contents data from the recording disc by sequentially using the drive control unit 47 and the drive 48 and transmits them to the stream buffer 22 via the bus 11.

The window generation control unit 10F reads the electronic program guide information or the attribute information from the hard disc drive 12 using the HDD control unit 10C in response to user's manipulation of the remocon RM and transmits the electronic program guide information or the attribute information or the like to the window data generation unit 10G.

In addition, the window generation control unit 10F reads the attribute information from the recording disc using the disc control unit 10E in response to the user's manipulation of the remocon RM and transmits the attribute information or the like to the window data generation unit 10G.

The window data generation unit 10G generates the program table window data, the data notification window data, the selection window data, the proposal window data, or the like as described above based on the electronic program guide information or the attribute information or the like provided form the window generation control unit 10F.

The window data generation unit 10G transmits the program table window data, the notification window data, the selection window data, the proposal window data, or the like for display to memory 39 via the bus 11 to temporarily store them. In this manner, the window generation control unit 10F can display the program table window, the notification window, or the like on the display of the television set 27 using the window data generation unit 10G.

If the print mode is selected by a user using the remocon RM with the recording disc where the contents data are recorded being installed inside the device, the window generation control unit 10F makes the process advance to the print mode. The window generation control unit 10F notifies the representative image obtainment unit 10H of the fact that the process advances to the print mode.

If the fact that the process advances to the print mode is notified, the representative image obtainment unit 10H requests the disc control unit 10E to read the attribute information in response. Consequently, the disc control unit 10E drives and controls the drive 48 using the drive control unit 47 to read the entire attribute information recorded in the recording disc and transmits it to the representative image obtainment unit 10H.

If the attribute information is provided from the disc control unit 10E, the representative image obtainment unit 10H selects a predetermined maximum number (set to one or higher number, for example, 3) of pieces of the attribute information depending on the number of pieces of the attribute information. At this moment, if a total number of pieces of the attribute information read from the recording disc is equal to or smaller than the maximum number, the representative image obtainment unit 10H selects the entire attribute information.

At this moment, if a total number of pieces of the attribute information read from the recording disc is larger than the maximum number, the representative image obtainment unit 10H randomly selects a maximum number of pieces of the attribute information among all of pieces of the attribute information read from the corresponding recording disc.

In this manner, if the attribute information is selected as the contents data used in the print process, then the representative image obtainment unit 10H notifies the disc control unit 10E of the selected attribute information.

Consequently, the disc control unit 10E drives and controls the drive 48 using the drive control unit 47, reads the contents data corresponding to the notified attribute information from the recording disc, and transmits the contents data to the representative image obtainment unit 10H.

If the contents data are provided from the disc control unit 10E, the representative image obtainment unit 10H obtains representative image data by appropriately using the attribute information. That is, if the attribute information on the photograph image data is selected in this case, the representative image obtainment unit 10H decodes the photograph image data read from the recording disc in response. In addition, the representative image obtainment unit 10H determines the decoded photograph image data as the representative image data on the representative image representing the photograph image.

If the attribute information on the program data is selected in this case, the representative image obtainment unit 10H separates the video data from the program data read from the recording disc and simultaneously decode the video data in response.

In addition, the representative image obtainment unit 10H extracts the frame image data identified by the representative image identification information within the attribute information from the decoded video data and determines the extracted frame image data as the representative image data on the representative image representing the recording program.

Furthermore, if the attribute information on the moving picture data is selected in this case, the representative image obtainment unit 10H separates the video data from the moving picture data read from the recording disc in response and simultaneously decodes the video data.

Then, the representative image obtainment unit 10H extracts the frame image data identified by the representative image identification information within the attribute information from the decoded video data and determines the extracted frame image data as the representative image data on the representative image representing the moving picture. In this manner, if one or more pieces of the representative image data are obtained, the representative image obtainment unit 10H transmits the obtained representative image data to the image analysis unit 10J together with the attribute information.

Here, the representative image based on the representative image data is formed, for example, in a rectangular shape. Hereinafter, in the rectangular-shaped representative image, an image vertical direction parallel to the short side of the corresponding representative image will be also referred to as an image longitudinal direction. Hereinafter, in the representative image, one end of the image longitudinal direction will be also referred to as an upper end, and the other end of the image longitudinal direction will be also referred to as a lower end.

Hereinafter, in the rectangular-shaped representative image, an image horizontal direction parallel to the long side of the corresponding representative image will be also referred to as an image lateral direction. Hereinafter, in the representative image, one end of the image lateral direction is referred to as a left end, and the other end of the image lateral direction will be also referred to as a right end.

This representative image may have an image characteristic portion, such as a ridge of a mountain, a row of people, a train, or a tall structure, depicted to extend in a single direction, for example, in the image lateral direction or the image longitudinal direction.

The representative image may have an image characteristic portion, such as a car, a ship, a decorative article, or a bug, depicted to be short in either the image lateral direction or the image longitudinal direction and collected in a certain place such as a center of the corresponding representative image.

The representative image representing the photograph image is a photograph image itself generated by taking a photograph of the target object using the digital recording device and originally created in order to allow the target object to be more appropriately shown as the image characteristic portion.

The representative image representing the photograph image tends to be generated such that the corresponding image characteristic portion can be apparently recognized by expressing the image characteristic portion using more diversified colors on a background expressed using a relatively small number of colors such as sky, walls, or lawns.

The image characteristic portion appropriately representing the corresponding recording program or moving picture is selected by a user as the representative image representing the recording program or the moving picture as described above. That is, the representative image representing the recording program or the moving picture tends to be selected such that the corresponding image characteristic portion can be apparently recognized by expressing the image characteristic portion using more diversified colors on a background expressed using a relatively small number of colors such as sky, walls, or lawns.

Therefore, the image analysis unit 10J is configured to analyze the representative image based on, for example, colors of each pixel (e.g., RGB (Red-Green-Blue)) and cut out the area having the image characteristic portion from the corresponding representative image based on the result of the analysis as will be described later in detail.

However, if only a single piece of the contents data (any one of pieces of the program data, the moving picture data, and the photograph image data) is recorded on the recording disc, the representative image obtainment unit 10H obtains only a single piece of the representative image data and deliver it to the image analysis unit 10J.

If two or more pieces of the contents data (including the program data, the moving picture data, and the photograph image data) are recorded on the recording disc, the representative image obtainment unit 10H obtains a plurality of pieces of the representative image data corresponding to the maximum number and provides it to the image analysis unit 10J.

Hereinafter, first, a case where a single image of the representative image data is provided together with the attribute information from the corresponding representative image obtainment unit 10H to the image analysis unit 10J when a single image of the representative image data is obtained by the representative image obtainment unit 10H will be described.

Then, a case where a plurality of images of the representative image data are provided together with the attribute information from the corresponding representative image obtainment unit 10H to the image analysis unit 10J when a plurality (e.g., a maximum number of) of images of the representative image data are obtained by the representative image obtainment unit 10H will be described.

If a single image of the representative image data is provided, the image analysis unit 10J analyzes the representative image based on the corresponding representative image data and executes a first analysis cutout process for cutting out an area where the image characteristic portion extending in an image lateral direction from the representative image. Hereinafter, the image characteristic portion extending in the image lateral direction as the single direction in the representative image will be also referred to as a lengthwise characteristic portion.

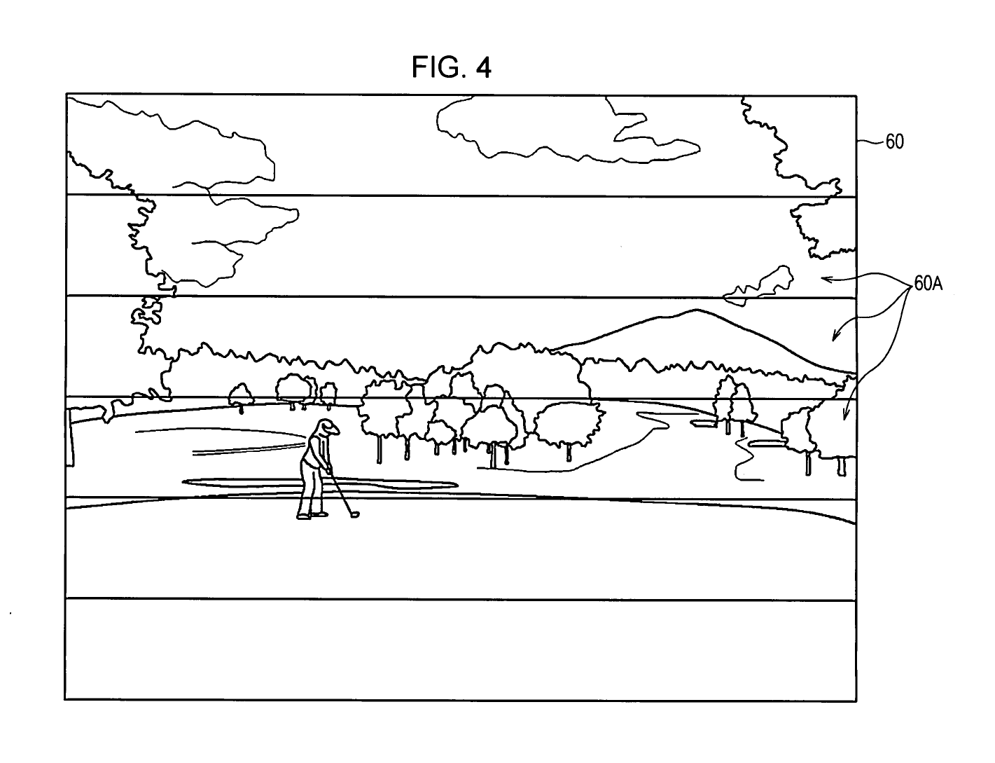

In this case, as shown in FIG. 4, the image analysis unit 10J sequentially partitions the representative image 60 based on the representative image data into analysis regions (i.e., a lengthwise analysis region) 60A having a band-shape in parallel with the image lateral direction from the upper end to the lower end.

In addition, each lengthwise analysis region 60A has a length extending from the left end to the right end in the representative image 60 and an identical width in the image longitudinal direction. The number of the lengthwise analysis regions 60A obtained by partitioning the representative image 60 is arbitrarily selected in advance.

At this moment, if the image analysis unit 10J partitions the representative image 60 having the lengthwise characteristic portion using the lengthwise analysis region 60A, it is possible to obtain an analysis region 60A where the background portion is dominated and an analysis region 60A where an image characteristic portion is dominated.

At this moment, if the lengthwise characteristic portion occupies a little area, and the background portion occupies a wide area in an analysis region 60A, there is a tendency that the number of pixels corresponding to each color (the number of colors is small) used to express the background portion is large, and the number of pixels corresponding to each color (the number of colors is large) used to express the lengthwise characteristic portion is small.

If the lengthwise characteristic portion occupies a wider area than the background portion the analysis region 60A, there is a tendency that the number of pixels corresponding each color (while the number of colors is large) used to express lengthwise characteristic portion is equal to or larger than the number of pixels corresponding to each color (while the number of colors is small) used to express the background portion.

Meanwhile, at this moment, if the image analysis unit 10J partitions the representative image having the image characteristic portion extending in the image longitudinal direction using the lengthwise analysis region 60A, it is possible to obtain an analysis region 60A where a part of the image characteristic portion is depicted, and the background portion is depicted in an enormously larger area than the image characteristic portion. Hereinafter, the image characteristic portion extending in the image longitudinal direction as the single direction in the representative image will be also referred to as a breadthwise characteristic portion.

At this moment, there is a tendency in each analysis region 60A that the number of pixels corresponding to each color (while the number of colors is small) used to express the background portion is large, and the number of pixels corresponding to each color (while the number of colors is large) used to express the breadthwise characteristic portion is small.

At this moment, if the image analysis unit 10J partitions the representative image having the image characteristic portion, which is short in any direction, using the lengthwise analysis region 60A, it is also possible to obtain an analysis region 60A where a part of the image characteristic portion is depicted, and the background portion is depicted in an enormously larger area than the image characteristic portion. Hereinafter, the image characteristic portion which is short in either image lateral direction or the image longitudinal direction in the representative image will be also referred to as a matrix-type characteristic portion.

Even in this case, there is a tendency in the analysis region 60A that the number of pixels corresponding to each color (while the number of colors is small) used to express the background portion is large, and the number of pixels corresponding to each color (while the number of colors is large) used to express the matrix-type characteristic portion is small.

Therefore, for example, the image analysis unit 10J detects the number of pixels corresponding to the red color R expressed in 256 gray-scale levels 0 to 255 from each analysis region 60A. Similarly, the image analysis unit 10J detects the number of pixels corresponding to the green color G expressed in 256 gray-scale levels 0 to 255 from each analysis region 60A. Similarly, the image analysis unit 10J detects the number of pixels corresponding to the blue color B expressed in 256 gray-scale levels 0 to 255 from each analysis region 60A.

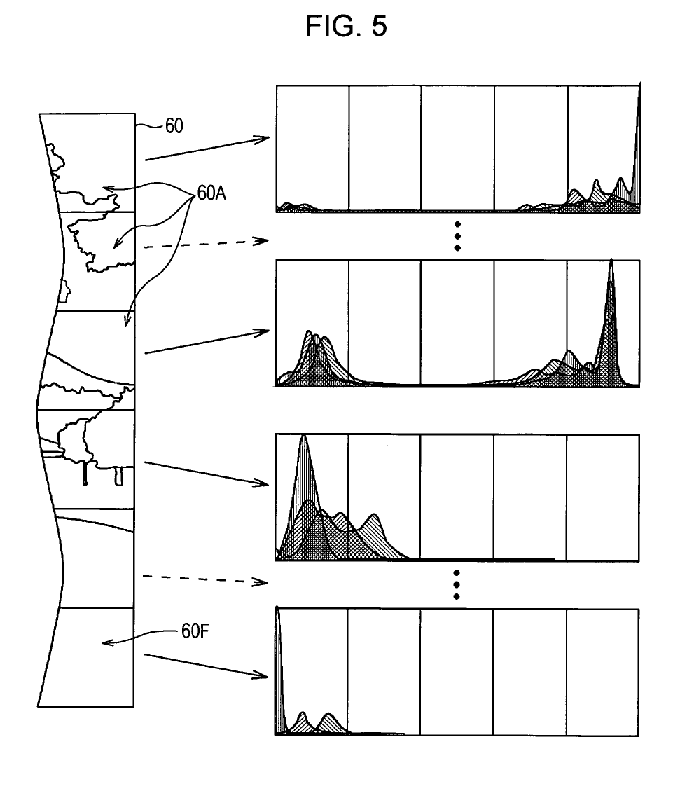

As shown in FIG. 5, the image analysis unit 10J generates an RGB histogram for each analysis region 60A by obtaining the number of pixels corresponding to each of red, green, and blue colors and normalizing the number of pixels in such a way that the highest number of pixels is set to a maximum value (e.g., 1) on the ordinate while the abscissa designates values of red, green, and blue colors.

Consequently, the image analysis unit 10J obtains, from the analysis region 60A where the background portion is dominated, an RGB histogram recognized as the number of pixels corresponding to each color used to express the background portion is large, and the number of pixels corresponding to each color used to express the image characteristic portion is nearly zero.

The image analysis unit 10J obtains, from the analysis region 60A where the image characteristic portion is dominated, an RGB histogram recognized as the number of pixels corresponding to each color used to express the image characteristic portion is generally higher than the number of pixels corresponding to each color used to express the background portion.

However, as described above, there is a tendency in the representative image that the number of colors used to express the background portion is small, and the number of colors used to express the image characteristic portion is enormously large. Therefore, the RGB histogram shows that more pixels are detected in a case where the RGB histogram is generated based on the analysis region 60A where the lengthwise characteristic portion is dominated in comparison with a case where the RGB histogram is generated based on the analysis region 60A where the background portion is dominated.

Therefore, the image analysis unit 10J integrates a function expressing the number of pixels corresponding to the red color R in the RGB histogram for each analysis region 60A to obtain an area (corresponding to the integral value) of the aggregate domain of the corresponding number of pixels surrounded by the curve of the function and the abscissa.

Similarly, the image analysis unit 10J integrates a function expressing the number of pixels corresponding to the green color G in the RGB histogram for each analysis region 60A to obtain an area (corresponding to the integral value) of the aggregate domain of the corresponding number of pixels surrounded by the curve of the function and the abscissa.

Similarly, the image analysis unit 10J integrates a function expressing the number of pixels corresponding to the blue color B in the RGB histogram for each analysis region 60A to obtain an area (corresponding to the integral value) of the aggregate domain of the corresponding number of pixels surrounded by the curve of the function and the abscissa. Furthermore, the image analysis unit 10J sums up the areas of the aggregate domains of each color R, G, and B obtained in the RGB histogram for each analysis region 60A to calculate a total area.

Here, in the RGB histogram of the analysis region 60A where the background portion is dominated, the number of pixels corresponding to each color used to express the background portion is large while the number of pixels corresponding to each color used to express the image characteristic portion is nearly zero. Therefore, the total area is relatively small.

On the contrary, in the RGB histogram of the analysis region 60A where the image characteristic portion is dominated, both the number of pixels corresponding to each color used to express the background portion and the number of pixels corresponding to each color used to express the image characteristic portion are large. Therefore, the total area is relatively large.

Therefore, the image analysis unit 10J compares each of the total areas calculated for each analysis region 60A with a predetermined first threshold value. The first threshold value is appropriately selected such that the analysis region 60A where the background portion is dominated and the analysis region 60A where the lengthwise characteristic portion is dominated can be distinguished from each other.

Consequently, the image analysis unit 10J detects the analysis region 60A having a total area equal to or larger than the first threshold value as the characteristic area 60A where a part of the lengthwise characteristic portion is depicted. The image analysis unit 10J detects two or more characteristic areas 60A adjacent to each other as a region-adjoining section.

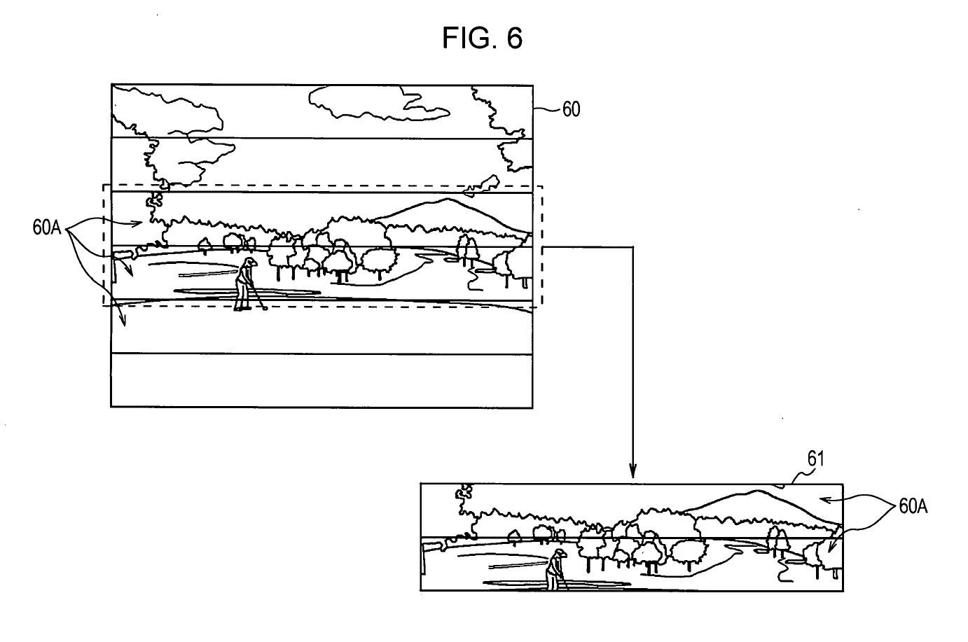

As a result, as shown in FIG. 6, if only a single region-adjoining section exists in the representative image 60, the image analysis unit 10J cuts out the corresponding region-adjoining section from the corresponding representative image 60 as the characteristic depiction area 61 where the lengthwise characteristic portion is depicted.

If two or more region-adjoining sections exist in the representative image, the image analysis unit 10J cuts out a single region-adjoining section as the characteristic depiction area from the representative image according to a predetermined cutout condition, for example, the region-adjoining section extending over the center of the image or nearest to the center of the image.

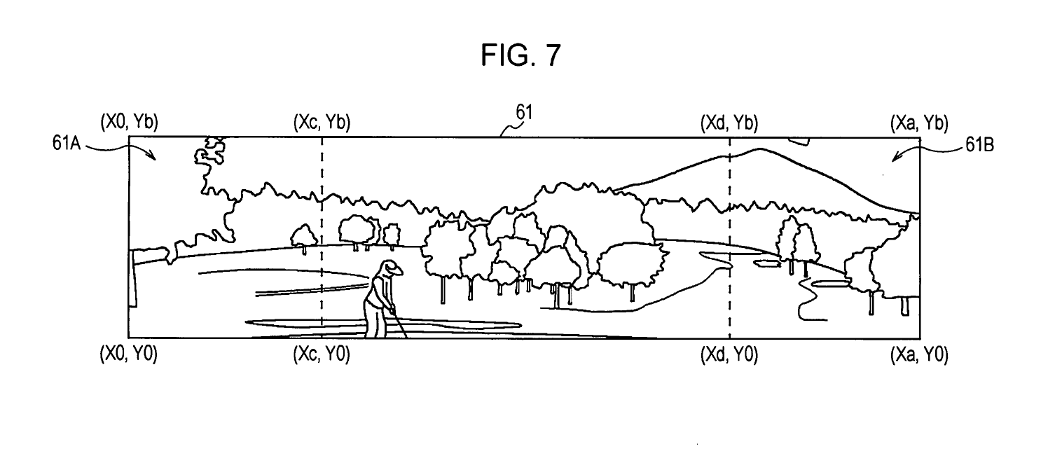

As shown in FIG. 7, if a single characteristic depiction area 61 is obtained in this manner, the image analysis unit 10J selects the position of the pixel located in the lower left corner as an origin (X0, Y0) of the rectangular coordinate system in the corresponding characteristic depiction area 61, for example, by setting the left end as an X-axis in the rectangular coordinate system and setting the lower end as the Y-axis in the rectangular coordinate system.

Consequently, the image analysis unit 10J expresses positions of each pixel of the characteristic depiction area using coordinate values of the rectangular coordinate system. At this moment, in the characteristic depiction area 61, the position of the pixel located in the lower right corner is expressed as a coordinate value (Xa, Y0), the position of the pixel located in the upper left corner is expressed as a coordinate value (X0, Yb), and the position of the pixel located in the upper right corner is expressed as a coordinate value (Xa, Yb).

The image analysis unit 10J establishes comparison regions 61A and 61B having a narrower width than that of the center portion of the characteristic depiction area 61 in the left and right ends except for the center portion in order to compare the left and right ends thereof.

Hereinafter, the comparison region 61A in the left end of the characteristic depiction area 61 will be also referred to as a left comparison region 61A, and the comparison region 61B in the right end of the characteristic depiction area 61 will be also referred to as a right comparison region 61B.

The left comparison region 61A includes each of the pixels ranged from the left end of the characteristic depiction area 61 to the location designated by the following equation 1 on a straight line parallel to the Y-axis (i.e., the image lateral direction) with a slight distance to the right (i.e., the X-coordinate is set to Xc, and the Y-coordinate is set to Y0 to Yb).

X=Xc (1)

The right comparison region 61B includes each of the pixels ranged from the right end of the characteristic depiction area 61 to the location designated by the following equation 2 on a straight line parallel to the Y-axis (i.e., the image lateral direction) with a slight distance to the left (i.e., the X-coordinate is set to Xd, and the Y-coordinate is set to Y0 to Yb).

X=Xd (2)

(Xd>Xc)

Hereinafter, a sequence of pixels on a straight line parallel to the Y-axis (i.e., from the upper end to the lower end) in the characteristic depiction area 61 will be referred to as a row.

In this state, the image analysis unit 10J compares each of the rows in the left comparison region 61A with each of the rows in the right comparison region 61B in a round-robin. In practice, the image analysis unit 10J obtains the value of each pixel in each row in the left comparison region 61A by calculating the square root of a result obtained by squaring the values of R, G, and B and adding them as shown in Equation 3.

$$P 1 = \sqrt{{\{ r ( x 1 , y ) \}}^{2} + {\{ g ( x 1 , y ) \}}^{2} + {\{ b ( x 1 , y ) \}}^{2}} \\ ( \begin{matrix}x 1 = X 0 ∼ Xc \\ y = Y 0 ∼ Yb\end{matrix} ) \qquad ( 3 )$$

where, for the left comparison region 61A, the value of R is set to r(x1, y), the value of G is set to g(x1, y), the value of B is set to b(x1, y), and the value of each pixel of each row is set to P1.

In addition, the image analysis unit 10J obtains the values of each pixel in each row in the right comparison region 61B by calculating the square root of a result obtained by squaring the values of R, G, and B and adding them according to the following Equation 4.

$$P 2 = \sqrt{{\{ r ( x 2 , y ) \}}^{2} + {\{ g ( x 2 , y ) \}}^{2} + {\{ b ( x 2 , y ) \}}^{2}} \\ ( \begin{matrix}x 2 = Xd ∼ Xa \\ y = Y 0 ∼ Yb\end{matrix} ) \qquad ( 4 )$$

where, for the right comparison region 61B, the value of R is set to r(x2, y), the value of G is set to g(x2, y), the value of B is set to b(x2, y), and the value of each pixel of each row is set to P2.

Furthermore, the image analysis unit 10J calculates a sum of difference values S1 (hereinafter, also referred to as a difference sum value) as an absolute value of the sum of differences between the value of each pixel of each row in the left comparison region 61A and the corresponding value of each pixel of each row in the right comparison region 61B according to the following Equation 5.

$$\begin{matrix}S 1 = {\sum }_{y = Y 0}^{Yb} \vert P 2 - P 1 \vert \\ = {\sum }_{y = Y 0}^{Yb} \vert \begin{matrix}\sqrt{{\{ r ( x 2 , y ) \}}^{2} + {\{ g ( x 2 , y ) \}}^{2} + {\{ b ( x 2 , y ) \}}^{2}} - \\ \sqrt{{\{ r ( x 1 , y ) \}}^{2} + {\{ g ( x 1 , y ) \}}^{2} + {\{ b ( x 1 , y ) \}}^{2}}\end{matrix} \vert\end{matrix} \\ ( \begin{matrix}x 1 = X 0 ∼ Xc \\ x 2 = Xb ∼ Xa\end{matrix} ) \qquad ( 5 )$$

where, S1 denotes a difference sum value between the value of each pixel of each row in the left comparison region 61A and the corresponding value of each pixel of each row in the right comparison region 61B.

The image analysis unit 10J uses the difference sum value calculated by performing a round-robin between each row of the left comparison region 61A and each row of the right comparison region 61B as an index for representing a similarity between the each row of the left comparison region 61A and the each row of the right comparison region 61B.

Specifically, it can be said that the left and right comparison regions 61A and 61B have a lower similarity as the difference sum value is larger because a sequence of colors or hues expressed by each pixel in a single row are different from each other.

In addition, it can be said that the left and right comparison regions 61A and 61B have a higher similarity as the difference sum value is smaller because a sequence of colors or hues expressed by each pixel in a single row are similar to each other.

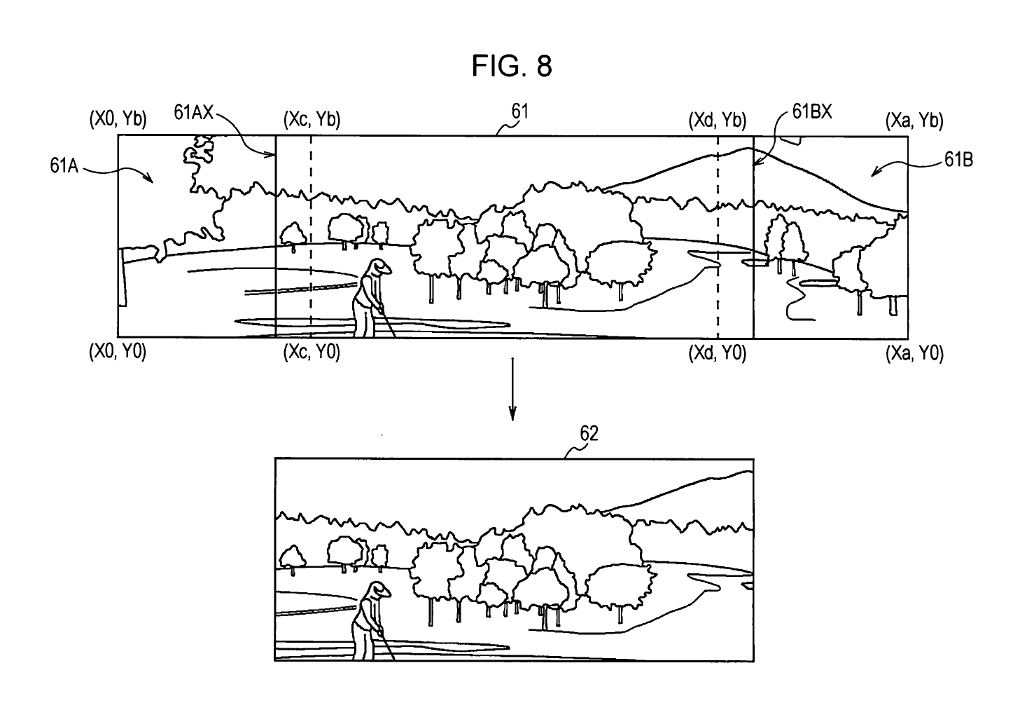

Therefore, as shown in FIG. 8, the image analysis unit 10J selects a pair of a single row 61AX of the left comparison region 61A and a single row 61BX of the right comparison region 61B that can provide the smallest difference sum value from various combinations of a single row of the left comparison region 61A and a single row of the right comparison region 61B.

Hereinafter, the smallest difference sum value selected from various difference sum values will be also referred to as a minimum difference sum value. Hereinafter, in the pair of the single row 61AX of the left comparison region 61A and the single row 61BX of the right comparison region 61B that can provide the minimum difference sum value, the single row 61AX selected from the corresponding left comparison region 61A will be also referred to as a left selection row 61AX.

Hereinafter, in the pair of the single row 61AX of the left comparison region 61A and the single row 61BX of the right comparison region 61B that can provide the minimum difference sum value, the single row 61BX selected from the corresponding right comparison region 61B is also referred to as a right selection row 61BX.

The image analysis unit 10J cuts out the left side with respect to the left selection row 61AX from the left comparison region 61A in the characteristic depiction area 61. Similarly, image analysis unit 10J cuts out the right side with respect to the right selection row 61BX from the right comparison region 61B in the characteristic depiction area 61.

The image analysis unit 10J cuts out an area (i.e., ranged from the left selection row 61AX to the right selection row 61BX) obtained by setting the left selection row 61AX as the left end and setting the right selection row 61BX as the right end from the characteristic depiction area 61 to obtain a characteristic depiction image 62 functioning as a basis of the print image.

In this manner, for the representative image 60 where the lengthwise characteristic portion is depicted, the image analysis unit 10J analyzes the corresponding representative image 60 to detect an area where the lengthwise characteristic portion is depicted. The image analysis unit 10J generates a quadrilateral characteristic depiction image 62 where the lengthwise characteristic portion is dominantly depicted while excluding the background portion as much as possible by cutting out the detected area from the representative image 60. Hereinafter, the characteristic depiction image 62 where the lengthwise characteristic portion is dominantly depicted will be also referred to as a lengthwise characteristic image 62.

However, when a single image is obtained, if the image analysis unit 10J is not allowed to detect the characteristic area even by executing the detection process for the characteristic area during the first analysis cutout process, it is probable that the breadthwise characteristic portion or the matrix-type characteristic portion is depicted.

For this reason, if it is difficult to detect the characteristic area during the first analysis cutout process, the image analysis unit 10J stops the first analysis cutout process at that time point. Then, the image analysis unit 10J re-analyzes the representative image used in the first analysis cutout process that has been stopped and executes the second analysis cutout process for cutting out the area where the breadthwise characteristic portion is depicted from the representative image as the characteristic depiction image.

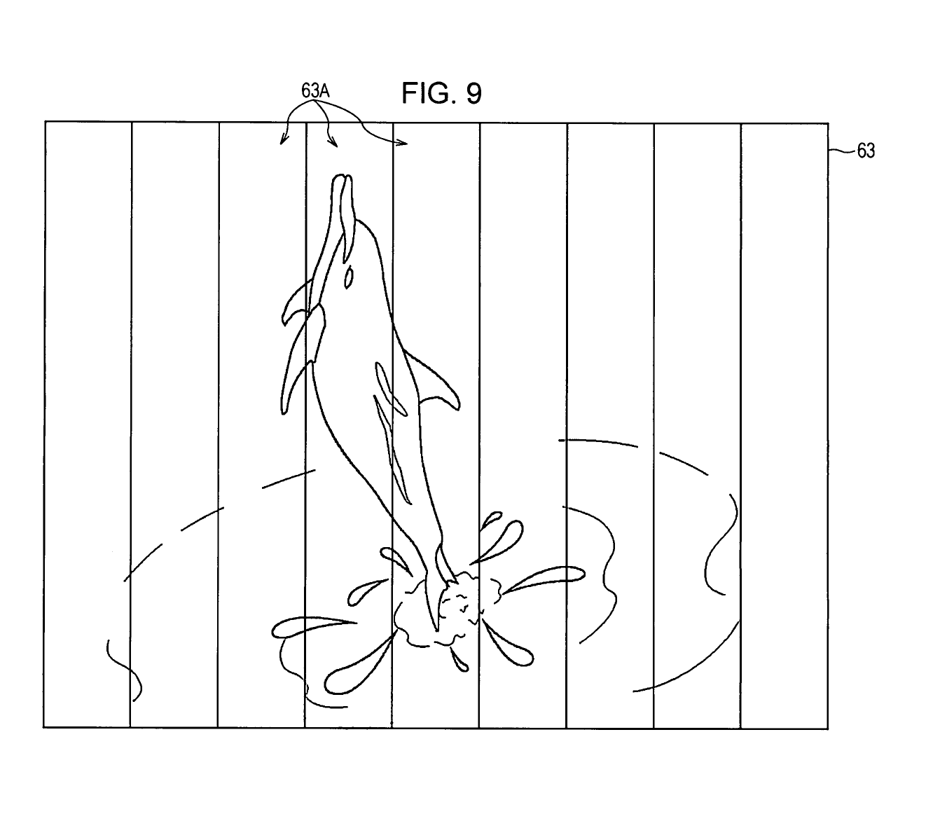

In this case, as shown in FIG. 9, the image analysis unit 10J sequentially partitions the representative image 63 from the left end to the right end into analysis regions 63A (i.e., breadthwise analysis regions) having a band-shape parallel to the image longitudinal direction.

In addition, each of the breadthwise analysis regions 63A has a length extending from the upper end to the lower end in the representative image 63 and has the same widths in the image lateral direction. The number of the breadthwise analysis regions 63A obtained by partitioning the representative image 63 is arbitrarily selected.

At this moment, if the image analysis unit 10J partitions the representative image 63 where the breadthwise characteristic portion is depicted into the breadthwise analysis region 63A, it is possible to obtain the analysis region 63A where the background portion is dominated and the analysis region 63A where breadthwise characteristic portion is dominated.

At this moment, if the breadthwise characteristic portion occupies a little area, and the background portion occupies a large area in the analysis region 63A, there is a tendency that the number of pixels corresponding to each color (the number of colors is small) used to express the background portion is large, and the number of pixels corresponding to each color (the number of colors is large) used to express the breadthwise characteristic portion is small.

If the breadthwise characteristic portion occupies a larger area than the background portion in the analysis region 63A, there is a tendency that the number of pixels corresponding to each color (the number of colors is large) used to express the breadthwise characteristic portion is equal to or larger than the number of pixels corresponding to each color (the number of colors is small) used to express the background portion.

Meanwhile, if the image analysis unit 10J partitions the representative image 63 where the matrix-type characteristic portion is depicted using the breadthwise analysis region 63A, it is possible to obtain the analysis region 63A where a part of the matrix-type characteristic portion is depicted, and the background portion occupies an enormously larger area than the matrix-type characteristic portion.

At this moment, there is a tendency in each analysis region 63A that the number of pixels corresponding to each color (the number of colors is small) used to express the background portion is large, and the number of pixels corresponding to each color (the number of colors is large) used to express the matrix-type characteristic portion is small.

Therefore, as described above, the image analysis unit 10J generates an RGB histogram for each analysis region 63A. Consequently, the image analysis unit 10J obtains, from the analysis region 63A where the background portion is dominated, an RGB histogram recognized as the number of pixels corresponding to each color used to express the background portion is large, and the number of pixels corresponding to each color used to express the image characteristic portion is little.

In addition, the image analysis unit 10J obtains, from the analysis region 63A where the image characteristic portion is dominated, an RGB histogram recognized as the number of pixels corresponding to each color used to express the image characteristic portion is generally larger than the number of pixels corresponding to each color used to express the background portion.

However, as described above, there is a tendency in the representative image that the number of colors used to express the background portion, and the number of colors used to express the image characteristic portion is enormously large. Therefore, the RGB histogram shows that more pixels are detected in a case where the RGB histogram is generated based on the analysis region 60A where the image characteristic portion is dominated in comparison with a case where the RGB histogram is generated based on the analysis region 60A where the background portion is dominated.

Therefore, even in this case, the image analysis unit 10J calculates a total area by summing up the areas of the aggregate domains of the number of pixels corresponding to each color R, G, and B in the RGB histogram. The image analysis unit 10J compares the total area calculated for each analysis region 63A with a predetermined second threshold value.

The second threshold value is appropriately selected so that the analysis region 63A where the breadthwise characteristic portion is dominated and the analysis region 63A where the background portion is dominated can be distinguished from each other.

Consequently, the image analysis unit 10J detects the analysis region 63A having a total area equal to or larger than the second threshold value as the characteristic area 63A where a part of the breadthwise characteristic portion is depicted. The image analysis unit 10J detects two or more characteristic areas 63A adjacent to each other among the characteristic areas 63A as the region-adjoining section.

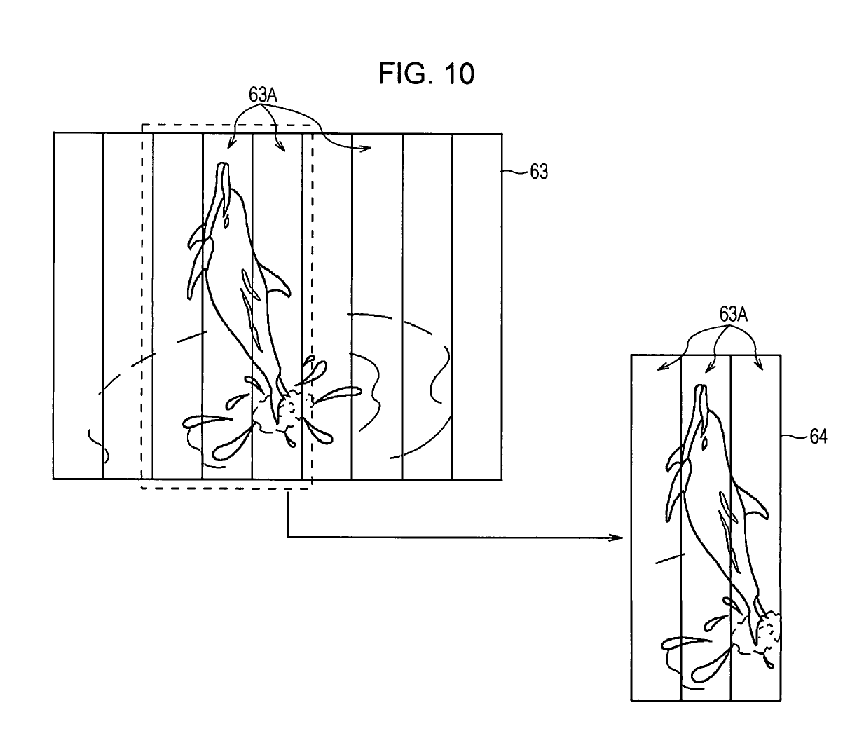

As a result, as shown in FIG. 10, if a single region-adjoining section exists in the representative image 63, the image analysis unit 10J cuts out that region-adjoining section from the corresponding representative image 63 as the characteristic depiction area 64 where the breadthwise characteristic portion is depicted.

In a case where two or more region-adjoining sections exist in the representative image 63, the image analysis unit 10J cuts out a single region-adjoining section extending over the center of the image or nearest to the center of the image as the characteristic depiction area from the representative image according to a predetermined cutout condition described above.

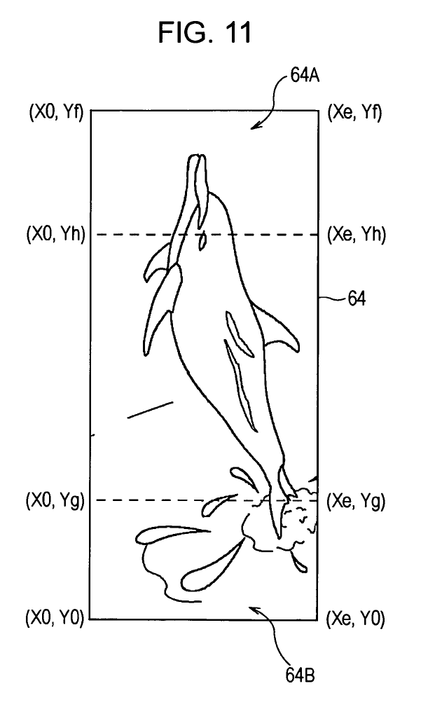

As shown in FIG. 11, if a single characteristic depiction area 64 is obtained in this manner, the image analysis unit 10J selects the position of the pixel located in the lower left corner as an origin (X0, Y0) of the rectangular coordinate system in the corresponding characteristic depiction area 64, for example, by setting the left end as an X-axis in the rectangular coordinate system and setting the lower end as the Y-axis in the rectangular coordinate system.

Consequently, the image analysis unit 10J expresses positions of each pixel of the characteristic depiction area using coordinate values of the rectangular coordinate system. At this moment, in the characteristic depiction area 64, the position of the pixel located in the lower right corner is expressed as a coordinate value (Xe, Y0), the position of the pixel located in the upper left corner is expressed as a coordinate value (X0, Yf), and the position of the pixel located in the upper right corner is expressed as a coordinate value (Xe, Yf).

The image analysis unit 10J establishes comparison regions 64A and 64B having a narrower width than that of the center portion of the characteristic depiction area 64 in the left and right ends except for the center portion in order to compare the left and right ends thereof.

Hereinafter, the comparison region 64A in the upper end of the characteristic depiction area 61 will be also referred to as an upper comparison region 64A, and the comparison region 64B in the lower end of the characteristic depiction area 64 will be also referred to as a lower comparison region 64B.

The upper comparison region 64A includes each of the pixels ranged from the upper end of the characteristic depiction area 64 to the location designated by the following equation 6 on a straight line parallel to the X-axis (i.e., the image longitudinal direction) with a slight distance to the bottom (i.e., the X-coordinate is set to X0 to Xe, and the Y-coordinate is set to Yh).

Y=Yh (6)

Y=Yh

The lower comparison region 64B includes each of the pixels ranged from the lower end of the characteristic depiction area 64 to the location designated by the following equation 7 on a straight line parallel to the X-axis (i.e., the image longitudinal direction) with a slight distance to the top (i.e., the X-coordinate is set to X0 to Xe, and the Y-coordinate is set to Yg).

Y=Yg (7)

(Yg<Yh)

Hereinafter, a sequence of pixels on a straight line parallel to the X-axis (i.e., from the left end to the right end) in the characteristic depiction area 64 will be also referred to as a column.

In this state, the image analysis unit 10J compares each of the columns in the upper comparison region 64A with each of the columns in the lower comparison region 64B in a round-robin. In practice, the image analysis unit 10J obtains the value of each pixel in each column in the upper comparison region 64A by calculating the square root of a result obtained by squaring the values of R, G, and B and adding them as shown in Equation 8.

$$P 3 = \sqrt{{\{ r ( x , y 1 ) \}}^{2} + {\{ g ( x , y 1 ) \}}^{2} + {\{ b ( x , y 1 ) \}}^{2}} \\ ( \begin{matrix}x = X 0 ∼ Xe \\ y 1 = Yh ∼ Yf\end{matrix} ) \qquad ( 8 )$$

where, for the upper comparison region 64A, the value of R is set to r(x, y1), the value of G is set to g(x, y1), the value of B is set to b(x, y1), and the value of each pixel of each column is set to P3.

In addition, the image analysis unit 10J obtains the value of each pixel in each column in the lower comparison region 64B by calculating the square root of a result obtained by squaring the values of R, G, and B and adding them as shown in Equation 9.

$$P 4 = \sqrt{{\{ r ( x , y 2 ) \}}^{2} + {\{ g ( x , y 2 ) \}}^{2} + {\{ b ( x , y 2 ) \}}^{2}} \\ ( \begin{matrix}x = X 0 ∼ Xe \\ y 2 = Y 0 ∼ Yg\end{matrix} ) \qquad ( 9 )$$

where, for the lower comparison region 64B, the value of R is set to r(x, y2), the value of G is set to g(x, y2), the value of B is set to b(2, y2), and the value of each pixel of each column is set to P4.

Furthermore, the image analysis unit 10J obtains a difference sum value S2 as an absolute value of the sum of differences between the value of each pixel of each column in the upper comparison region 64A and the corresponding value of each pixel of each column in the lower comparison region 64B according to the following Equation 10.

$$\begin{matrix}S 2 = {\sum }_{x = X 0}^{Xe} \vert P 4 - P 3 \vert \\ = {\sum }_{x = X 0}^{Xe} \vert \begin{matrix}\sqrt{{\{ r ( x , y 2 ) \}}^{2} + {\{ g ( x , y 2 ) \}}^{2} + {\{ b ( x , y 2 ) \}}^{2}} - \\ \sqrt{{\{ r ( x , y 1 ) \}}^{2} + {\{ g ( x , y 1 ) \}}^{2} + {\{ b ( x , y 1 ) \}}^{2}}\end{matrix} \vert\end{matrix} \\ ( \begin{matrix}y 1 = Yh ∼ Yf \\ y 2 = Y 0 ∼ Yg\end{matrix} ) \qquad ( 10 )$$

where, S2 denotes a difference sum value between the value of each pixel of each column in the upper comparison region 64A and the corresponding value of each pixel (i.e., the pixel having the same X-coordinate value) of each column in the lower comparison region 64B.

The image analysis unit 10J uses the difference sum value calculated by performing a round-robin between each column of the upper comparison region 64A and each column of the lower comparison region 64B as an index for representing a similarity between the each column of the upper comparison region 64A and the each column of the lower comparison region 64B.

Specifically, similar to the left and right comparison regions 61A and 61B described above, it can be said that the upper and lower comparison regions 64A and 64B have a lower similarity as the difference sum value is larger because a sequence of colors or hues expressed by each pixel in a single column are different from each other.

In addition, similar to the left and right comparison regions 61A and 61B described above, it can be said that the upper and lower comparison regions 64A and 64B have a higher similarity as the difference sum value is smaller because a sequence of colors or hues expressed by each pixel in a single column are similar to each other.

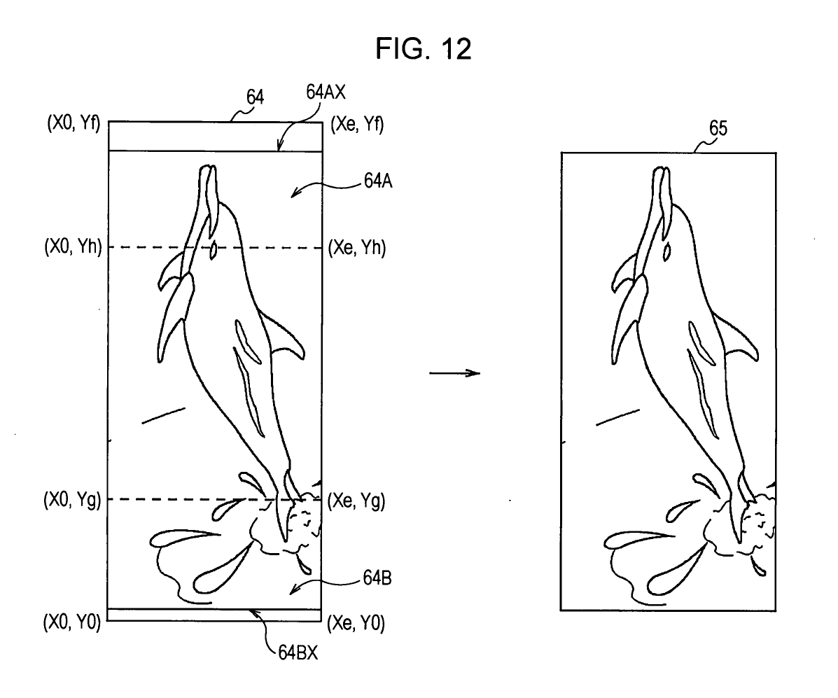

Therefore, as shown in FIG. 12, the image analysis unit 10J selects a pair of a single column 64AX of the upper comparison region 64A and a single column 64BX of the lower comparison region 64B that can provide the minimum difference sum value from various combinations of a single column of the upper comparison region 64A and a single column of the lower comparison region 64B.

Hereinafter, in the pair of the single column 64AX of the upper comparison region 64A and the single column 64BX of the lower comparison region 64B that can provide the minimum difference sum value, the single column 64AX selected from the corresponding upper comparison region 64A will be also referred to as an upper selection column 64AX.

Hereinafter, in the pair of the single column 64AX of the upper comparison region 64A and the single column 64BX of the lower comparison region 64B that can provide the minimum difference sum value, the single column 64BX selected from the corresponding lower comparison region 64B will be also referred to as a lower selection column 64BX.

The image analysis unit 10J cuts out the upper side with respect to the upper selection column 64AX from the upper comparison region 64A in the characteristic depiction area 64. Similarly, image analysis unit 10J cuts out the lower side with respect to the lower selection column 64BX from the lower comparison region 64B in the characteristic depiction area 64.

The image analysis unit 10J cuts out an area (i.e., ranged from the upper selection column 64AX to the lower selection column 64BX) obtained by setting the upper selection column 64AX as the upper end and setting the lower selection column 64BX as the lower end from the characteristic depiction area 64 to obtain a characteristic depiction image 65 functioning as a basis of the print image.

In this manner, for the representative image 63 where the breadthwise characteristic portion is depicted, the image analysis unit 10J analyzes the corresponding representative image 63 to detect an area where the breadthwise characteristic portion is depicted. The image analysis unit 10J generates a quadrilateral characteristic depiction image 65 where the breadthwise characteristic portion is dominantly depicted by cutting out the detected area from the representative image 63 while excluding the background portion as much as possible. Hereinafter, the characteristic depiction image 65 where the breadthwise characteristic portion is dominantly depicted will be also referred to as a breadthwise characteristic image 65.

However, when a single image is obtained, if it is difficult for the image analysis unit 10J to detect the characteristic area even by executing the detection process for the characteristic area during the second analysis cutout process, the image analysis unit 10J stops second analysis cutout process because the representative image where the matrix-type characteristic portion is depicted is used in this case.

Then, the image analysis unit 10J re-analyzes the representative image used in the first and second analysis cutout processes that have been stopped and executes the third analysis cutout process for cutting out the area where the matrix-type characteristic portion is depicted from the representative image as the characteristic depiction image.

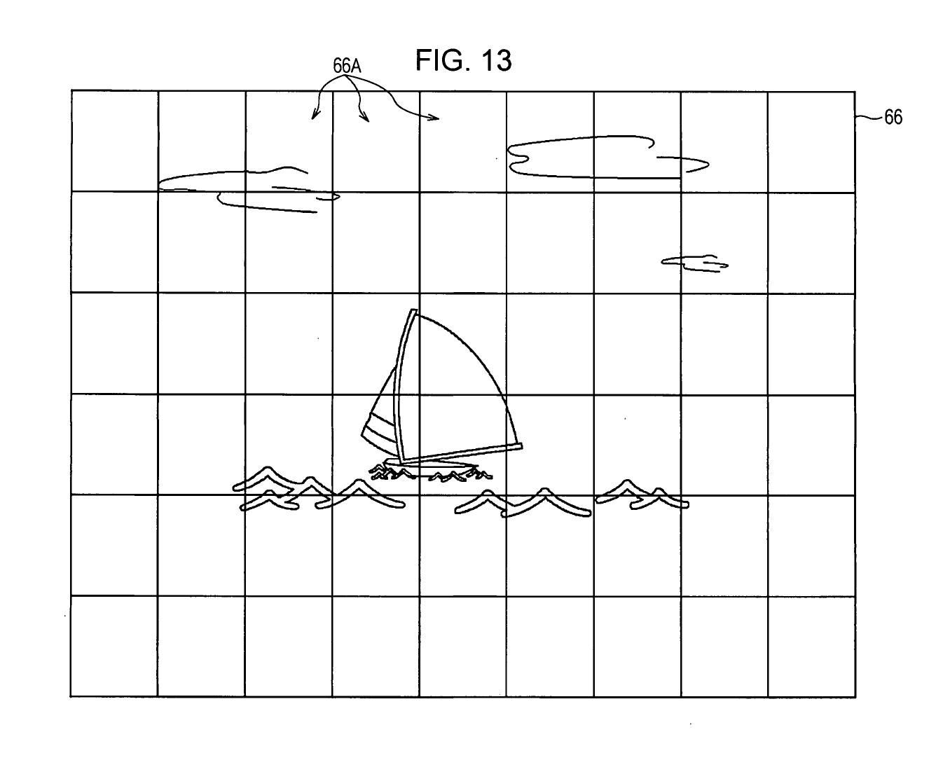

In this case, as shown in FIG. 13, the image analysis unit 10J partitions the entire representative image into, for example, a plurality of quadrilateral analysis regions 66A. In addition, each of the quadrilateral analysis regions 66A has the same size. The number of the quadrilateral analysis regions 66A obtained by partitioning the representative image 66 is not limited to that shown in the drawing but may be arbitrarily selected.

At this moment, if the image analysis unit 10J partitions the representative image 66 where the matrix-type characteristic portion is depicted into the quadrilateral analysis regions 66A, it is possible to obtain the analysis region 66A where the background portion is dominated and the analysis region 66A where matrix-type characteristic portion is dominated.

At this moment, if the matrix-type characteristic portion occupies a little area, and the background portion occupies a large area in the analysis region 66A, there is a tendency that the number of pixels corresponding to each color (the number of colors is small) used to express the background portion is large, and the number of pixels corresponding to each color (the number of colors is large) used to express the matrix-type characteristic portion is small.

If the matrix-type characteristic portion occupies a larger area than the background portion in the analysis region 66A, there is a tendency that the number of pixels corresponding to each color (the number of colors is large) used to express the matrix-type characteristic portion is equal to or larger than the number of pixels corresponding to each color (the number of colors is small) used to express the background portion.

Therefore, as described above, the image analysis unit 10J generates an RGB histogram for each analysis region 66A. Consequently, the image analysis unit 10J obtains, from the analysis region 66A where the background portion is dominated, an RGB histogram recognized as the number of pixels corresponding to each color used to express the background portion is large, and the number of pixels corresponding to each color used to express the matrix-type characteristic portion is little.

In addition, the image analysis unit 10J obtains, from the analysis region 66A where the matrix-type characteristic portion is dominated, an RGB histogram recognized as the number of pixels corresponding to each color used to express the matrix-type characteristic portion is generally larger than the number of pixels corresponding to each color used to express the background portion.

However, as described above, there is a tendency in the representative image 66 that the number of colors used to express the background portion is large, and the number of colors used to express the matrix-type characteristic portion is enormously large. Therefore, the RGB histogram shows that more pixels are detected in a case where the RGB histogram is generated based on the analysis region 66A where the matrix-type characteristic portion is dominated in comparison with a case where the RGB histogram is generated based on the analysis region 66A where the background portion is dominated.

Therefore, the image analysis unit 10J calculates a total area by summing up the areas of the aggregate domains of the number of pixels corresponding to each color R, G, and B in the RGB histogram. The image analysis unit 10J compares the total area calculated for each analysis region 66A with a predetermined third threshold value.

The third threshold value is appropriately selected so that the analysis region 66A where the matrix-type characteristic portion is dominated and the analysis region 66A where the background portion is dominated can be distinguished from each other.

Consequently, the image analysis unit 10J detects the analysis region 66A having a total area equal to or larger than the third threshold value as the characteristic area 66A where a part of the matrix-type characteristic portion is depicted. The image analysis unit 10J detects two or more characteristic areas 66A adjacent to each other regardless of the image lateral direction and the image longitudinal direction among the characteristic areas 66A as the region-adjoining section.

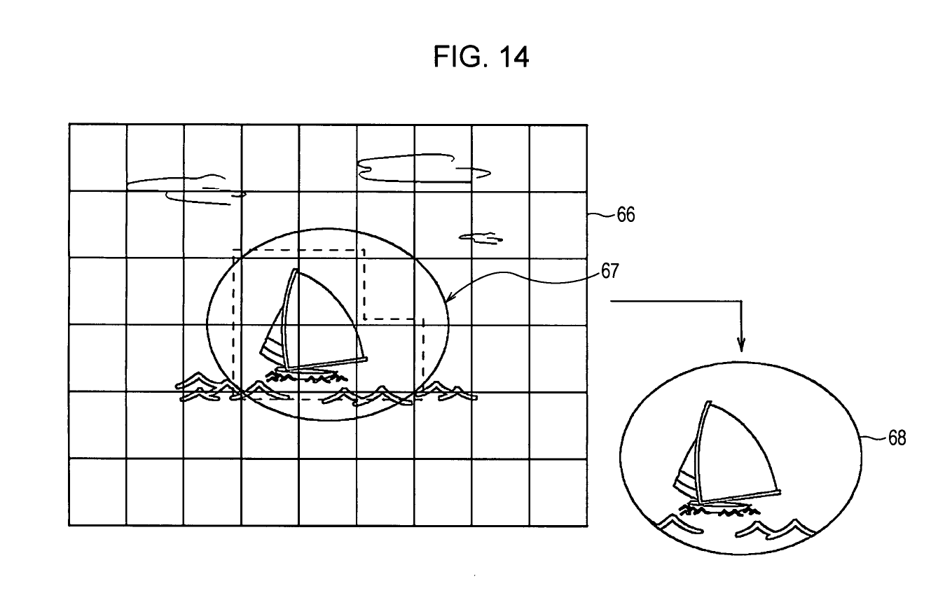

As a result, as shown in FIG. 14, if only a single region-adjoining section exists in the representative image 66, the image analysis unit 10J generates a smallest circular or elliptical envelope 67, for example, which is close to at least a part of the region-adjoining section and surrounds the region-adjoining section.

In as case where the envelope 67 surrounding the region-adjoining section is formed of an elliptical shape, the image analysis unit 10J generates the envelope 67 by parallelizing one of the major axis and the minor axis of the ellipsoid with the image longitudinal direction according to the shape of the region-adjoining section.

The image analysis unit 10J cuts out the portion surrounded by the envelope 67 (i.e., the portion including the region-adjoining section) from the representative image 66 as the characteristic depiction image 68 where the matrix-type characteristic portion is dominated while excluding the background portion as much as possible.

In a case where two or more region-adjoining sections exist in the representative image, the image analysis unit 10J surrounds a single region-adjoining section extending over the center of the representative image or nearest to the center of the representative image with an envelope and cuts out the portion surrounded by the envelope as the characteristic depiction image from the representative image.

In this manner, for the representative image 66 where the matrix-type characteristic portion is depicted, the image analysis unit 10J analyzes the corresponding representative image 66 to detect an area where the matrix-type characteristic portion is depicted.

The image analysis unit 10J generates a characteristic depiction image 68 where the matrix-type characteristic portion is dominantly depicted by cutting out the detected area from the representative image 66 while excluding the background portion as much as possible. Hereinafter, the characteristic depiction image 68 where the matrix-type characteristic portion is dominantly depicted will be also referred to as a matrix-type characteristic image 68.

In this manner, if the lengthwise characteristic image 62 is generated by executing the first analysis cutout process, the image analysis unit 10J transmits the generated lengthwise characteristic image 62 together with the corresponding minimum difference sum value and the attribute information to the print image generation unit 10K.

In addition, if the breadthwise characteristic image 65 is generated by executing the second analysis cutout process subsequently after the first analysis cutout process is stopped, the image analysis unit 10J transmits the breadthwise characteristic image 65 together with the corresponding minimum difference sum value and the attribute information to the print image generation unit 10K.

In addition, if the matrix-type characteristic image 68 is generated by executing the third analysis cutout process subsequently after the first and second analysis cutout processes are stopped, the image analysis unit 10J transmits the matrix-type characteristic image 68 together with the corresponding attribute information to the print image generation unit 10K.

Meanwhile, if a plurality of images are obtained, if a plurality of (two or more) pieces of the representative image data are provided from the representative image obtainment unit 10H, the image analysis unit 10J also appropriately executes the first, second, and third analysis cutout processes sequentially using a single piece of the representative image data as described above.

Consequently, the image analysis unit 10J generates any one of the lengthwise characteristic image 62, the breadthwise characteristic image 65, and the matrix-type characteristic image 68 sequentially based on a single representative image data. In other words, at this moment, the image analysis unit 10J generates at least one of the lengthwise characteristic image 62, the breadthwise characteristic image 65, and the matrix-type characteristic image 68 according to the type of the image characteristic portion depicted in each of a plurality of the representative images.

Therefore, at this moment, the image analysis unit 10J may generate only the lengthwise characteristic image 62, only the breadthwise characteristic image 65, or only the matrix-type characteristic image 68 according to the image characteristic portions depicted in a plurality of the representative images based on a plurality of the representative images.

At this moment, the image analysis unit 10J may generate the lengthwise characteristic image 62 and the breadthwise characteristic image 65, and may not generate the matrix-type characteristic image 68 based on a plurality of the representative images. Furthermore, the image analysis unit 10J may generate the matrix-type characteristic image 68 and one of the lengthwise characteristic image 62 and the breadthwise characteristic image 65, and may not generate the other one of the lengthwise characteristic image 62 and the breadthwise characteristic image 65 based on a plurality of the representative images.

In this manner, if the lengthwise characteristic image 62 or the breadthwise characteristic image 65 is generated at this moment, the image analysis unit 10J transmits the generated lengthwise characteristic image 62 or the breadthwise characteristic image 65 together with the corresponding minimum difference sum value and the attribute information to the print image generation unit 10K. If the matrix-type characteristic image 68 is generated at this moment, the image analysis unit 10J transmits the generated matrix-type characteristic image 68 together with the corresponding attribute information to the print image generation unit 10K.

Here, when a single image is obtained, the print image generation unit 10K is provided with any one of the lengthwise characteristic image 62, the breadthwise characteristic image 65, and the matrix-type characteristic image 68 from the image analysis unit 10J. When a plurality of images are obtained, the print image generation unit 10K is provided with a plurality of the lengthwise characteristic image 62, the breadthwise characteristic image 65, and/or the matrix-type characteristic image 68 from the image analysis unit 10J.

Hereinafter, first, a description will be given for a case where the print image generation unit 10K is provided with one of the lengthwise characteristic image 62, the breadthwise characteristic image 65, and matrix-type characteristic image 68 from the image analysis unit 10J when a single image is obtained.

Then, a description will be given for a case where the print image generation unit 10K is provided with a plurality of the lengthwise characteristic images 62, the breadthwise characteristic images 65, and/or matrix-type characteristic images 68 from the image analysis unit 10J when a plurality of images are obtained.

When a single image is obtained, if a single lengthwise characteristic image 62 is provided together with the corresponding minimum difference sum value and the attribute information from image analysis unit 10J, the print image generation unit 10K compares the minimum difference sum value with a predetermined fourth threshold value.

The fourth threshold value is appropriately selected in order to determine whether or not the hues are similar to each other between one end and the other end as much as they do not generate uncomfortable feeling when one end of the image is bonded with the other end.

Therefore, if the minimum difference sum value is equal to or smaller than the fourth threshold value, the print image generation unit 10K determines that the hues are similar to each other between one end and the other end of the lengthwise characteristic image 62 as much as they do not generate uncomfortable feeling and uses the corresponding lengthwise characteristic image 62 as an original image of the print image without change. Hereinafter, the original image used to generate the print image will be also referred to as a print source image.

On the contrary, if the minimum difference sum value is larger than the fourth threshold value, the print image generation unit 10K determines that the hues are significantly different between one end and the other end of the lengthwise characteristic image 62 and sets a portion of the lengthwise characteristic image 62 ranged from the left end to several rows distant to the right end side as an effect region for which the special effect process is executed.

At this moment, the print image generation unit 10K also sets a portion of the lengthwise characteristic image 62 ranged from the right end to several rows distant to the left end side as the effect region to which a special effect process is applied. Hereinafter, the effect region located in the left end of the lengthwise characteristic image 62 will be also referred to as a left effect region, and the effect region located in the right end of the lengthwise characteristic image 62 will be also referred to as a right effect region.

Here, the special effect process may include a feathering process in which a feathering level of the depiction in the left effect region is smoothly strengthened from the right end side to the left end, and a feathering level of the depiction in the right effect region is smoothly strengthened from the left end side to the right end.

The special effect process may include a gradation process in which brightness or chroma in the left effect region is smoothly decreased from the right end side to the left end, and brightness or chroma in the right effect region is smoothly decreased from the left end side to the right end.

The print image generation unit 10K executes, as the special effect process, one of the feathering and gradation processes selected by a user in advance for the left and right effect regions of the lengthwise characteristic image 62.

Consequently, the print image generation unit 10K equalizes the hues between the left and right ends of the lengthwise characteristic image 62. The print image generation unit 10K selects the lengthwise characteristic image 62 subjected to the special effect process as the print source image.

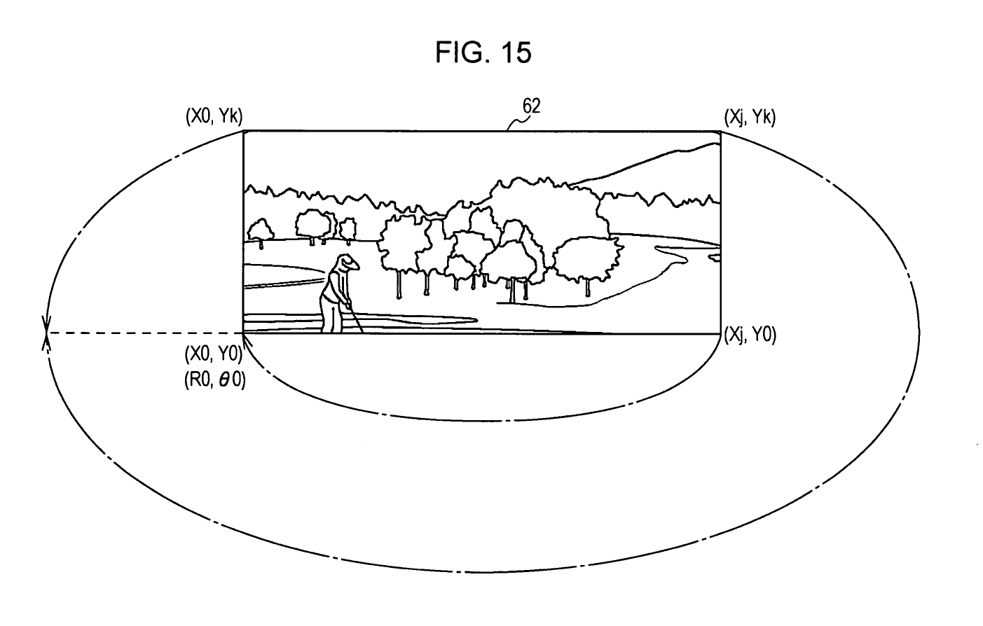

Then, as shown in FIG. 15, the print image generation unit 10K selects the position of the pixel located in the lower left corner as an origin (X0, Y0) of the rectangular coordinate system in the lengthwise characteristic image 62 corresponding to the print source image, for example, by setting the left end as an X-axis in the rectangular coordinate system and setting the lower end as the Y-axis in the rectangular coordinate system.

Consequently, the print image generation unit 10K expresses positions of each pixel of the lengthwise characteristic image 62 using coordinate values of the rectangular coordinate system. At this moment, in the lengthwise characteristic image 62, the position of the pixel located in the lower right corner is expressed as a coordinate value (Xj, Y0), the position of the pixel located in the upper left corner is expressed as a coordinate value (X0, Yk), and the position of the pixel located in the upper right corner is expressed as a coordinate value (Xj, Yk).

The print image generation unit 10K sets the origin (X0, Y0) of the rectangular coordinate system as the pole (R0, θ0) of the polar coordinate system and sets the X-axis of the rectangular coordinate system as the initial line of the polar coordinate system. In addition, print image generation unit 10K obtains a distance R from the pole to the location of each pixel based on the coordinate value representing the location of each pixel in the polar coordinate system.

Furthermore, the print image generation unit 10K also obtains the yawing angle θ of the line segment obtained by connecting the pole and the location of the pixel with respect to the initial line based on the coordinate value representing the location of each pixel in the rectangular coordinate system. In this manner, the print image generation unit 10K converts the coordinate value (X, Y) based on the rectangular coordinate system representing the location of each pixel of the lengthwise characteristic image 62 to the polar coordinate value (R, θ).

The print image generation unit 10K concurrently changes the locations of each pixel into the polar coordinate system by substituting pixels other than the pole with pixel of the pole by changing the locations of pixels other than the pixel of the pole among pixels of a single column located in the lower end in the lengthwise characteristic image 62 into the pole and radially arranging each row from the pole at the same time.

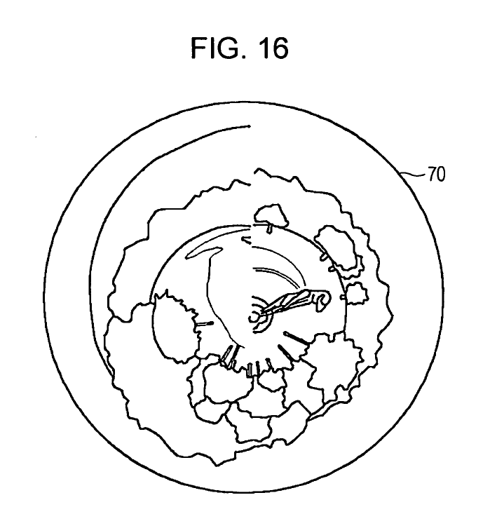

Consequently, as shown in FIG. 16, the print image generation unit 10K generates a circular print image 70 by reducing the lower end of the lengthwise characteristic image 62 to set the pole as the center of the image, setting the upper end as the outer circumference of the image, and bonding the left and right ends.

That is, the print image generation unit 10K generates the print image 70 obtained by transforming the quadrilateral lengthwise characteristic image 62 into a circular shape and sequentially deploying the lengthwise characteristic portion extending in a single direction (e.g., the image lateral direction) depicted in the quadrilateral lengthwise characteristic image 62 along the arc centered at the pole.

In the circular print image 70, the length (i.e., the length of a single row) of the left end (and the right end) of the lengthwise characteristic image 62 becomes a radius. Hereinafter, the radius of the print image 70 will be also referred to as an image radius.

However, if the print image generation unit 10K generates the print image 70 without changing the number of pixels within the lengthwise characteristic image 62, among each pixel located in various concentric circles centered at the pole, each pixel located in the concentric circle has a larger gap as the radius of the concentric circle increases.

Therefore, the print image generation unit 10K interpolates a new pixel in the gap between each pixel on the concentric circle located in the outer circumference within the print image 70 using a plurality of pixels located near the gap. Consequently, the print image generation unit 10K prevents degradation in the image quality of the print image generated when each pixel is sparsely arranged as the radius of the outer circumference increases.

In this manner, if the print image 70 is generated based on the lengthwise characteristic image 62, the print image generation unit 10K transmits that print image 70 to the print data generation unit 10L.

When a single image is obtained, if a single breadthwise characteristic image 65 is provided from the image analysis unit 10J together with the corresponding minimum difference sum value and the attribute information, the print image generation unit 10K also compares the minimum difference sum value with the fourth threshold value.

As a result, if the minimum difference sum value is equal to or smaller than the fourth threshold value, the print image generation unit 10K determines that the hues are similar to each other between the upper end and the lower end of the breadthwise characteristic image 65 as much as they do not generate uncomfortable feeling and uses the corresponding breadthwise characteristic image 65 as the print source image without change.

On the contrary, if the minimum difference sum value is larger than the fourth threshold value, the print image generation unit 10K determines that the hues are significantly different between the upper and lower ends of the breadthwise characteristic image 65 and sets a portion of the breadthwise characteristic image 65 ranged from the upper end to several columns distant to the lower end side as the effect region.

At this moment, the print image generation unit 10K also sets a portion of the breadthwise characteristic image 65 ranged from the lower end to several columns distant to the upper end side as the effect region. Hereinafter, the effect region located in the upper end of the breadthwise characteristic image 65 will be referred to as an upper effect region, and the effect region located in the lower end of the breadthwise characteristic image 65 will be also referred to as a lower effect region.

Furthermore, similar to the case of the lengthwise characteristic image 62 described above, the print image generation unit 10K executes the special effect process for the upper and lower effect regions of the breadthwise characteristic image 65. Consequently, the print image generation unit 10K equalizes the hues between the upper and lower ends of the breadthwise characteristic image 65 and selects the breadthwise characteristic image 65 subjected to the special effect process as the print source image.

Then, as shown in FIG. 17, the print image generation unit 10K selects the position of the pixel located in the lower left corner as an origin (X0, Y0) of the rectangular coordinate system in the breadthwise characteristic image 65 corresponding to the print source image, for example, by setting the left end as an X-axis in the rectangular coordinate system and setting the lower end as the Y-axis in the rectangular coordinate system.

Consequently, the print image generation unit 10K expresses positions of each pixel of the breadthwise characteristic image 65 using coordinate values of the rectangular coordinate system. At this moment, in the breadthwise characteristic image 65, the position of the pixel located in the lower right corner is expressed as a coordinate value (Xm, Y0), the position of the pixel located in the upper left corner is expressed as a coordinate value (X0, Yn), and the position of the pixel located in the upper right corner is expressed as a coordinate value (Xm, Yn).

In addition, similar to the case of the lengthwise characteristic image 62 described above, the print image generation unit 10K converts the coordinate value (X, Y) based on the rectangular coordinate system representing the location of each pixel of the breadthwise characteristic image 65 to the polar coordinate value (R, θ)

The print image generation unit 10K concurrently changes the locations of each pixel into the polar coordinate system by substituting pixels other than the pole with pixel of the pole by changing the locations of all pixels other than the pixel of the pole among pixels of a single column located in the left end in the breadthwise characteristic image 65 into the pole and radially arranging each column from the pole at the same time.

Consequently, the print image generation unit 10K generates a circular print image (not shown) by reducing the left end of the breadthwise characteristic image 65 to set the pole as the center of the image, setting the right end as the outer circumference of the image, and bonding the upper and lower ends.

That is, the print image generation unit 10K generates the print image by transforming the quadrilateral breadthwise characteristic image 65 into a circular shape and deploying the breadthwise characteristic portion extending in a single direction (e.g., the image longitudinal direction) depicted in the quadrilateral breadthwise characteristic image 65 along the arc centered at the pole.

The length (i.e., the length of a single column) of the upper end (and the lower end) of the breadthwise characteristic image 65 becomes a radius. In addition, if the print image generation unit 10K generates the print image without changing the number of pixels within the breadthwise characteristic image 65, among each pixel located in various concentric circles centered at the pole, each pixel located in the concentric circle has a larger gap as the radius of the concentric circle increases.

Therefore, similar to the case where the lengthwise characteristic image 62 is used as described above, the print image generation unit 10K interpolates a new pixel in the gap between each pixel on the concentric circle located in the outer circumference within the print image. Consequently, the print image generation unit 10K prevents degradation in the image quality of the print image generated when each pixel is sparsely arranged as the radius of the outer circumference increases.

In this manner, if the print image is generated based on the breadthwise characteristic image 65, the print image generation unit 10K transmits that print image to the print data generation unit 10L.

However, when a single image is obtained, if the matrix-type characteristic image 68 is provided from the image analysis unit 10J together with the corresponding attribute information, the print image generation unit 10K does not process that matrix-type characteristic image 68 in the same way as the lengthwise characteristic image 62 or the breadthwise characteristic image 65. Subsequently, the print image generation unit 10K transmits the matrix-type characteristic image 68 as the print image to the print data generation unit 10L without change.

Meanwhile, when a plurality of images are obtained, if a plurality of the lengthwise characteristic images 62, breadthwise characteristic images 65 and/or the matrix-type characteristic images 68 are provided together with the corresponding difference sum value or the attribute information from the image analysis unit 10J, the print image generation unit 10K determines the type of the image provided at this moment.

If a plurality of the lengthwise characteristic images 62, the breadthwise characteristic images 65 and/or the matrix-type characteristic images 68 are provided from the image analysis unit 10J, the print image generation unit 10K is set to first use the lengthwise characteristic image 62 and the breadthwise characteristic image 65 to generate the print image.

That is, if the matrix-type characteristic image 68 is provided from the image analysis unit 10J together with the lengthwise characteristic image 62 and/or the breadthwise characteristic image 65, the print image generation unit 10K excludes the matrix-type characteristic image 68 and selects only the lengthwise characteristic image 62 and/or the breadthwise characteristic image 65 to generate the print image.

At this moment, the print image generation unit 10K generates a single print image based on all (one or a plurality) of the lengthwise characteristic image 62 and/or the breadthwise characteristic image 65 selected for generating the print image. The print image generation unit 10K transmits the print image to the print data generation unit 10L but does not transmit the print image based on the matrix-type characteristic image 68 to the print data generation unit 10L.

If only the lengthwise characteristic image 62 and/or the breadthwise characteristic image 65 are provided from the image analysis unit 10J, the print image generation unit 10K selects them all for generating the print image. At this moment, the print image generation unit 10K generates a single print image based on a plurality of the lengthwise characteristic images 62 and/or the breadthwise characteristic images 65 selected for generating the print image. Then, the print image generation unit 10K transmits the print image to the print data generation unit 10L.

However, if only a plurality of the matrix-type characteristic images 68 are provided from the image analysis unit 10J, the print image generation unit 10K selects all of the matrix-type characteristic images 68 for generating the print image.

The print image generation unit 10K transmits a plurality of the matrix-type characteristic images 68 to the print data generation unit 10L as the print image without particularly processing all of the matrix-type characteristic images 68 selected for generating the print image.

In practice, when a plurality of images are selected, if one of the lengthwise characteristic image 62 or the breadthwise characteristic image 65 is selected for generating the print image, the print image generation unit 10K processes it as described above in conjunction with a case where a single image is selected. That is, the print image generation unit 10K generates a single print image based on the selected one of the lengthwise characteristic image 62 or the breadthwise characteristic image 65. Then, the print image generation unit 10K transmits that print image to the print data generation unit 10L.

When a plurality of image are selected, if the print image generation unit 10K selects, for example, two breadthwise characteristic image is selected for generating the print image, the print image generation unit 10K executes a pre-processing for generating the print image. In this case, the print image generation unit 10K sets, as a reference width, the width (in this case, the number of pixels corresponding to a single row from the upper end to the lower end) extending in one direction (e.g., the image longitudinal direction) perpendicular to the other direction (e.g., the image lateral direction) where the lengthwise characteristic portion is longitudinally depicted within a single lengthwise characteristic image.

In addition, the print image generation unit 10K sets, as a comparison target width, the width (also in this case, the number of pixels corresponding to a single row from the upper end to the lower end) extending in one direction (e.g., the image longitudinal direction) perpendicular to the other direction (e.g., the image lateral direction) where the lengthwise characteristic portion is longitudinally depicted within a single lengthwise characteristic image.

The print image generation unit 10K compares the comparison target width with the reference width. As a result, if the comparison target width is equal to the reference width, the print image generation unit 10K terminates the pre-processing so that one and the other breadthwise characteristic images can be used in a process for generating the print image without change.

On the contrary, if the comparison target width is different from the reference width, the print image generation unit 10K enlarges the other lengthwise characteristic image by appropriately interpolating pixels as a whole or contracts the other lengthwise characteristic image by appropriately decimating pixels. Consequently, the print image generation unit 10K matches the width of the other lengthwise characteristic image with the width of the one of the lengthwise characteristic images and terminates the pre-processing.

In this manner, when the one and the other lengthwise characteristic images have different widths, the print image generation unit 10K equalizes them, and then, uses them in the process for generating the print image.

If the pre-processing is terminated, the print image generation unit 10K calculates a difference sum value between the values of each pixel of a single row in the right end of the one lengthwise characteristic image and the corresponding values of each pixel of a single row in the left end of the other lengthwise characteristic image as described above in conjunction with Equations 1 to 5. Then, the print image generation unit 10K compares that difference sum value with the fourth threshold value.

As a result, if the difference sum value is equal to or smaller than the fourth threshold value, the print image generation unit 10K determines that the hues are similar to each other between the right end of the one lengthwise characteristic image and the left end of the other lengthwise characteristic image as much as they do not generate uncomfortable feeling. Therefore, the print image generation unit 10K does not execute the special effect process for the right end of the one lengthwise characteristic image and the left end of the other lengthwise characteristic image.

On the contrary, if the difference sum value is larger than the fourth threshold value, the print image generation unit 10K determines that the hues are relatively different between the right end of the one lengthwise characteristic image and the left end of the other lengthwise characteristic image. In addition, the print image generation unit 10K sets the right effect region in the right end of the one lengthwise characteristic image.

At this moment, the print image generation unit 10K sets the left effect region in the left end of the other lengthwise characteristic image. The print image generation unit 10K executes the special effect process for the right end of the one lengthwise characteristic image and the left end of the other lengthwise characteristic image as described above. Consequently, the print image generation unit 10K equalizes the hues between the right end of the one lengthwise characteristic image and the left end of the other lengthwise characteristic image.

Similarly, the print image generation unit 10K calculates the difference sum value between the values of each pixel of a single row in the left end of the one lengthwise characteristic image and the corresponding values of each pixel of a single row in the right end of the other lengthwise characteristic image.

The print image generation unit 10K compares that difference sum value with the fourth threshold value. As a result, if the difference sum value is equal to or smaller than the fourth threshold value, the print image generation unit 10K does not execute the special effect process for the left end of the one lengthwise characteristic image and the right end of the other lengthwise characteristic image.

On the contrary, if the difference sum value is larger than the fourth threshold value, the print image generation unit 10K sets the left effect region in the left end of the one lengthwise characteristic image and sets the right effect region in the right end of the other lengthwise characteristic image.

The print image generation unit 10K executes the special effect process for the left effect region of the one lengthwise characteristic image and the right effect region of the other lengthwise characteristic image. Consequently, the print image generation unit 10K equalizes the hues between the left end of the one lengthwise characteristic image and the right end of the other lengthwise characteristic image.

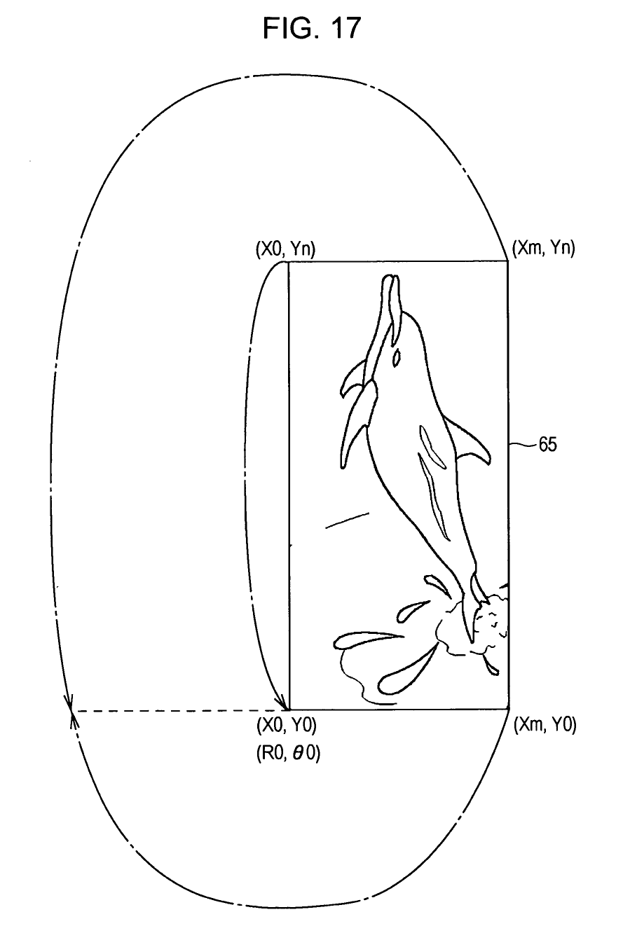

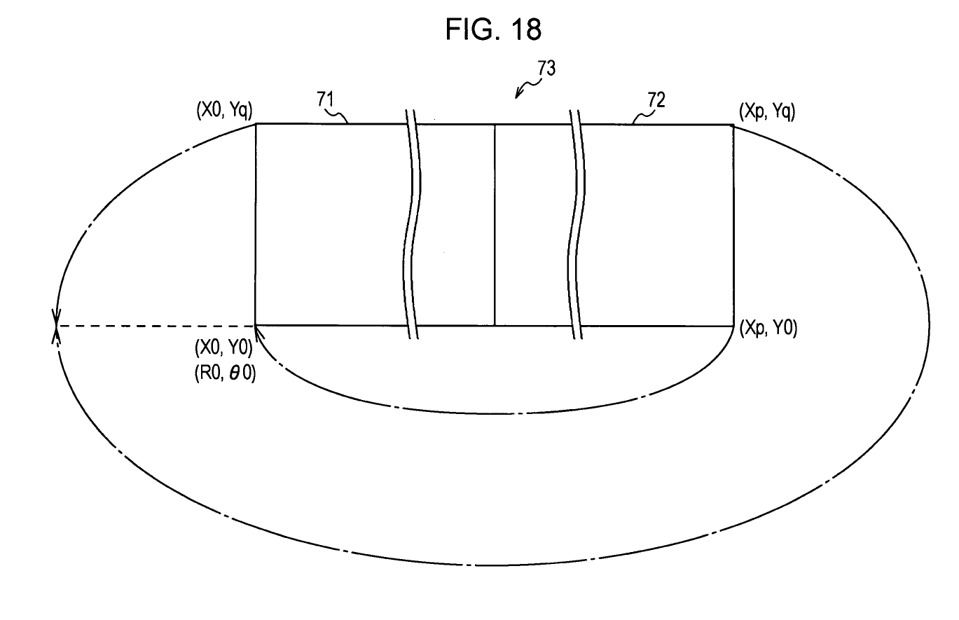

In this state, as shown in FIG. 18, the print image generation unit 10K generates a single consecutive characteristic depiction image 73 by connecting the right end of the one lengthwise characteristic image 71 to the left end of the other lengthwise characteristic image 72 and selects the generated single characteristic depiction image 73 as the print source image.

The print image generation unit 10K selects, for example, the left end (e.g., the left end of the one lengthwise characteristic image 71) within the consecutive characteristic depiction image 73 as the X-axis of the rectangular coordinate system. In addition, the print image generation unit 10K selects, for example, the lower end (e.g., the lower ends of the one and the other lengthwise characteristic images 71 and 72) within the consecutive characteristic depiction image 73 as the Y-axis of the rectangular coordinate system. The print image generation unit 10K selects the position of the pixel located in the lower left corner (e.g., the lower left corner of the one lengthwise characteristic image 71) as the origin (X0, Y0) of the rectangular coordinate system.

Consequently, the print image generation unit 10K expresses positions of each pixel of the consecutive characteristic depiction image 73 using coordinate values of the rectangular coordinate system. At this moment, in the consecutive characteristic depiction image 73, the position of the pixel located in the lower right corner (in practice, the lower right corner of the one lengthwise characteristic image 72) is expressed as a coordinate value (Xp, Y0).

Also, in the consecutive characteristic depiction image 73, the position of the pixel located in the upper left corner (in practice, the upper left corner of the one lengthwise characteristic image 71) is expressed as a coordinate value (X0, Yq). Furthermore, in the consecutive characteristic depiction image 73, the position of the pixel located in the upper right corner (in practice, the upper right corner of the other lengthwise characteristic image 72) is expressed as a coordinate value (Xp, Yq).

Similar to the case of the lengthwise characteristic image 62 described above, the print image generation unit 10K converts the coordinate value (X, Y) based on the rectangular coordinate system representing the location of each pixel of the consecutive characteristic depiction image 73 to the polar coordinate value (R, θ).

The print image generation unit 10K concurrently changes the locations of each pixel into the polar coordinate system by substituting pixels other than the pole with pixel of the pole by changing the locations of pixels other than the pixel of the pole among pixels of a single column located in the lower end in the consecutive characteristic depiction image 73 into the pole and radially arranging each row from the pole at the same time.

Consequently, the print image generation unit 10K generates a circular print image (not shown) by reducing the lower end of the consecutive characteristic depiction image 73 to set the pole as the center of the image, setting the upper end as the outer circumference of the image, and bonding the left and right ends.

That is, the print image generation unit 10K generates the print image by transforming the quadrilateral consecutive characteristic depiction image 73 into a circular shape and sequentially deploying two lengthwise characteristic portions extending in a single direction (e.g., the image lateral direction) depicted in the quadrilateral consecutive characteristic depiction image 73 along the arc centered at the pole.

In the print image, the length (i.e., the length of a single row) of the left end (and the right end) of the consecutive characteristic depiction image 73 is set to the radius of the image. Also in this case, the print image generation unit 10K appropriately interpolates the gap between each pixel in the print image.

In this manner, if a single print image is generated based on two lengthwise characteristic image 71 and 72, the print image generation unit 10K transmits that print image to the print data generation unit 10L.

In addition, when a plurality of images are selected, if three or more lengthwise characteristic images are selected for generating the print image, the print image generation unit 10K similarly generates a single consecutive characteristic depiction images by sequentially connecting three or more lengthwise characteristic images in the image lateral direction and selects it as the print source image. The print image generation unit 10K generates a single print image based on the consecutive characteristic depiction image and transmits it to the print data generation unit 10L.

Furthermore, when a plurality of images are selected, for example, if two breadthwise characteristic images are selected for generating the print image, the print image generation unit 10K also executes a pre-processing for generating the print image at this moment. In this case, the print image generation unit 10K sets, as the reference width, the width (in this case, the number of pixels corresponding to a single column from the left end to the right end) extending in the other direction (e.g., image lateral direction) perpendicular to one direction (e.g., the image longitudinal direction) where the breadthwise characteristic portion is longitudinally depicted within one of the breadthwise characteristic images.

In addition, the print image generation unit 10K sets, as the comparison target width, the width (also in this case, the number of pixels corresponding to a single column from the left end to the right end) extending in the other direction (e.g., the image lateral direction) perpendicular to one direction (e.g., the image longitudinal direction) where the breadthwise characteristic portion is longitudinally depicted within a single breadthwise characteristic image.

The print image generation unit 10K compares the comparison target width with the reference width. As a result, if the comparison target width is equal to the reference width, the print image generation unit 10K terminates the pre-processing so that one and the other breadthwise characteristic images can be used in the process for generating the print image without change.

On the contrary, if the comparison target width is different from the reference width, the print image generation unit 10K enlarges the other breadthwise characteristic image by appropriately interpolating pixels as a whole or contracts the other lengthwise characteristic image by appropriately decimating pixels. Consequently, the print image generation unit 10K matches the width of the other breadthwise characteristic image with the width of the one of the breadthwise characteristic images and terminates the pre-processing.

In this manner, when the one and the other breadthwise characteristic images have different widths, the print image generation unit 10K equalizes them, and then, uses them in the process for generating the print image.

If the pre-processing is terminated, the print image generation unit 10K calculates a difference sum value between the values of each pixel of a single column in the lower end of the one breadthwise characteristic image and the corresponding values of each pixel of a single column in the upper end of the other breadthwise characteristic image as described above in conjunction with Equations 6 to 10. Then, the print image generation unit 10K compares that difference sum value with the fourth threshold value.

As a result, if the difference sum value is equal to or smaller than the fourth threshold value, the print image generation unit 10K determines that the hues are similar to each other between the lower end of the one breadthwise characteristic image and the upper end of the other breadthwise characteristic image as much as they do not generate uncomfortable feeling. Therefore, the print image generation unit 10K does not execute the special effect process for the lower end of the one breadthwise characteristic image and the upper end of the other breadthwise characteristic image.

On the contrary, if the difference sum value is larger than the fourth threshold value, the print image generation unit 10K determines that the hues are significantly different between the lower end of the one breadthwise characteristic image and the right end of the other breadthwise characteristic image. In addition, the print image generation unit 10K sets the lower effect region in the lower end of the one lengthwise characteristic image.

At this moment, the print image generation unit 10K sets the upper effect region in the upper end of the other breadthwise characteristic image. The print image generation unit 10K executes the special effect process for the lower effect region of the one breadthwise characteristic image and the upper effect region of the other breadthwise characteristic image as described above. Consequently, the print image generation unit 10K equalizes the hues between the lower end of the one breadthwise characteristic image and the upper end of the other breadthwise characteristic image.

Similarly, the print image generation unit 10K calculates the difference sum value between the values of each pixel of a single column in the upper end of the one breadthwise characteristic image and the corresponding values of each pixel of a single column in the lower end of the other breadthwise characteristic image.

The print image generation unit 10K compares that difference sum value with the fourth threshold value. As a result, if the difference sum value is equal to or smaller than the fourth threshold value, the print image generation unit 10K does not execute the special effect process for the upper end of the one breadthwise characteristic image and the lower end of the other breadthwise characteristic image.

On the contrary, if the difference sum value is larger than the fourth threshold value, the print image generation unit 10K sets the upper effect region in the upper end of the one breadthwise characteristic image and sets the lower effect region in the lower end of the other breadthwise characteristic image.

The print image generation unit 10K executes the special effect process for the upper effect region of the one breadthwise characteristic image and the lower effect region of the other breadthwise characteristic image. Consequently, the print image generation unit 10K equalizes the hues between the upper end of the one breadthwise characteristic image and the lower end of the other breadthwise characteristic image.

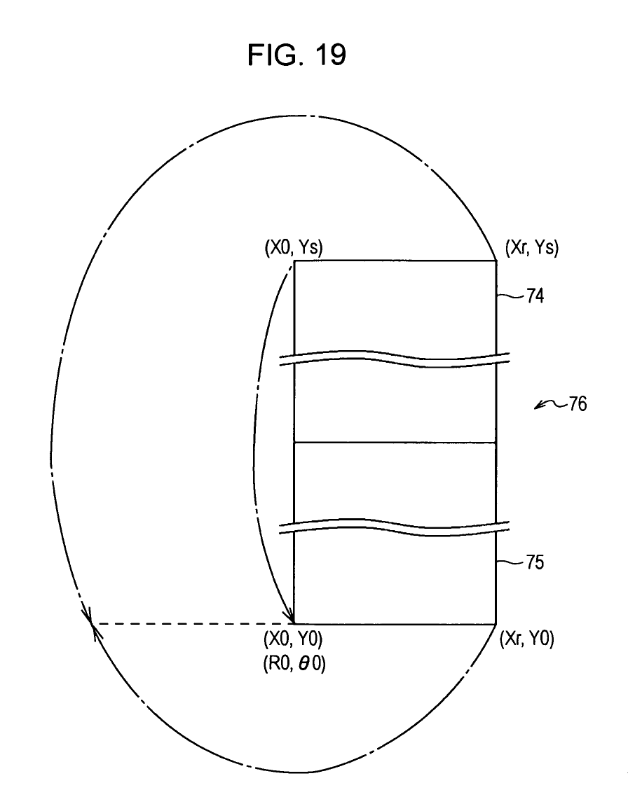

In this state, as shown in FIG. 19, the print image generation unit 10K generates a single consecutive characteristic depiction image 76 by connecting the lower end of the one breadthwise characteristic image 74 to the upper end of the other breadthwise characteristic image 75 and selects the generated single characteristic depiction image 76 as the print source image. The print image generation unit 10K selects, for example, the left end (e.g., the left ends of the one and the other breadthwise characteristic images 74 and 75) within the consecutive characteristic depiction image 76 as the X-axis of the rectangular coordinate system.

In addition, the print image generation unit 10K selects, for example, the lower end (e.g., the lower end of the other breadthwise characteristic images 75) within the consecutive characteristic depiction image 76 as the Y-axis of the rectangular coordinate system. The print image generation unit 10K selects the position of the pixel located in the lower left corner (in practice, the lower left corner of the other breadthwise characteristic image 75) as the origin (X0, Y0) of the rectangular coordinate system.

Consequently, the print image generation unit 10K expresses positions of each pixel of the consecutive characteristic depiction image 76 using coordinate values of the rectangular coordinate system. At this moment, in the consecutive characteristic depiction image 76, the position of the pixel located in the lower right corner (in practice, the lower right corner of the other lengthwise characteristic image 75) is expressed as a coordinate value (Xr, Y0).

Also, in the consecutive characteristic depiction image 76, the position of the pixel located in the upper left corner (in practice, the upper left corner of the one breadthwise characteristic image 74) is expressed as a coordinate value (X0, Ys). Furthermore, in the consecutive characteristic depiction image 76, the position of the pixel located in the upper right corner (in practice, the upper right corner of the one breadthwise characteristic image 75) is expressed as a coordinate value (Xr, Ys).

Similar to the case of the breadthwise characteristic image 65 described above, the print image generation unit 10K converts the coordinate value (X, Y) based on the rectangular coordinate system representing the location of each pixel of the consecutive characteristic depiction image 76 to the polar coordinate value (R, θ).

The print image generation unit 10K concurrently changes the locations of each pixel into the polar coordinate system by substituting pixels other than the pole with pixel of the pole by changing the locations of pixels other than the pixel of the pole among pixels of a single row located in the left end in the consecutive characteristic depiction image 76 into the pole and radially arranging each column from the pole at the same time.

Consequently, the print image generation unit 10K generates a circular print image (not shown) by reducing the left end of the consecutive characteristic depiction image 76 to set the pole as the center of the image, setting the right end as the outer circumference of the image, and bonding the upper and lower ends.

That is, the print image generation unit 10K generates the print image by transforming the quadrilateral consecutive characteristic depiction image 76 into a circular shape and sequentially deploying two breadthwise characteristic portions extending in a single direction (e.g., the image longitudinal direction) depicted in the quadrilateral consecutive characteristic depiction image 76 along the arc centered at the pole.

In the print image, the length (i.e., the length of a single column) of the upper end (and the lower end) of the consecutive characteristic depiction image 76 is set to the radius of the image. Also in this case, the print image generation unit 10K appropriately interpolates the gap between each pixel in the print image.

In this manner, if a single print image is generated based on two breadthwise characteristic images 74 and 75, the print image generation unit 10K transmits that print image to the print data generation unit 10L.

In addition, when a plurality of images are selected, if three or more breadthwise characteristic images are selected for generating the print image, the print image generation unit 10K similarly generates a single consecutive characteristic depiction images by sequentially connecting three or more breadthwise characteristic images in the image longitudinal direction and selects it as the print source image. The print image generation unit 10K generates a single print image based on the consecutive characteristic depiction image and transmits it to the print data generation unit 10L.

Furthermore, when a plurality of images are selected, for example, if a single lengthwise characteristic image 62 and a single breadthwise characteristic image 65 are selected for generating the print image, the print image generation unit 10K also executes the pre-processing for generating the print image first at this moment. In this case, the print image generation unit 10K sets, as the reference width, for example, the width extending in the other direction (e.g., image longitudinal direction) perpendicular to one direction (e.g., the image lateral direction) where the lengthwise characteristic portion is longitudinally depicted within the lengthwise characteristic image 62.

In addition, the print image generation unit 10K sets, as the comparison target width, the width extending in the other direction (e.g., the image lateral direction) perpendicular to one direction (e.g., the image longitudinal direction) where the breadthwise characteristic portion is longitudinally depicted within the breadthwise characteristic image. Then, the print image generation unit 10K compares the comparison target width with the reference width.

As a result, if the comparison target width is equal to the reference width, the print image generation unit 10K terminates the pre-processing so that the horizontal and breadthwise characteristic images 62 and 65 can be used in the process for generating the print image without change.

On the contrary, if the comparison target width is different from the reference width, the print image generation unit 10K enlarges the breadthwise characteristic image 65 by appropriately interpolating pixels as a whole or contracts the breadthwise characteristic image 65 by appropriately decimating pixels. Consequently, the print image generation unit 10K matches the width of the breadthwise characteristic image 65 with the width of the lengthwise characteristic image 62 and terminates the pre-processing.

That is, if the width of the lengthwise characteristic image 62 is different from the width of the breadthwise characteristic image 65, the print image generation unit 10K equalizes them and then uses the corresponding lengthwise characteristic image 62 and the breadthwise characteristic image 65 in the process for generating the print image.

If the pre-processing is terminated, the print image generation unit 10K calculates a difference sum value between the values of each pixel of a single row in the right end of the lengthwise characteristic image 62 and the corresponding values of each pixel of a single column in the upper end of the breadthwise characteristic image 65.

Then, the print image generation unit 10K compares that difference sum value with the fourth threshold value. As a result, if the difference sum value is equal to or smaller than the fourth threshold value, the print image generation unit 10K determines that the hues are similar to each other between the right end of the lengthwise characteristic image 62 and the upper end of breadthwise characteristic image 65 as much as they do not generate uncomfortable feeling. In this case, the print image generation unit 10K does not execute the special effect process for the right end of the lengthwise characteristic image 62 and the breadthwise characteristic image 65.

On the contrary, if the difference sum value is larger than the fourth threshold value, the print image generation unit 10K determines that the hues are significantly different between the right end of the lengthwise characteristic image 62 and the upper end of the breadthwise characteristic image 65. In addition, the print image generation unit 10K sets the right effect region in the right end of the one lengthwise characteristic image 62.

At this moment, the print image generation unit 10K sets the upper effect region in the upper end of breadthwise characteristic image 65. The print image generation unit 10K executes the special effect process for the right effect region of the lengthwise characteristic image 62 and the upper effect region of the breadthwise characteristic image 65. Consequently, the print image generation unit 10K equalizes the hues between the right end of the lengthwise characteristic image 62 and the upper end of the breadthwise characteristic image 65.

Similarly, the print image generation unit 10K calculates the difference sum value between the values of each pixel of a single row in the left end of the one lengthwise characteristic image 62 and the corresponding values of each pixel of a single column in the lower end of the breadthwise characteristic image 65.

The print image generation unit 10K compares that difference sum value with the fourth threshold value. As a result, if the difference sum value is equal to or smaller than the fourth threshold value, the print image generation unit 10K does not execute the special effect process for the left end of the lengthwise characteristic image 62 and the lower end of the breadthwise characteristic image 65.

On the contrary, if the difference sum value is larger than the fourth threshold value, the print image generation unit 10K sets the left effect region in the left end of the lengthwise characteristic image 62 and sets the lower effect region in the lower end of the breadthwise characteristic image 65.

The print image generation unit 10K executes the special effect process for the left effect region of the lengthwise characteristic image 62 and the lower effect region of the breadthwise characteristic image 65. Consequently, the print image generation unit 10K equalizes the hues between the left end of the lengthwise characteristic image 62 and the lower end of the breadthwise characteristic image 65.

The print image generation unit 10K generates a single consecutive characteristic depiction image by connecting the upper end of the breadthwise characteristic image 65 to the right end of the lengthwise characteristic image 62 and selects the generated single characteristic depiction image as the print source image. In this state, the print image generation unit 10K selects, for example, the left end (e.g., the left end of the lengthwise characteristic image 62) within the consecutive characteristic depiction image as the X-axis of the rectangular coordinate system.

In addition, the print image generation unit 10K selects, for example, the lower end (e.g., the lower end of the lengthwise characteristic image 62 and the left end of the breadthwise characteristic image 65) within the consecutive characteristic depiction image as the Y-axis of the rectangular coordinate system. The print image generation unit 10K selects the position of the pixel located in the lower left corner (e.g., the lower left corner of the lengthwise characteristic image 62) as the origin (X0, Y0) of the rectangular coordinate system. Consequently, the print image generation unit 10K expresses positions of each pixel of the consecutive characteristic depiction image using coordinate values of the rectangular coordinate system.

At this moment, in the consecutive characteristic depiction image, the pixel located in the lower right corner corresponds to the pixel located in the lower left corner of the breadthwise characteristic image 65, the pixel located in the upper left corner of the corresponds to the pixel located in the upper left corner of the lengthwise characteristic image 62, and the pixel located in the upper right corner corresponds to the pixel located in the lower right corner of the breadthwise characteristic image 65.

Similar to the case of the lengthwise characteristic image 62 described above, the print image generation unit 10K converts the coordinate value (X, Y) based on the rectangular coordinate system representing the location of each pixel of the consecutive characteristic depiction image to the polar coordinate value (R, θ).

The print image generation unit 10K concurrently changes the locations of each pixel into the polar coordinate system by substituting pixels other than the pole with the pixel of the pole by changing the locations of pixels other than the pixel of the pole among pixels of a single column located in the lower end in the consecutive characteristic depiction image into the pole and radially arranging each row from the pole at the same time.

Consequently, the print image generation unit 10K generates a circular print image by reducing the lower end of the consecutive characteristic depiction image to set the pole as the center of the image, setting the upper end as the outer circumference of the image, and bonding the left and right ends. That is, the print image generation unit 10K generates the print image by transforming the quadrilateral consecutive characteristic depiction image into a circular shape and sequentially deploying the lengthwise characteristic portion and the breadthwise characteristic portion extending in a single direction (e.g., the image lateral direction and the image longitudinal direction) depicted in the quadrilateral consecutive characteristic depiction image along the arc centered at the pole.

In the print image, the length (i.e., the length of a single row) of the left end (and the right end) of the consecutive characteristic depiction image is set to the radius of the image. Also in this case, the print image generation unit 10K appropriately interpolates the gap between each pixel in the print image.

In this manner, if a single print image is generated based on the lengthwise characteristic image 62 and the breadthwise characteristic image 65, the print image generation unit 10K transmits that print image to the print data generation unit 10L.

In addition, even in a case where various combinations of three or more lengthwise characteristic images 62 and the breadthwise characteristic images 65 are selected for generating the print image, similarly, the print image generation unit 10K generates a single consecutive characteristic depiction image by connecting three or more lengthwise characteristic images 62 and the breadthwise characteristic images 65. The print image generation unit 10K selects the consecutive characteristic depiction image as the print source image, generates the print image based on the consecutive characteristic depiction image, and transmits it to the print data generation unit 10L.

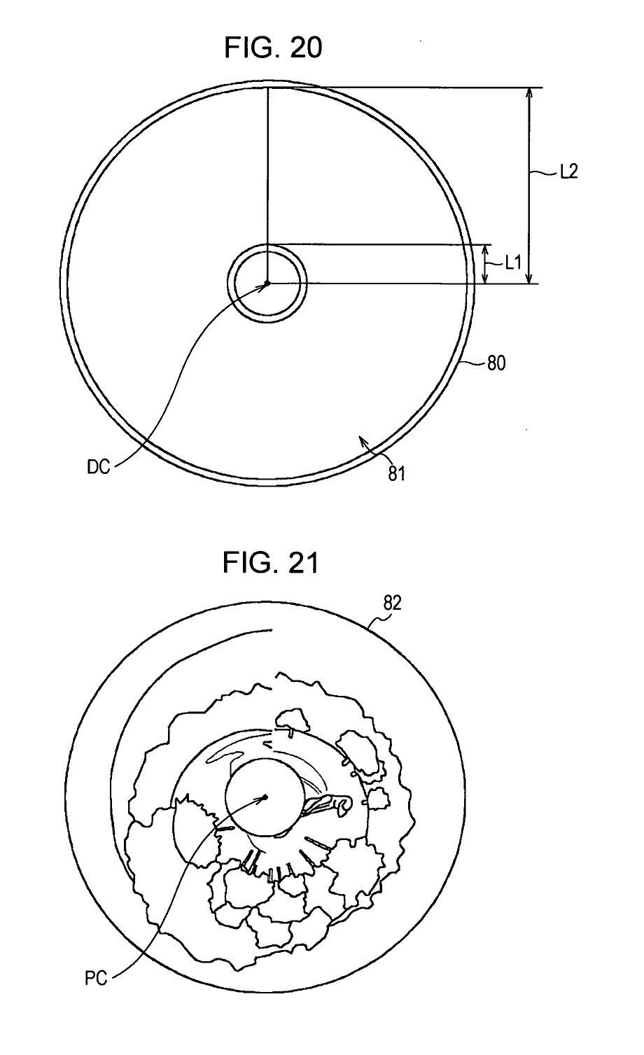

As shown in FIG. 20, the print data generation unit 10L previously stores print area information representing the shape and the size of a ring-shaped print area 81 provided on one surface of the recording disc 80.

The print area information contains, as information regarding the shape and the size of the print area 81, information regarding the radius L1 ranged from the disc center DC of the recording disc 80 to the inner circumference of the print area 81 and information regarding the radius L2 ranged from the disc center DC to the outer circumference of the print area 81.

Hereinafter, the radius L1 ranged from the disc center DC of the recording disc 80 to the inner circumference of the print area 81 will be also referred to as an inner radius L1. Hereinafter, radius L2 ranged from the center DC of the recording disc 80 to the outer circumference of the print area 81 will be also referred to as an outer radius L2.

As shown in FIG. 21, for example, if the print image 70 generated from the print image generation unit 10K based on a single lengthwise characteristic image is provided, the print data generation unit 10L enlarges the corresponding print area 70 such that the radius of the image match the outer radius L2 based on the print area information.

The print data generation unit 10L removes a circular portion having a radius set to the inner radius L1 and a center of the image set to the center of the enlarged print image. In this manner, the print data generation unit 10L corrects the corresponding print area 70 such that the shape and the size of the print image 70 match the shape and the size of the print area 81 of the recording disc 80.

Then, the print data generation unit 10L generates print data for printing the corrected print image 82 on one surface of the disc by matching the disc center with the center of the image PC. That is, the print data generation unit 10L generates the print data for specifying the print position of the corresponding print image 82 on one surface of the disc by setting the corrected print image 82 as the print target such that the disc center match the center of the image PC.

As the print data are generated, the print data generation unit 10L transmits the print data to the window generation control unit 10F. If the print data are provided from the print data generation unit 10L, the window generation control unit 10F transmits the print data to the window data generation unit 10G.

The window data generation unit 10G generates print condition identification window data of the print condition identification window for previously identifying (before an actual printing) a print condition of the print image 82 based on the print data provided from the window generation control unit 10F. Hereinafter, the print condition identification window will be also referred to as a print preview window, and the print condition identification window data will be also referred to as print preview window data.

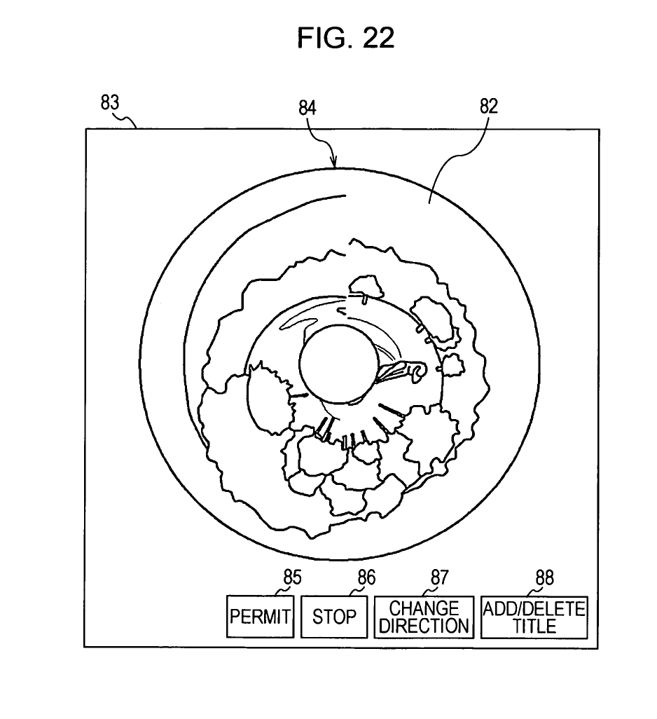

The window data generation unit 10G temporarily stores the print preview window data for display in the memory via the bus 11. In this manner, the window generation control unit 10F displays the print preview window 83 on the display of the television set 27 based on the print preview window data as shown in FIG. 22.

In this case, on the print preview window 83, the print image 82 is displayed within the disc one-surface image 84 by arranging the disc one-surface image 84 having a ring shape resembling one surface of the recording disc 80 in the center portion.

Consequently, the window generation control unit 10F allows a user to previously identify the print condition such as a depiction or a hue of the print image 82 printed on one surface of the disc using the print preview window 83.

In addition, on the print preview window 83, a PERMIT button 85 for permitting printing the print image 82 on the recording disc is provided under the disc one-surface image 84. Furthermore, on the print preview window 83, a STOP button 86 for stopping printing the print image 82 is also provided under the disc one-surface image 84.

Furthermore, on the print preview window 83, a CHANGE DIRECTION button 87 for changing the direction of the depiction of the print image 82 is provided under the disc one-surface image 84. Furthermore, on the print preview window 83, an ADD/DELETE TITLE button 88 for selecting addition/deletion of the title (e.g., a program title, a moving picture title, or a photograph title) of the print image 82 in a toggle type is provided under the disc one-surface image 84.

If the PERMIT button 85 is pressed by a user using the remocon RM on the print preview window 83 to permit printing the print image 82, the window generation control unit 10F notifies the print data generation unit 10L of the permission.

If the permission of the printing is notified from the window generation control unit 10F, the print data generation unit 10L transmits the print data to the printer control unit 49 via the bus 11 to control the corresponding printer control unit 49 to perform the printing. Accordingly, the printer control unit 49 drives and controls the printer 50 based on the print data at this moment.

Consequently, for example, as shown in FIG. 23, the print data generation unit 10L prints the print image 82 on one surface of the recording disc 90 based on the print data in a single cycle (across the entire print area).

In this manner, the print data generation unit 10L can print the lengthwise characteristic image cut out from the representative image as a circular print image 82 on one surface of the recording disc 90 without missing anything.

However, if the CHANGE DIRECTION button 87 is pressed by a user using the remocon RM on the print preview window 83 to change the direction of the depiction of the print image 82, the window generation control unit 10F notifies the print image generation unit 10K of this instruction.

When the print image is generated and transmitted to the print data generation unit 10L, the print image generation unit 10K temporarily stores the print image and the print source image together with the corresponding attribute information until the printing of the print image on one surface of the recording disc is terminated or stopped.

In addition, the print source image may include the horizontal or breadthwise characteristic image determined to have no necessity to execute the special effect process, the horizontal or breadthwise characteristic image subjected to the special effect process, or the consecutive characteristic depiction image generated by sequentially connecting two or more horizontal or vertical characteristic images.

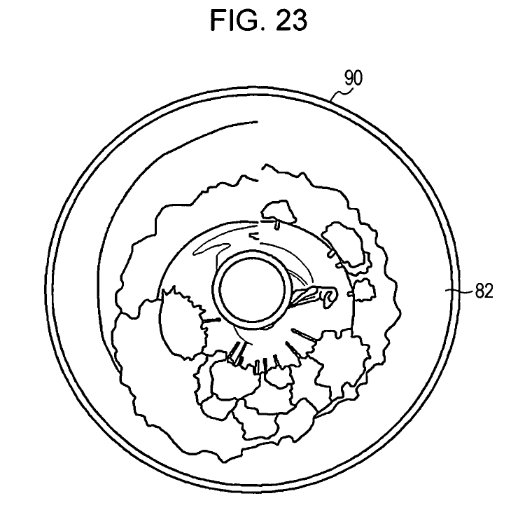

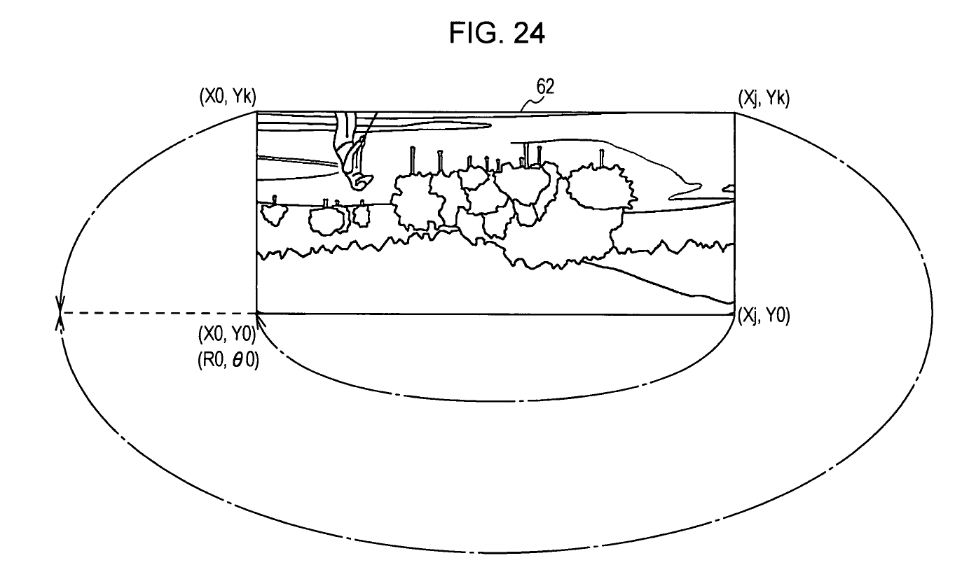

As shown in FIG. 24, if the change of the direction of the depiction of the print image 82 is notified from the window generation control unit 10F, the print image generation unit 10K selects, as the X-axis of the rectangular coordinate system, for example, the right end of the lengthwise characteristic image 62 temporarily stored as the print source image.

The print image generation unit 10K sets the upper end of that lengthwise characteristic image 62 as the Y-axis of the rectangular coordinate system and sets the position of the pixel located in the upper right corner as the origin (X0, Y0) of the rectangular coordinate system. In this manner, unlike the aforementioned case, the print image generation unit 10K expresses the positions of each pixel of the lengthwise characteristic image 62 using the coordinate values of the rectangular coordinate system in an upside-down state.

At this moment, in the lengthwise characteristic image 62, the position of the pixel located in the upper left corner is expressed as a coordinate value (Xj, Y0), the position of the pixel located in the lower right corner is expressed as a coordinate value (X0, Yk), and the position of the pixel located in the lower left corner is expressed as a coordinate value (Xj, Yk).

In addition, the print image generation unit 10K converts the coordinate value (X, Y) based on the rectangular coordinate system representing the location of each pixel of the lengthwise characteristic image 62 to the polar coordinate value (R, θ).

The print image generation unit 10K concurrently changes the locations of each pixel into the polar coordinate system by substituting pixels other than the pole with pixel of the pole by changing the locations of pixels other than the pixel of the pole among pixels of a single column located in the upper end in the lengthwise characteristic image 62 into the pole and radially arranging each row from the pole at the same time.

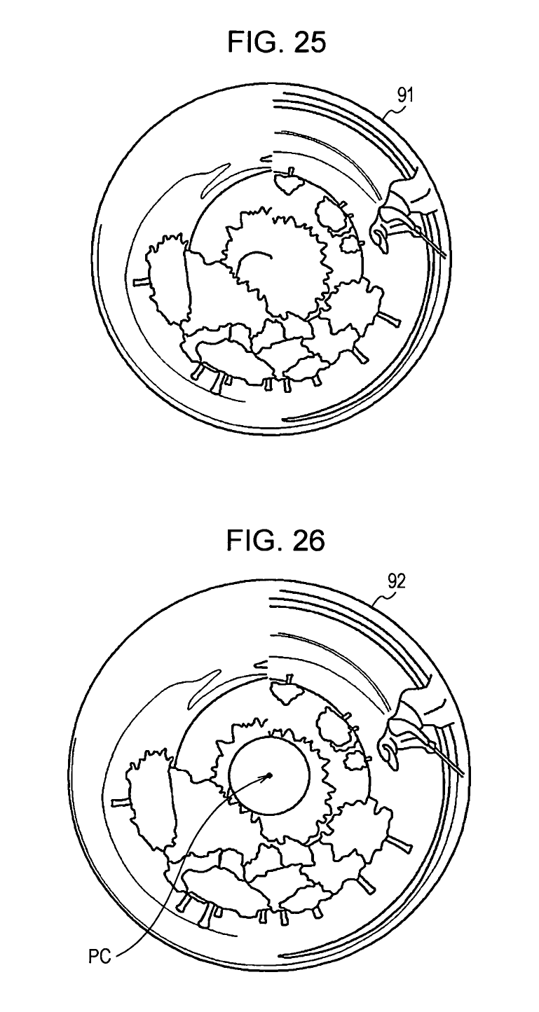

Consequently, as shown in FIG. 25, the print image generation unit 10K generates a circular print image 91 by reducing the upper end of the lengthwise characteristic image 62 to set the pole as the center of the image, setting the lower end as the outer circumference of the image, and bonding the left and right ends.

That is, the print image generation unit 10K generates the circular print image 91 obtained by sequentially deploying the lengthwise characteristic portion extending in a single direction (e.g., the image lateral direction) depicted in the lengthwise characteristic image 62 along the arc centered at the pole.

In the print image 91, the length (i.e., the length of a single row) of the left end (and the right end) of the lengthwise characteristic image 62 becomes a radius of the image. Also in this case, the print image generation unit 10K appropriately interpolates the gap of each pixel within the print image 91.

In this manner, the print image generation unit 10K re-generates the print image 91 by changing the direction of the depiction based on the lengthwise characteristic image 62. Then, the print image generation unit 10K transmits that print image 91 to the print data generation unit 10L.

At this moment, as shown in FIG. 26, if the print image 91 is provided from print image generation unit 10K, the print data generation unit 10L enlarges the print image 91 based on the print area information as described above and deletes a circular portion from the center portion at the same time.

Consequently, the print data generation unit 10L corrects the corresponding print image 91 to match the shape and the size of the print image 91 with the shape and the size of the print area of the recording disc. The print data generation unit 10L generates the print data for printing the corrected print image 92 on one surface of the disc by matching the center of the image PC with the center of the disc.

If the print data are generated in this manner, the print data generation unit 10L re-transmits the print data to the window generation control unit 10F. If the print data are provided from the print data generation unit 10L, the window generation control unit 10F re-transmits that print data to the window data generation unit 10G.

The window data generation unit 10G generates the print preview window data based on the print data provided from the window generation control unit 10F and temporarily stores them in the memory 39 for display via the bus 11.

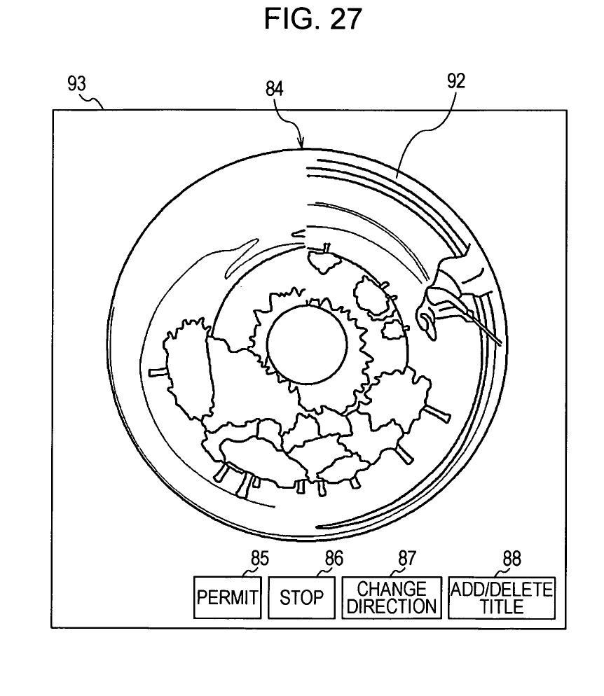

In this manner, the window generation control unit 10F displays the print preview window 93 on the display of the television set 27 based on the print preview window data as shown in FIG. 27 where like reference numerals denote like elements as in FIG. 22.

In this case, on the print preview window 93, the print image 92 is displayed within the disc one-surface image at the center portion by changing the direction of the depiction. Consequently, the window generation control unit 10F allows a user to previously identify the print condition of the print image 92 by changing the direction of the depiction using the print preview window 93 before printing the print image 92 on the one surface of the disc.

At this moment, if the CHANGE DIRECTION 87 button is pressed by a user using the remocon RM on the print preview window 93, the window generation control unit 10F restores the direction of the depiction of the print image 92 and re-proposes it as the print preview window 83.

In this case, the print image generation unit 10K re-transmits, for example, the print image 70 before the change to the print data generation unit 10L. The print data generation unit 10L re-generates the print data based on the print image 70 before the change to allow the print image 82 having the restored direction of the depiction to be proposed and printed.

At this moment, if the PERMIT button 85 is pressed by a user using the remocon RM on the print preview window 93 to permit printing the print image 92, the window generation control unit 10F notifies the print data generation unit 10L of the permission.

If the permission of the printing is notified from the window generation control unit 10F, the print data generation unit 10L transmits the re-generated print data to the printer control unit 49 via the bus 11 to control the corresponding printer control unit 49 for printing. Accordingly, the printer control unit 49 drives and controls the printer 50 based on the print data at this moment.

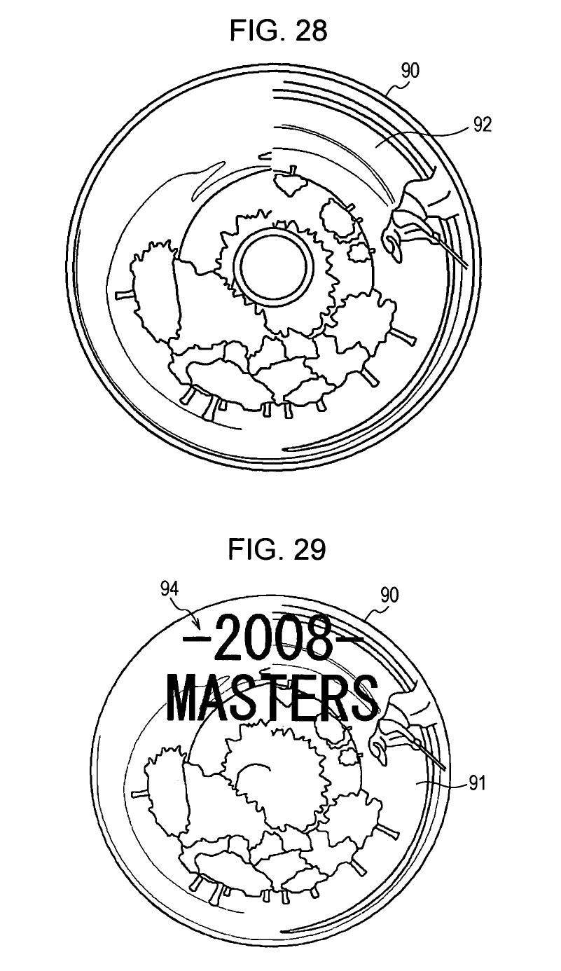

Consequently, for example, as shown in FIG. 28, the print data generation unit 10L prints the print image 92 on one surface of the recording disc 90 based on the print data in a single cycle (across the entire print area).

The print data generation unit 10L can print the circular print image 92 obtained by collectively switching between the one serving as the center of the image and the other one serving as the outer circumference of the image between the upper and lower ends of the lengthwise characteristic image 62 by changing the direction of the depiction of the corresponding lengthwise characteristic image 62 on one surface of the disc.

If the ADD/DELETE TITLE button 88 is pressed by a user using the remocon RM on the print preview window 93 to add the title, the window generation control unit 10F notifies the print image generation unit 10K of this instruction.

As shown in FIG. 29, if the addition of the title is notified from the window generation control unit 10F, the print image generation unit 10K extracts information on the title (e.g., a program title, a moving picture title, or a photograph title) from the corresponding attribute information temporarily stored together with the print image 91 at this moment.

Then, the print image generation unit 10K overlaps that title 94 (in practice, a character string representing the title) at a predetermined location on one surface of the print image 91. Consequently, the print image generation unit 10K generates the print image 95 obtained by adding the title 94. Then, the print image generation unit 10K transmits that print image 95 to the print data generation unit 10L.

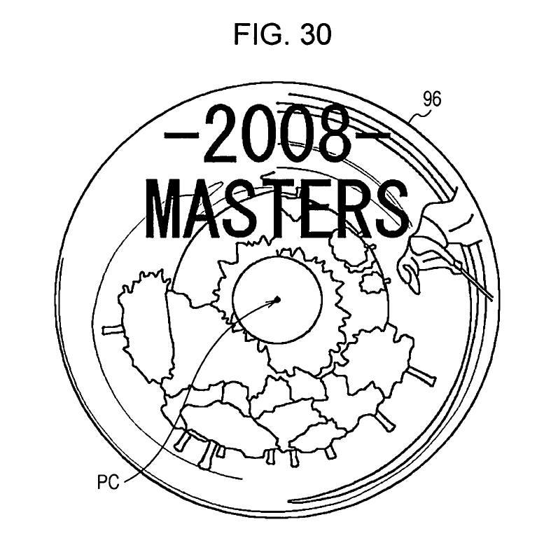

As shown in FIG. 30, if the print image 95 is provided from print image generation unit 10K, the print data generation unit 10L enlarges the print image 95 (i.e., the print image 91 and the title 94 on a circle) based on the print area information as described above and deletes a circular portion from the center portion at the same time.

Consequently, the print data generation unit 10L corrects the corresponding print image 95 to match the shape and the size of the print image 95 with the shape and the size of the print area of the recording disc. The print data generation unit 10L generates the print data for printing the corrected print image 96 on the one surface of the disc by matching the center PC of the image with the center of the disc.

If the print data are re-generated in this manner, the print data generation unit 10L re-transmits the print data to the window generation control unit 10F. If the print data are provided from the print data generation unit 10L, the window generation control unit 10F re-transmits that print data to the window data generation unit 10G.

The window data generation unit 10G generates the print preview window data based on the print data provided from the window generation control unit 10F and temporarily stores them in the memory 39 for display via the bus 11.

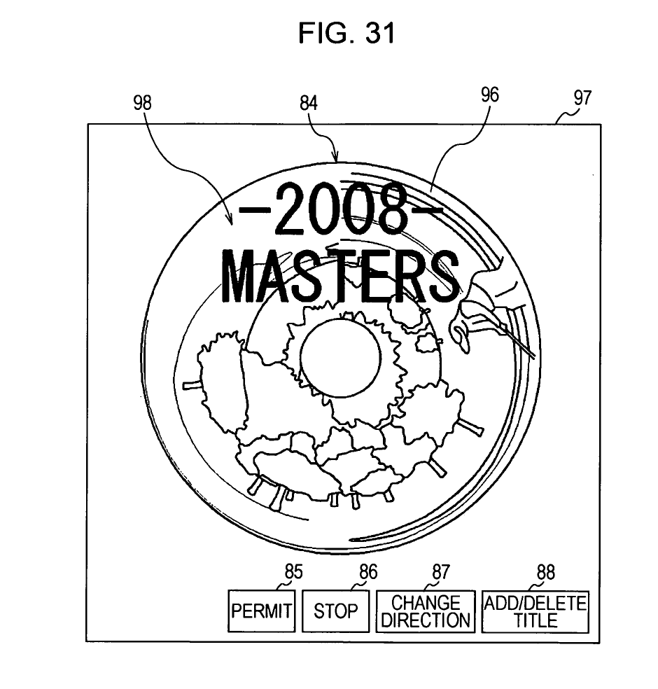

In this manner, the window generation control unit 10F displays the print preview window 97 on the display of the television set 27 based on the print preview window data as shown in FIG. 31 where like reference numerals denote like elements as in FIG. 22.

In this case, the print preview window 97 displays the print image 96 obtained by adding the title 98 within the disc one-surface image 84 at the center portion. Consequently, the window generation control unit 10F allows a user to previously identify the print condition of the print image 96 obtained by adding the title 98 using the print preview window 97 before printing the print image 96 on the one surface of the disc.

At this moment, if the ADD/DELETE TITLE button 88 is pressed by a user using the remocon RM on the print preview window 97, the window generation control unit 10F determines that deletion of the title has been requested. Then, the window generation control unit 10F restores the original print image 92 having no title 98 from the print image 96 and re-proposes it as the print preview window 93.

In this case, the print image generation unit 10K re-transmits, for example, the print image 95 before the change to the print data generation unit 10L. The print data generation unit 10L re-generates the print data before the change based on the print image 95 before adding the title to allow the original print image 92 obtained by deleting the title 94 to be proposed and printed.

At this moment, if the PERMIT button 85 is pressed by a user using the remocon RM on the print preview window 97 to permit printing the print image 96, the window generation control unit 10F notifies the print data generation unit 10L of this permission.

If the permission of the printing is notified from the window generation control unit 10F, the print data generation unit 10L transmits the re-generated print data to the printer control unit 49 via the bus 11 to control the corresponding printer control unit 49 for printing. Accordingly, the printer control unit 49 drives and controls the printer 50 based on the print data at this moment.

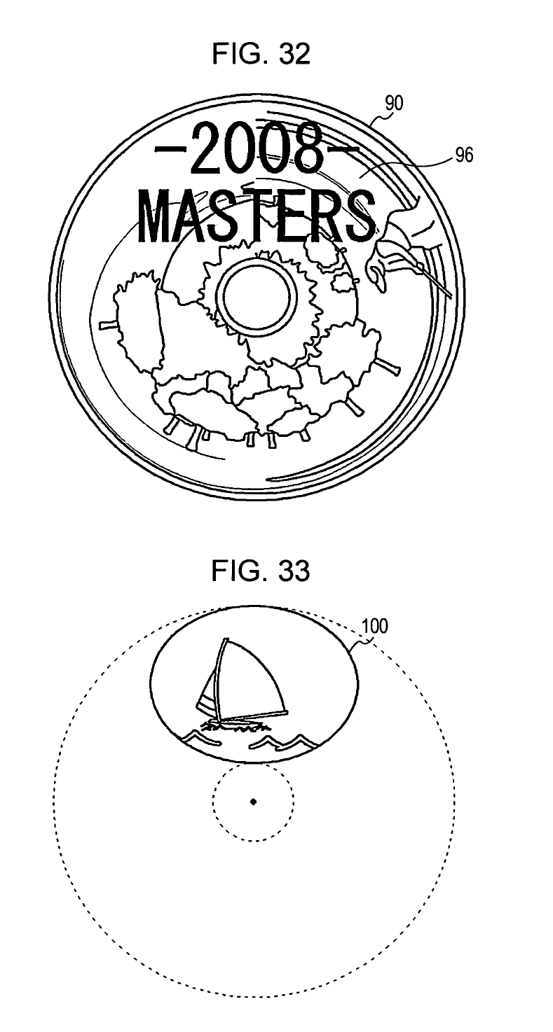

Consequently, for example, as shown in FIG. 32, the print data generation unit 10L prints the print image 96 on one surface of the recording disc 90 based on the print data in a single cycle (across the entire print area).

In this manner, the print data generation unit 10L lengthwise characteristic image cut out from the representative image together with the title on one surface of the recording disc 90 as the circular print image 96.

The window generation control unit 10F can add the title to the print image 70 using the print image generation unit 10K even for the print image 70 before changing the direction of the depiction as described above.

In addition, the window generation control unit 10F can change the direction of the depiction of the print image using the print image generation unit 10K even for the print image 95 obtained by adding the title as described above. However, at this moment, the print image generation unit 10K re-generates the print image by re-generating the print image obtained by changing the direction of the depiction and then adding the title again.

However, the print data generation unit 10L, the window generation control unit 10F, the window data generation unit 10G, and the print image generation unit 10K execute the same process even when the circular print image is generated based on the breadthwise characteristic image, or two or more lengthwise characteristic images and/or breadthwise characteristic images.

Consequently, the image generation control unit 10F can allows a user to identify the print condition of the circular print image generated based on the breadthwise characteristic image, or two or more lengthwise characteristic images and/or breadthwise characteristic images.

Furthermore, the print data generation unit 10L can print the circular print image generated based on the breadthwise characteristic image, or two or more lengthwise characteristic images and/or breadthwise characteristic images on one surface of the recording disc.

When the change of the direction is requested for the print image based on the lengthwise characteristic image, the print image generation unit 10K changes the direction of the depiction by collectively switching the one side serving as the center of the image and the other side serving as the outer circumference of the image between the upper and lower ends of the lengthwise characteristic image as described above.

When the change of the direction is requested for the print image based on the breadthwise characteristic image, the print image generation unit 10K changes the direction of the depiction by collectively switching the one side serving as the center of the image and the other side serving as the outer circumference of the image between the left and right ends of the breadthwise characteristic image.

When the change of the direction is requested for the print image based on the consecutive characteristic depiction image, the print image generation unit 10K changes the direction of the depiction by collectively switching the one side serving as the center of the image and the other side serving as the outer circumference of the image between the upper and lower ends of the consecutive characteristic depiction image.

Furthermore, when the addition of the title is requested for the print image based on the consecutive characteristic depiction image, the print image generation unit 10K overlaps the corresponding title on each of a part of the lengthwise characteristic image and/or a part of the breadthwise characteristic image included in the corresponding print image.

Furthermore, when the deletion of the title is requested for the print image based on the consecutive characteristic depiction image, the print image generation unit 10K deletes the corresponding title from each of a part of the lengthwise characteristic image and/or a part of the breadthwise characteristic image included in the corresponding print image.

However, for example, if the a single matrix-type characteristic image is provided as the print image from the print image generation unit 10K, the print data generation unit 10L detects the length of the corresponding print image according to the shape of the print image.

In practice, in a case where the circular matrix-type characteristic image is provided as the print image from the print image generation unit 10K, the print data generation unit 10L sets the diameter of the print image as the length of the corresponding print image. At this moment, the print data generation unit 10L sets the axis parallel to the image longitudinal by passing through the center of the image within the print image as the image center axis.

In a case where the elliptical matrix-type characteristic image is provided as the print image from the print image generation unit 10K, the print data generation unit 10L sets the short span of the minor axis (or the long span of the major axis) parallel to the image longitudinal direction of the print image as the length of the corresponding print image. At this moment, the print data generation unit 10L sets the minor axis or the major axis parallel to the image longitudinal by passing through the center of the image within the print image as the image center axis.

As shown in FIG. 33, the print data generation unit 10L enlarges the corresponding print image to match the length of the print image with the width (i.e., the length obtained by subtracting the inner radius L1 from the outer radius L2) ranged from the inner circumference to the outer circumference of the print area based on the print area information.

The print data generation unit 10L generates the print data for printing the print image 100 obtained by correcting (enlarging) the size thereof within the print area on one surface of the disc by matching the image center axis with the axis passing through the center of the recording disc.

That is, the print data generation unit 10L generates the print data for specifying the print position of the corresponding print image 100 for the print area on one surface of the disc within a distance between the center of the disc and the center of the image by setting the corrected print image 100 as the print target and matching the image center axis with the axis passing through the center of the disc.

As the print data are generated, the print data generation unit 10L transmits that print data to the window generation control unit 10F. When the print data are provided from the print data generation unit 10L, the window generation control unit 10F transmits that print data to the window data generation unit 10G.

The window data generation unit 10G generates the print preview window data based on the print data provided from the window generation control unit 10F and temporarily stores them for display in the memory 39 via the bus 11.

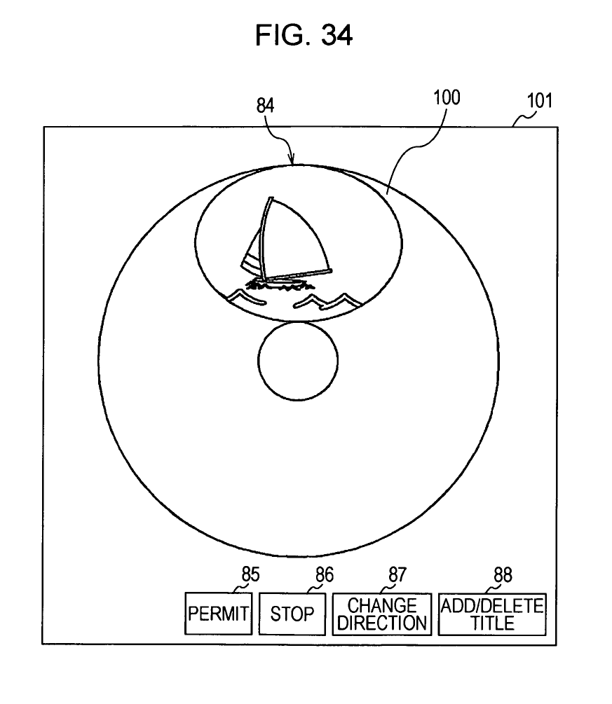

In this manner, the window generation control unit 10F displays the print preview window 101 on the display of the television set 27 based on the print preview window data as shown FIG. 34 where like reference numerals denote like elements as in FIG. 22.

In this case, the print preview window 101 displays the print image 100 within the disc one-surface image 84 at the center portion. Consequently, the window generation control unit 10F allows a user to previously identify the print condition such as the depiction, the hue, or the print position of the print image 100 printed on one surface of the disc using the print preview window 101.

In this state, if the PERMIT button 85 is pressed by a user using the remocon RM on the print preview window 101 to permit printing the print image 100, the window generation control unit 10F notifies the print data generation unit 10L of this permission.

If the permission of the printing is notified from the window generation control unit 10F, the print data generation unit 10L transmits the print data to the printer control unit 49 via the bus 11 to control the corresponding printer control unit 49 for printing. Accordingly, the printer control unit 49 drives and controls the printer 50 based on the print data at this moment.

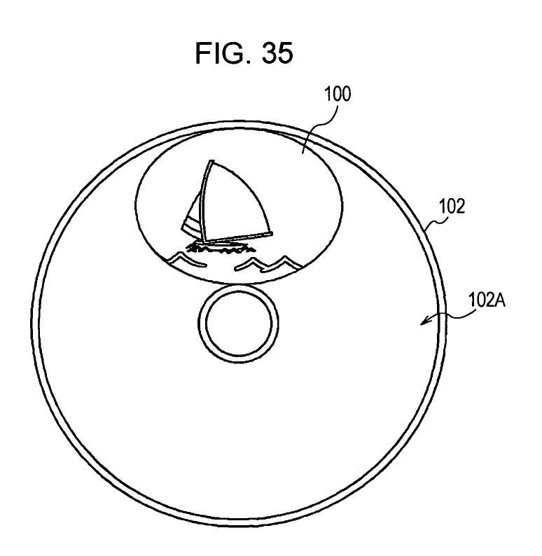

Consequently, for example, as shown in FIG. 35, the print data generation unit 10L prints the print image 100 at a predetermined position (e.g., a predetermined position within the print area) on one surface 102A of the recording disc 102 based on the print data.

In this manner, the print data generation unit 10L can print the matrix-type characteristic image cut out from the representative image on one surface 102A of the recording disc 102 as the print image 100.

If the change of the direction is requested when a single matrix-type characteristic image is selected as the print image, the print image generation unit 10K transmits the corresponding matrix-type characteristic image as the print image to the print data generation unit 10L in an upside-down state.

While the print data are generated based on the print image as described above, the print data generation unit 10L changes the direction of the depiction by selecting the one (e.g., the upper end) as the disc center side and selecting the other one (e.g., the lower end) as the disc outer circumference side between the upper and lower ends of the matrix-type characteristic image.

If the addition of the title is requested when a single matrix-type characteristic image is selected as the print image, the print image generation unit 10K overlaps the title on the corresponding matrix-type characteristic image and transmits it as the print image to the print data generation unit 10L.

The print data generation unit 10L generates the print data based on the print image as described above to allow the matrix-type characteristic image obtained by overlapping the title to be proposed and printed as the print image.

Furthermore, if the deletion of the title is requested when a single matrix-type characteristic image is selected as the print image, the print image generation unit 10K re-transmits the corresponding matrix-type characteristic image before overlapping the title as the print image to the print data generation unit 10L.

The print data generation unit 10L generates the print data based on the print image as described above to allow the matrix-type characteristic image obtained by deleting the title to be proposed and printed as the print image.

However, the print data generation unit 10L, the window generation control unit 10F, and the window data generation unit 10G executes the same process even when each of two or more matrix-type characteristic images is selected as the print image.

That is, when each of two or more matrix-type characteristic images is provided as the print image, the print data generation unit 10L generates print data such that a plurality of the print images can be arranged with the same distance and printed in the print area on one surface of the disc in a single cycle.

The window generation control unit 10F allows a user to identify the print conditions obtained by selecting each of two or more matrix-type characteristic images as the print image before executing the printing. In addition, the print data generation unit 10L can print each of two or more matrix-type characteristic images as the print image on one surface of the recording disc.

In addition, if the change the direction is requested when each of two or more matrix-type characteristic images is selected as the print image, the print image generation unit 10K transmits each print image to the print data generation unit 10L with a plurality of matrix-type characteristic images being in an upside-down state.

The print data generation unit 10L generates the print data based on a plurality of the print images as described above to change the direction of the depiction by selecting the one as the disc center side and selecting the other end as the outer circumference of the disc between the upper and lower ends of each of a plurality of the matrix-type characteristic images.

If the addition of the title is requested when each of two or more matrix-type characteristic images is selected as the print image, the print image generation unit 10K transmits these images as the print image to the print data generation unit 10L by overlapping the corresponding title with each of a plurality of matrix-type characteristic image.

The print data generation unit 10L generates the print data based on a plurality of the print images as described above to allow a plurality of the matrix-type characteristic images obtained by overlapping the title to be proposed and printed as the print image.

In addition, if the deletion of the title is requested when each of two or more matrix-type characteristic images is selected as the print image, the print image generation unit 10K re-transmits each of a plurality of the matrix-type characteristic images before overlapping the title as the print image to the print data generation unit 10L.

The print data generation unit 10L generates the print data based on a plurality of the print images as described above to allow each of a plurality of the matrix-type characteristic images obtained by deleting the title to be proposed and printed as the print image.

However, if the STOP button 86 is pressed by a user using the remocon RM on the print preview window 83, 93, 97, or 101 to stop the printing, the window generation control unit 10F notifies the print data generation unit 10L of this instruction.

If the stop of the printing for the print image 82, 92, 96, or 100 is notified from the window generation control unit 10F, the print data generation unit 10L destroys the print data generated at this moment. Consequently, the print data generation unit 10L stops printing the print image 82, 92, 96, or 100 on one surface 102A of the recording disc 90 or 102.

When the print image 82, 92, 96, or 100 is stopped, or the printing is terminated by finishing the printing of the print image 82, 92, 96, or 100 as described above, the print data generation unit 10L notifies the print image generation unit 10K of this fact.

Consequently, when the print image generation unit 10K is notified of the printing stop or the printing termination from the print data generation unit 10L, the print image, the print source image, or the attribute information that has been temporarily stored is destroyed.

### 1-4. Print Process Sequence

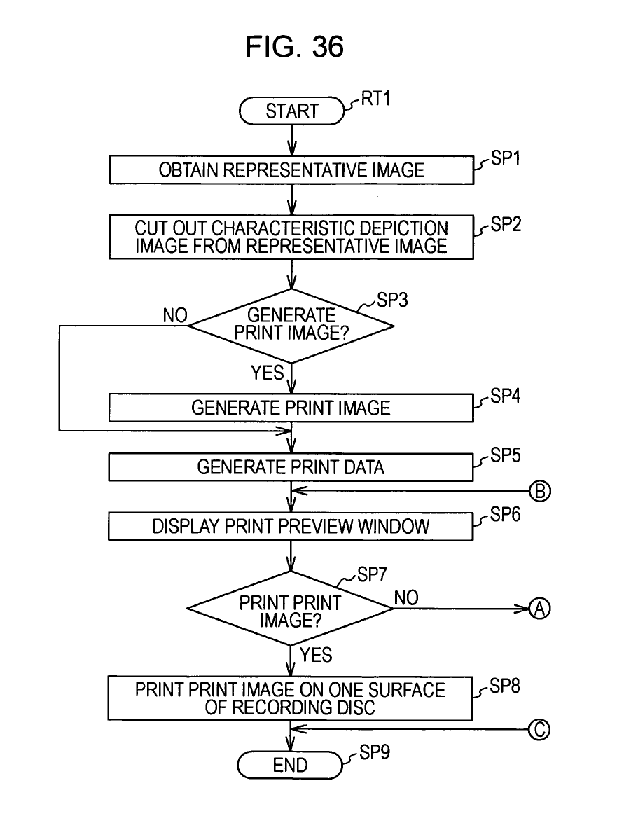

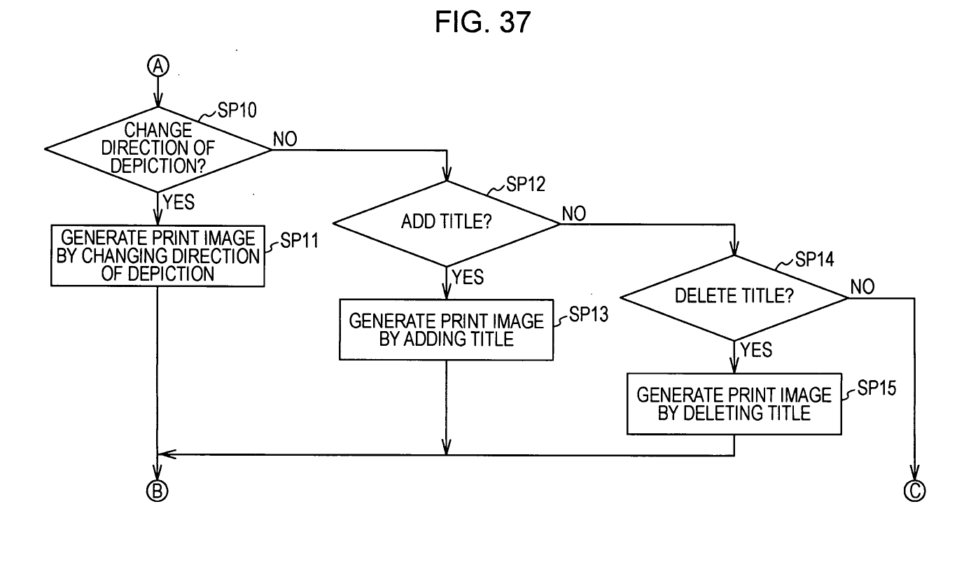

Subsequently, a print process sequence RT1 for printing the print image on one surface of the recording disc using the main control unit 10 will be described with reference to FIGS. 36 and 37. If the recording disc is installed inside the device, and the print mode is selected by a user, the main control unit 10 initiates the print process sequence RT1 shown in FIGS. 36 and 37 according to the print program previously stored in the internal memory or the hard disc drive 12.

As the print process sequence RT1 is initiated, the main control unit 10 reads the entire attribute information installed inside the device from the recording disc in step SP1. The main control unit 10 obtains one or a plurality of representative images representing the contents data recorded on the recording disc based on the attribute information, and the process advances to the next step SP2.

In step SP2, main control unit 10 analyzes the representative image and cuts out the characteristic depiction area where the image characteristic portion is depicted as the characteristic depiction image from the corresponding representative image. Then, the process advances to the next step SP3.

In step SP3, the main control unit 10 determines whether or not the print image is generated based on the characteristic depiction image. If a positive result is obtained in the step SP3, this means at least one representative image where the lengthwise characteristic portion or the breadthwise characteristic portion is depicted is obtained, and the lengthwise characteristic image or the breadthwise characteristic image is cut out from the representative image as the characteristic depiction image. If the main control unit 10 obtains a positive result in the step SP3, the process advances to the next step SP4.

In step SP4, the main control unit 10 generates a circular print image by bonding the one end and the other end in a single direction where the lengthwise characteristic portion or the breadthwise characteristic portion of the lengthwise characteristic image or the breadthwise characteristic image generated at this moment is depicted to extend.

Otherwise, the main control unit 10 generates a consecutive characteristic depiction image by sequentially connecting a plurality of lengthwise characteristic images and/or breadthwise characteristic images generated at this moment in a single direction where the lengthwise characteristic portion or the breadthwise characteristic portion is longitudinally depicted. The main control unit 10 generates a single circular print image by bonding one end and the other end of the consecutive characteristic depiction image in a single direction where the lengthwise characteristic portion or the breadthwise characteristic portion is longitudinally depicted.

In this manner, if a single print image is generated based on one or a plurality of the lengthwise characteristic images and/or the breadthwise characteristic images generated at this moment, the main control unit 10 makes the process advance to the next step SP5.

However, if a negative result is obtained in the step SP3, this means that only one or a plurality of the representative images where the matrix-type characteristic portion is depicted are obtained, and only the matrix-type characteristic image is cut out from the representative image as the characteristic depiction image. If a negative result is obtained in the step SP3, the main control unit 10 selects that matrix-type characteristic image as the print image without change, and the process advances to step SP5.

In step SP5, the main control unit 10 generates print data for printing the corresponding print image on one surface of the disc based on the print image, and the process advances to the next step SP6.

In step SP6, the main control unit 10 generates the print preview window data based on the print data. In addition, the main control unit 10 displays the print preview window based on the print preview window data on a display.

Consequently, the main control unit 10 allows a user to identify the print condition of the print image printed on one surface of the recording disc using the print preview window. In this manner, if the main control unit 10 displays the print preview window on the display, the process advances to the next step SP7.

In step SP7, the main control unit 10 determines whether or not the print image is printed on one surface of the recording disc. If a positive result is obtained in the step SP7, this means that a user identifies the print condition of the print image on the print preview window and permits the printing of the corresponding print image. In step SP7, if the main control unit 10 obtains such a positive result, the process advances to the next step SP8.

In step SP8, the main control unit 10 prints the print image on one surface of the recording disc based on the print data using the print control unit 49 and the printer 50, and the process advances to the next step SP9. Consequently, in step SP9, the main control unit 10 terminates the print process sequence RT1.

However, if a negative result is obtained in the step SP7, this means that the direction of the depiction in the print image is changed, the title is added or deleted, or the printing of the print image is stopped. If a negative result is obtained in the step SP7 by the main control unit 10, the process advances to step SP10.

In step SP10, the main control unit 10 determines whether or not the direction of the depiction of the print image is changed. If a positive result is obtained in step SP10, this means that a user requests to change the direction of the depiction of the print image on the print preview window. If a positive result is obtained in step SP10 by the main control unit 10, the process advances to the next step SP11.

In step SP11, the main control unit 10 generates a single print image obtained by changing the direction of the depiction based on one or a plurality of lengthwise characteristic images and/or breadthwise characteristic images generated at this moment. Then, the process returns to the step SP6.

If a negative result is obtained in the step SP10, this means that the title is added or deleted, or the printing of the print image is stopped. If a negative result is obtained in the step SP10 by the main control unit 10, the process advances to step SP12.

In step SP12, the main control unit 10 determines whether or not the title is added to the print image. If a positive result is obtained in the step SP10, this means that a user requests to add the title to the print image on the print preview image.

If a positive result is obtained in the step SP12 by the main control unit 10, the process advances to the next step SP13. In step SP13, the main control unit 10 adds the title (e.g., a program title, a moving picture title, a photograph title) to the print image generated at this moment, and the process returns to the step SP6.

Furthermore, if a negative result is obtained in the step SP12, this means that the title is detected, or the printing of the print image is stopped. If a negative result is obtained in the step SP12 by the main control unit 10, the process advances to step SP14.

In step SP14, the main control unit 10 determines whether or not the title on the print image is deleted. If a positive result is obtained in the step SP10, this means that a user requests to delete the title on the print image in the print preview image.

If a positive result is obtained in the step SP14 by the main control unit 10, the process advances to the next step SP15. In step SP15, the main control unit 10 deletes the title (e.g., a program title, a moving picture title, a photograph title) on the print image generated at this moment. The, the process returns to the step SP6.

Furthermore, if a negative result is obtained in the step SP14, this means that an instruction to stop printing the print image on the print preview image is received from a user. If a negative result is obtained in the step SP14 by the main control unit 10, the process advances to step SP9. Consequently, in step SP9, the main control unit 10 terminates the print process sequence RT1.

### 1-5. Operation and Effect of Embodiments

In the aforementioned configuration, the main control unit 10 of the program recording device 1 reads the contents data from the recording disc as the recording disc where the contents data are recorded is installed inside the device.

Then, the main control unit 10 of the program recording device 1 obtains the representative image representing that contents based on the contents data. In addition, the main control unit 10 of the program recording device 1 analyzes the representative image and cuts out the characteristic depiction area, where the image characteristic portion extending in a single direction is depicted, from the corresponding representative image as the characteristic depiction image.

Furthermore, the main control unit 10 of the program recording device 1 generates a circular print image by boding one end and the other end of a single direction, where the image characteristic portion is longitudinally depicted, of the characteristic depiction image and generates the print data for printing the print image on one surface of the disc. Then, the main control unit 10 of the program recording device 1 prints the print image on one surface of the recording disc based on the print data.

Therefore, the program recording device 1 can print the image characteristic portion extending in a single direction, where the representative image representing the contents data recorded on the recording disc is depicted, as the circular print image on one surface of the disc without any omission from the one surface of the disc.

According to the aforementioned configuration, the program recording device 1 is configured to obtain and analyze the representative image representing the contents data based on the contents data recorded on the recording disc as the recording disc is installed inside the device, cut out the characteristic depiction area as the characteristic depiction image, where the image characteristic portion extending in a single direction is depicted, from the corresponding representative image, generate a circular print image by bonding one end and the other end of a single direction where the image characteristic portion of the characteristic depiction image is longitudinally depicted, and print the print image on one surface of the recording disc.

Consequently, the program recording device 1 can print the image characteristic portion extending in a single direction, where the representative image representing the contents data is depicted, on one surface of the disc without any omission. Therefore, the program recording device 1 allows a user to identify the contents data recorded on the corresponding recording disc using the print image printed on one surface of the recording disc.

In addition, the program recording device 1 is configured to cut out the characteristic depiction area, where the image characteristic portion extending in a single direction is depicted, as the characteristic depiction image from the representative image and print the circular print image generated based on the characteristic depiction image on one surface of the recording disc.

Therefore, the program recording device 1 can allow a user to more easily recognize most of the contents of the print image printed on one surface of the disc as the image characteristic portion by setting the image characteristic portion as the corresponding print image. Therefore, the program recording device 1 can allow a user to appropriately identify the contents data recorded on the corresponding recording disc using the print image printed on one surface of the recording disc.

Furthermore, the program recording device 1 is configured to enlarge the circular print image generated based on the characteristic depiction image in this manner and print it on one surface of the recording disc. Therefore, the program recording device 1 can make it easier to identify the depiction of the print image printed on one surface of the disc. Therefore, the program recording device 1 can allow a user to more appropriately identify the contents data recorded on the corresponding recording disc using the print image printed on one surface of the recording disc.

Furthermore, if a plurality of characteristic depiction images, where the image characteristic portions extending in a single direction are depicted, are generated based on a plurality of the representative images, the program recording device 1 generates a consecutive characteristic depiction image by sequentially connecting a plurality of the characteristic depiction images in a single direction where the image characteristic portion is longitudinally depicted. In addition, the program recording device 1 is configured to generate a single circular print image by boding one end and the other end of a single direction where the image characteristic portion of the consecutive characteristic depiction image is longitudinally depicted and print it on one surface of the disc.

Therefore, the program recording device 1 can print the image characteristic portion extending in a single direction, where each of a plurality of characteristic images representing a plurality of pieces of the contents data recorded on the recording disc is depicted, on one surface of the disc without any omission. Therefore, the program recording device 1 can allow a user to appropriately identify a plurality of pieces of the contents data recording on the corresponding recording disc using the print image printed on one surface of the recording disc.

Furthermore, the program recording device 1 is configured to cut out the characteristic depiction image from the characteristic depiction area, where the image characteristic portion extending in a single direction within the representative image is depicted, by setting one end and the other end that are most similar between the one end portion and the other end portion of the corresponding single direction as a cutout location.

Therefore, the program recording device 1 can make the print image generated by bonding one end and the other end of the characteristic image be seen as an originally single circular image while concealing the boding portion as much as possible.

The program recording device 1 is configured to execute the special effect process for the one end portion and the other end portion of the corresponding characteristic depiction image when the print image is generated by bonding one end and the other end of a single characteristic depiction image. Therefore, the program recording device 1 can make it more difficult to notice the bonding portion between one end and the other end of the original characteristic depiction image.

Furthermore, the program recording device 1 is configured to execute the special effect process even for the bonding portion of a plurality of characteristic depiction images when a consecutive characteristic depiction image is generated by sequentially connecting a plurality of the characteristic depiction images in a single direction where the image characteristic portion is longitudinally depicted. Therefore, the program recording device 1 can make it difficult to notice the bonding portion or the connection portion of a plurality of original characteristic depiction images.

Moreover, when it is difficult to obtain the representative image, where the image characteristic portion extending in a single direction is depicted, and the representative image, where the image characteristic portion which is short in all directions is depicted, is obtained, the program recording device 1 is configured to print the image characteristic portion which is short in all directions as the print image on one surface of the disc.

Therefore, the program recording device 1 can allow a user to identify the contents data recorded on the corresponding recording disc using the print image printed on one surface of the recording disc even when it is difficult to obtain the representative image where the image characteristic portion extending in a single direction is depicted.

### 2. Modifications

### 2-1. Modification 1

In the aforementioned embodiment, a case has been described where the program recording device 1 is configured to generate the print image and print it on one surface of the disc when the recording disc where the contents data are recorded is installed, and the print mode is selected.

However, the present invention is not limited thereto, but the program recording device 1 may be configured such that, when an unused (new) recording disc is installed, and the recording of the contents data is terminated, the characteristic depiction image is continuously cut out from the representative image representing the corresponding contents data, and the characteristic depiction image is printed on one surface of the disc as the print image.

### 2-2. Modification 2

In the aforementioned embodiment, a case has been described where a circular print image is generated by bonding one end and the other end of a single direction, where the image characteristic portion is longitudinally depicted, of the characteristic depiction image cut out from the representative image.

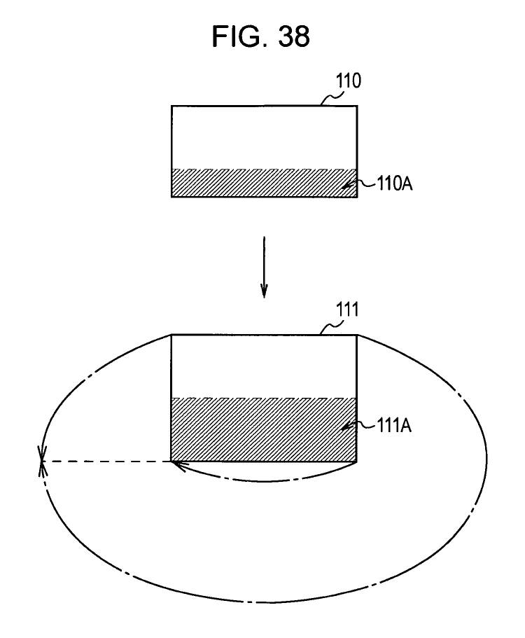

However, the present invention is not limited thereto, but may be configured such that, as shown in FIG. 38, in the characteristic depiction image 110 cut out from the representative image, pixels are interpolated in an one end portion 110A of the other direction perpendicular to a single direction where the image characteristic portion is longitudinally depicted in order to enlarge the width of the other direction.

The present invention may be configured such that, in the characteristic image 111 obtained by enlarging the width of the other direction, a circular print image may be generated by collectively setting one end of an end portion 111A obtained by interpolating pixels as the center of the image and setting the other end of the other direction as the outer circumference of the image.

Consequently, the present invention can make it easier to identify the contents of the print image because a portion of the corresponding print image at the center of the disc can be seen as much as possible when the print image is printed on one surface of the disc.

The present invention may be configured such that, in the characteristic depiction image, the width of the other direction of the corresponding characteristic depiction image is enlarged by adding an image having a band-shape parallel to the corresponding single direction with a monochrome color such as black or white to one end portion of the other direction perpendicular to the single direction where the image characteristic portion is longitudinally depicted.

The present invention may be configured such that, in the characteristic depiction image obtained by enlarging the width of the other direction, the circular print image is generated by setting one end of the side where the band-shaped image is added as the center of the image and setting the other end of the other direction as the outer circumference of the image.

Even in such a configuration, the present invention can make it easier to identify the contents of the print image because a portion of the corresponding print image depiction in the side of the center of the disc can be seen as much as possible when the print image is printed on one surface of the disc.

### 2-3. Modification 3

Furthermore, in the aforementioned embodiment, a case has been described where the representative image is analyzed based on the values of R, G, and B of the pixels to detect the characteristic depiction area, and the characteristic depiction area is cut out as the characteristic depiction image from the representative image.

However, the present invention is not limited thereto, but may be configured such that the representative image is analyzed based on the color, chroma, brightness (HSV: Hue Saturation value), luminance, or the like to detect the characteristic depiction area, and the characteristic depiction area is cut out as the characteristic depiction image from the corresponding representative image.

### 2-4. Modification 4

Furthermore, in the aforementioned embodiment, a case has been described where a circular print image is generated by cutting out the characteristic depiction image, where the image characteristic portion extending in a single direction is depicted, from the representative image, and bonding one end and the other end of the corresponding single direction of the characteristic depiction image.

However, the present invention is not limited thereto, but may be configured such that whether or not the image characteristic portion extending in a single direction is depicted by analyzing the representative image, and a circular print image is generated by bonding one end and the other end of the corresponding single direction without change for the representative image where the image characteristic portion extending in a single direction is depicted. Such a configuration according to the present invention can be used to reduce the processing load of the corresponding generation processes by simplifying the generation process of the print image based on the representative image.

### 2-5. Modification 5

Furthermore, in the aforementioned embodiment, a case has been described where a part of the contents data recorded on the recording disc or the contents data are obtained as the representative image data.

However, the present invention is not limited thereto, but may be configured such that, during the printing, the representative image representing the contents data is obtained from an external device such as an image providing device on a network, and the characteristic depiction image is generated based on that representative image.

### 2-6. Modification 6

Furthermore, in the aforementioned embodiment, a case has been described where, when the consecutive characteristic depiction image is generated by sequentially connecting a plurality of characteristic depiction images, the width of any single characteristic depiction image is used as a reference, and other characteristic depiction images are collectively enlarged or contracted to match the widths with each other.

However, the present invention is not limited thereto, but may be configured such that, when the consecutive characteristic depiction image is generated by sequentially connecting a plurality of characteristic depiction images, the width of a single characteristic depiction image having a widest width among a plurality of characteristic depiction images is set to a reference width, and the corresponding widths of other characteristic depiction images are adjusted to the reference width by enlarging other characteristic depiction images.

Consequently, according to the present invention, it is possible to prevent degradation in the image quality of the corresponding characteristic depiction image caused by decimation of the pixels because a plurality of characteristic depiction images are not contracted by decimating pixels when the consecutive characteristic depiction image is generated by sequentially connecting a plurality of characteristic depiction images.

### 2-7. Modification 7

In the aforementioned embodiment, a case has been described where, when the characteristic depiction area, where the image characteristic portion extending in a single direction is depicted, is detected by analyzing the representative image, the characteristic depiction image is cut out by specifying the cutout location at the one end portion and the other end portion of a single direction within that characteristic depiction area.

However, the present invention is not limited thereto, but may be configured such that, when the characteristic depiction area, where the image characteristic portion extending in a single direction is depicted, is detected by analyzing the representative image, that characteristic depiction area is cut out without change as the characteristic depiction image. In such a configuration according to the present invention, it is possible to reduce the processing load in the corresponding analysis cutout process by simplifying the analysis cutout process for cutting out the characteristic depiction image from the representative image.

### 2-8. Modification 8

Furthermore, in the aforementioned embodiment, a case has been described where the special effect process is executed for one end portion and the other end portion of the characteristic depiction image, or a connection portion of a plurality of characteristic depiction images included in the consecutive characteristic depiction image, or the like.

However, the present invention is not limited thereto, but may be configured such that the entire color of the characteristic depiction image is converted into a monochrome or sepia color. According to the present invention, even in such a configuration, it is possible to conceal the bonding portion between one end and the other end of the characteristic depiction image or the consecutive characteristic depiction image in the print image generated based on the characteristic depiction image or the consecutive characteristic depiction image. According to the present invention, in such a configuration, it is possible to conceal the connection portion between a plurality of characteristic depiction images included in the consecutive characteristic depiction image.

### 2-9. Modification 9

Furthermore, in the aforementioned embodiment, a case where the title is appropriately added to the print image has been described.

However, the present invention is not limited thereto, but may be configured such that various other information regarding the contents data such as genres, subtitles, broadcasting days, production names, producer names, performer names, and staff names may be added to the print image as characters or graphic arts.

### 2-10. Modification 10

Furthermore, in the aforementioned embodiment, a case where the print apparatus according to the present invention is applied to the aforementioned program recording device 1 described above in conjunction with FIGS. 1 to 38 has been described.

However, the present invention is not limited thereto, but may be applied to a printer that generates the print image representing the contents data recorded on the recording disc and prints it on one surface of the disc when the recording disc where the contents data are recorded is installed by an external recording device.

The present invention may be also applied to an information processing device such as a computer, a mobile phone, a PDA (Personal Digital Assistance), or a mobile game machine, and a recording print system constructed by connecting the printer in wired or wireless fashion.

Furthermore, the present invention may be applied to the print apparatuses having various other configurations such as a recording print system constructed by connecting a digital video camera, a digital camera, or a printer in a wired or wireless fashion.

### 2-11. Modification 11

Furthermore, in the aforementioned embodiment, the print program according to the present invention has been applied to a print program previously stored in internal memory of the main control unit 10 or a hard disc drive 12 described above in conjunction with FIGS. 1 to 38. In addition, a case where the main control unit 10 executes the aforementioned print process sequence RT1 according to that print program has been described.

However, the present invention is not limited thereto, but may be configured such that the program recording device 1 installs the print program using a computer readable recording medium where the print program is recorded. In addition, the main control unit 10 may execute the print process sequence RT1 according to the print program installed in such a way.

The program recording device 1 may externally install the print program using a wired and wireless communication medium such as a local area network (LAN), the Internet, and a digital satellite broadcasting.

The computer readable recording medium enabled to be executable by installing the print program in the program recording device 1 may be realized by, for example, a package medium such as a flexible disc.

The computer readable recording medium enabled to be executable by installing the print program in the program recording device 1 may be realized by a package medium such as a CD-ROM (Compact Disc-Read Only Memory).

Furthermore, the computer readable recording medium enabled to be executable by installing the print program in the program recording device 1 may be realized by a package medium such as a DVD (Digital Versatile Disc).

Such a computer readable recording medium may be realized by semiconductor memory or magnetic discs on which various programs are temporarily or permanently recorded in addition to the package medium.

A wired and wireless communication medium such as a local area network, the Internet, and a digital satellite broadcasting may be used to record the print program on these computer readable recording media.

Furthermore, the print program may be recorded on the computer readable recording medium using various communication interfaces such as a router or a modem.

### 2-12. Modification 12

Furthermore, in the aforementioned embodiment, a case has been described where the contents recorded on the recording disc includes the program data on the recording program of the digital system broadcasting or the analog system broadcasting described above in conjunction with FIGS. 1 to 38, or moving picture data or photograph image data generated by taking a moving picture or photograph of a target object using a digital recording device.

However, the present invention is not limited thereto, but may be widely applied to various other kinds of contents such as music clips, music data, video data such as movies, text data, program data such as game programs provided from a supply device on a network.

### 2-13. Modification 13

Furthermore, in the aforementioned embodiment, a case has been described where the main control unit 10 having a micro-computer configuration described above in conjunction with FIGS. 1 to 38 is applied as the print image generation unit which generates the circular print image by bonding one end and the other end of the corresponding single direction of the representative image where the image characteristic portion extending in a single direction is depicted to represent the contents recorded on the recording disc.

The present invention may be achieved by applying a CPU (Central Processing Unit), a microprocessor, or a DSP (Digital Signal Processor) without limitation. The present invention may be widely applied to various other kinds of configurations of the print image generation circuits such as a print image generation circuit having a hardware circuit configuration that generates the circular print image by bonding one end and the other end of the corresponding single direction of the representative image where the image characteristic portion extending in a single direction is depicted to represent the contents recorded on the recording disc.

### 2-14. Modification 14

Furthermore, in the aforementioned embodiment, a case has been described where the main control unit 10, the printer control unit 49 in the program recording device 1, and the printer 50 described above in conjunction with FIGS. 1 to 38 are applied as a print unit that prints the print image on one surface of the corresponding recording disc by matching the center of the recording disc with the center of the print image.

However, the present invention is not limited thereto, but may be widely applied to various other kinds of print units such as a printer connected to the recording device which records the contents on the recording disc in a wired or wireless fashion.

### 2-15. Modification 15

Furthermore, in the aforementioned embodiment, a case has been described where the main control unit 10 having a micro-computer configuration described above in conjunction with FIGS. 1 to 38 is applied as the image analysis unit that analyzes the representative image to detect the characteristic depiction area, where the image characteristic portion extending in a single direction is depicted, and cuts out the detected characteristic depiction area as the characteristic depiction image from the representative image.

However, the present invention is not limited thereto, but may be implemented by applying a CPU, a micro-processor, or a DSP. In addition, the present invention may be widely applied to various other configurations of the image analysis units such as a hardware-configured image analysis circuit that analyzes the representative image to detect the characteristic depiction area, where the image characteristic portion extending in a single direction is depicted, and cuts out the detected characteristic depiction area as the characteristic depiction image from the representative image.

### 2-16. Modification 16

Furthermore, in the aforementioned embodiment, a case has been described where the remocon RM described above in conjunction with FIGS. 1 to 38 is applied as an instruction unit for instructing to change the direction of the depiction of the image characteristic portion depicted on the print image.

However, the present invention is not limited thereto, but may be achieved by widely applying various other kinds of instruction units such as a manipulation key arranged in the front side of the recording program device or a touch panel integrated into the display.

The present application contains subject matter related to that disclosed in Japanese Priority Patent Application JP 2009-129314 filed in the Japan Patent Office on May 28, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A print apparatus comprising:
a print image generation unit that generates a circular print image by bonding one end and the other end of a single direction of a representative image where an image characteristic portion extending in a single direction is depicted to represent contents recorded on the recording disc; and
a print unit that prints the print image on one surface of the recording disc by matching a center of the recording disc with a center of the print image.

2. The print apparatus according to claim 1,
further comprising an image analysis unit that analyzes the representative image to detect the characteristic depiction area where the image characteristic portion extending in a single direction is depicted and cuts out the detected characteristic depiction area as an characteristic depiction image,
wherein the print image generation unit generates the print image by bonding one end and the other end of the single direction of the characteristic depiction image.

3. The print apparatus according to claim 2, wherein the print unit prints an enlarged view of the print image on one surface of the recording disc.

4. The print apparatus according to claim 3,
further comprising an instruction unit that instructs to change a direction of depiction of the image characteristic portion depicted in the print image,
wherein, when the change of the direction is instructed by the instruction unit, the print image generation unit generates the print image by collectively switching one side serving as a center of the print image and the other side serving as an outer circumference of the print image between one end and the other end of the other direction perpendicular to the single direction of the characteristic depiction image so that the other side serves as the image center, and the one side serves as the image outer circumference.

5. The print apparatus according to claim 4, wherein the image analysis unit specifies one end and the other end that are most similar to each other between the one end portion and the other end portion of the single direction of the characteristic depiction area and cuts out the representative image from the one end to the other end specified in the characteristic depiction area as the characteristic depiction image.

6. The print apparatus according to claim 5, wherein the print image generation unit executes a special effect process for the one end portion and the other end portion of the single direction of the characteristic depiction image.

7. The print apparatus according to claim 6, wherein the print image generation unit generates a single consecutive characteristic depiction image by sequentially connecting a plurality of the characteristic depiction images, where an image characteristic portion extending in a single direction is depicted, in the single direction, and the print image is generated by bonding the one end and the other end of the single direction of the single consecutive characteristic depiction image generated correspondingly.

8. The print apparatus according to claim 7, wherein the print image generation unit executes the special effect process for bonding portions of each of the characteristic depiction images included in the consecutive characteristic depiction image and also executes the special effect process for the one end portion and the other end portion of the single direction of the consecutive characteristic depiction image.

9. A print method comprising the steps of:
generating a circular print image by bonding one end and the other end of a single direction of a representative image where an image characteristic portion extending in the single direction is depicted to represent contents recorded on a recording disc; and
printing the print image on one surface of the recording disc by matching a center of the recording disc with a center of the print image.

10. A print program for executing, on a computer, a method comprising the steps of:
generating a circular print image by bonding one end and the other end of a single direction of a representative image where an image characteristic portion extending in the single direction is depicted to represent contents recorded on a recording disc; and
printing the print image on one surface of the recording disc by matching a center of the recording disc with a center of the print image.
